(19) United States
(12) Patent Application Publication
(10) Pub. No.: US 2025/0110275 A1
(43) Pub. Date: Apr. 3, 2025

(54) SEMICONDUCTOR PHOTONICS DEVICE AND METHODS OF FORMATION

(71) Applicant: Taiwan Semiconductor Manufacturing Company, Ltd., Hsinchu (TW)

(72) Inventors: Tai-Chun HUANG, New Taipei City (TW); Stefan RUSU, Sunnyvale, CA (US)

(21) Appl. No.: 18/403,258

(22) Filed: Jan. 3, 2024

Related U.S. Application Data
(60) Provisional application No. 63/586,295, filed on Sep. 28, 2023.

(51) Int. Cl. G02B 6/122; G02B 6/13

(52) U.S. Cl. CPC G02B 6/1228; G02B 6/13

(57) ABSTRACT

A semiconductor photonics device includes a multiple-layer coupler structure. The multiple-layer coupler structure includes a plurality of optical coupler layers, which enables the properties of the optical coupler layers to be configured to achieve efficient optical coupling for a broad spectrum of optical wavelengths. This enables the multiple-layer coupler structure to handle wide bandwidth optical signals, which enables the semiconductor photonics device to support high-bandwidth optical communication applications. Moreover, the optical coupler layers of the multiple-layer coupler device enable the performance of the multiple-layer coupler structure to be increased using less complex and less costly semiconductor manufacturing processes and techniques. Additionally, the optical coupler layers of the multiple-layer coupler structure enable the multiple-layer coupler structure to handle bidirectional transmission of optical signals, thereby enabling transmission of optical signals between various layers of the semiconductor photonics device.

### CROSS-REFERENCE TO RELATED APPLICATION

This patent application claims priority to U.S. Provisional Patent Application No. 63/586,295, filed on Sep. 28, 2023, and entitled “SEMICONDUCTOR PHOTONICS DEVICE AND METHODS OF FORMATION.” The disclosure of the prior application is considered part of and is incorporated by reference into this patent application.

### BACKGROUND

In semiconductor photonics, semiconductor materials such as silicon are used as an optical transmission medium. For example, a semiconductor photonics device may be used for optical communications, and may include coupling systems that convert between electrical signals and optical signals. Additionally, some semiconductor photonics devices may include integrated electronic components on a same semiconductor substrate for processing transmitted or received optical signals.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram of an example environment in which systems and/or methods described herein may be implemented.

FIGS. 2A-2D are diagrams of an example semiconductor photonics device described herein.

FIG. 3 is a diagram of an example implementation of optical coupling in a semiconductor photonics device described herein.

FIGS. 4A-4E are diagrams of an example implementation of forming a semiconductor photonics device described herein.

FIGS. 5A-5D are diagrams of an example semiconductor photonics device described herein.

FIG. 6 is a diagram of an example implementation of optical coupling in a semiconductor photonics device described herein.

FIGS. 7A-7E are diagrams of an example implementation of forming a semiconductor photonics device described herein.

FIGS. 8A-8C are diagrams of an example semiconductor photonics device described herein.

FIGS. 9A-9C are diagrams of an example semiconductor photonics device described herein.

FIGS. 10A-10C are diagrams of an example semiconductor photonics device described herein.

FIGS. 11A-11C are diagrams of an example semiconductor photonics device described herein.

FIGS. 12A and 12B are diagrams of an example semiconductor photonics device described herein.

FIGS. 13A and 13B are diagrams of an example semiconductor photonics device described herein.

FIGS. 14A-14C are diagrams of an example semiconductor photonics device described herein.

FIGS. 15A and 15B are diagrams of an example semiconductor photonics device described herein.

FIGS. 16A-16F are diagrams of an example semiconductor photonics device described herein.

FIG. 17 is a diagram of example components of a device described herein.

FIG. 18 is a flowchart of an example process associated with forming a semiconductor photonics device described herein.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

An optical signal may be provided from a fiber optic cable to optical circuitry of a semiconductor photonics device through an optical coupler device. The optical coupler device may include a waveguide that confines and directs the optical signal through a dielectric region to a photonic device such as a photodetector or optical modulator, among other examples. In some cases, an optical coupler device may have limited optical bandwidth capabilities due to being able to handle optical signals within a specific wavelength range. As a result, the optical coupler device may not support high-bandwidth applications such as datacenter optical communications. Additionally and/or alternatively, limitations in semiconductor manufacturing processes may not support tuning of parameters of the optical coupler device (e.g., thickness, length, positioning within a semiconductor photonics device), which may result in an inability to achieve high optical coupling efficiency for the optical coupler device.

In some implementations described herein, a semiconductor photonics device includes a multiple-layer coupler structure. The multiple-layer coupler structure includes a plurality of optical coupler layers, which enables the properties of the optical coupler layers (e.g., materials, refractive indices, shapes, sizes, positioning) to be configured to achieve efficient optical coupling for a broad spectrum of optical wavelengths. This enables the multiple-layer coupler structure to handle wide bandwidth optical signals, which enables the semiconductor photonics device to support high-bandwidth optical communication applications. Moreover, the optical coupler layers of the multiple-layer coupler device enable the performance of the multiple-layer coupler structure to be increased using less complex and less costly semiconductor manufacturing processes and techniques. Additionally, the optical coupler layers of the multiple-layer coupler structure enable the multiple-layer coupler structure to handle bidirectional transmission of optical signals, thereby enabling transmission of optical signals between various layers of the semiconductor photonics device.

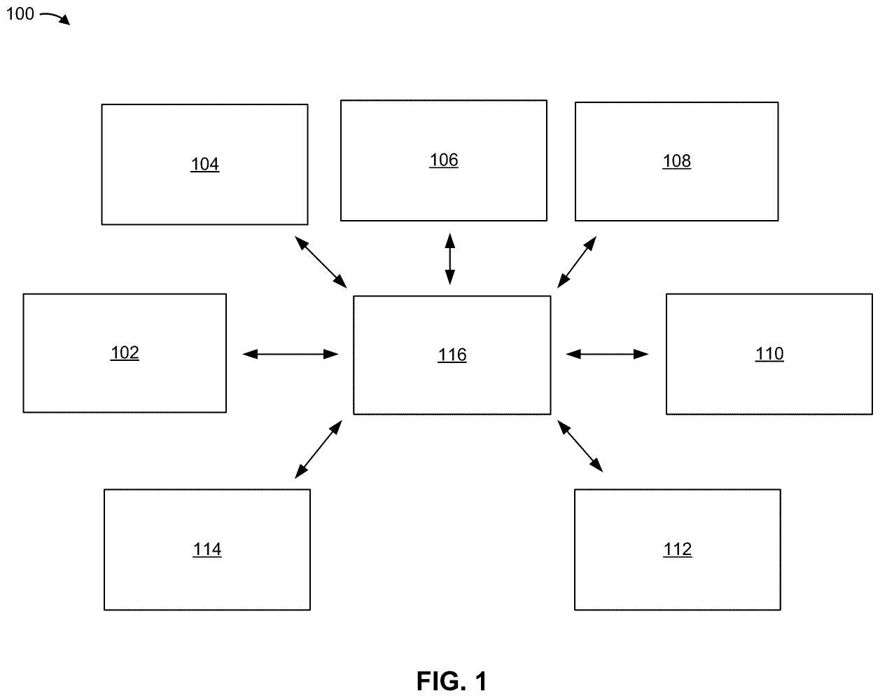

FIG. 1 is a diagram of an example environment 100 in which systems and/or methods described herein may be implemented. As shown in FIG. 1, environment 100 may include a plurality of semiconductor processing tools 102-114 and a wafer/die transport tool 116. The plurality of semiconductor processing tools 102-114 may include a deposition tool 102, an exposure tool 104, a developer tool 106, an etch tool 108, a planarization tool 110, a plating tool 112, an ion implantation tool 114, and/or another type of semiconductor processing tool. The tools included in example environment 100 may be included in a semiconductor clean room, a semiconductor foundry, a semiconductor processing facility, and/or a semiconductor manufacturing facility, among other examples.

The deposition tool 102 is a semiconductor processing tool that includes a semiconductor processing chamber and one or more devices capable of depositing various types of materials onto a substrate. In some implementations, the deposition tool 102 includes a spin coating tool that is capable of depositing a photoresist layer on a substrate such as a wafer. In some implementations, the deposition tool 102 includes a chemical vapor deposition (CVD) tool such as a plasma enhanced CVD (PECVD) tool, a low-pressure CVD (LPCVD) tool, a high-density plasma CVD (HDP-CVD) tool, a sub-atmospheric CVD (SACVD) tool, an atomic layer deposition (ALD) tool, a plasma-enhanced atomic layer deposition (PEALD) tool, or another type of CVD tool. In some implementations, the deposition tool 102 includes a physical vapor deposition (PVD) tool, such as a sputtering tool or another type of PVD tool. In some implementations, the example environment 100 includes a plurality of different types of deposition tools 102. “Deposition tool 102,” as used herein, may refer to one or more deposition tools 102, one or more of the same type of deposition tools 102, and/or one or more different types of deposition tools 102, among other examples.

The exposure tool 104 is a semiconductor processing tool that is capable of exposing a photoresist layer to a radiation source, such as an ultraviolet light (UV) source (e.g., a deep UV light source, an extreme UV light (EUV) source, and/or the like), an x-ray source, an electron beam (e-beam) source, and/or the like. The exposure tool 104 may expose a photoresist layer to the radiation source to transfer a pattern from a photomask to the photoresist layer. The pattern may include one or more semiconductor device layer patterns for forming one or more semiconductor devices, may include a pattern for forming one or more structures of a semiconductor device, may include a pattern for etching various portions of a semiconductor device, and/or the like. In some implementations, the exposure tool 104 includes a scanner, a stepper, or a similar type of exposure tool.

The developer tool 106 is a semiconductor processing tool that is capable of developing a photoresist layer that has been exposed to a radiation source to develop a pattern transferred to the photoresist layer from the exposure tool 104. In some implementations, the developer tool 106 develops a pattern by removing unexposed portions of a photoresist layer. In some implementations, the developer tool 106 develops a pattern by removing exposed portions of a photoresist layer. In some implementations, the developer tool 106 develops a pattern by dissolving exposed or unexposed portions of a photoresist layer through the use of a chemical developer.

The etch tool 108 is a semiconductor processing tool that is capable of etching various types of materials of a substrate, wafer, or semiconductor device. For example, the etch tool 108 may include a wet etch tool, a dry etch tool, and/or the like. In some implementations, the etch tool 108 includes a chamber that is filled with an etchant, and the substrate is placed in the chamber for a particular time period to remove particular amounts of one or more portions of the substrate. In some implementations, the etch tool 108 may etch one or more portions of the substrate using a plasma etch or a plasma-assisted etch, which may involve using an ionized gas to isotropically or directionally etch the one or more portions.

The planarization tool 110 is a semiconductor processing tool that is capable of polishing or planarizing various layers of a wafer or semiconductor device. For example, a planarization tool 110 may include a chemical mechanical planarization (CMP) tool and/or another type of planarization tool that polishes or planarizes a layer or surface of deposited or plated material. The planarization tool 110 may polish or planarize a surface of a semiconductor device with a combination of chemical and mechanical forces (e.g., chemical etching and free abrasive polishing). The planarization tool 110 may utilize an abrasive and corrosive chemical slurry in conjunction with a polishing pad and retaining ring (e.g., typically of a greater diameter than the semiconductor device). The polishing pad and the semiconductor device may be pressed together by a dynamic polishing head and held in place by the retaining ring. The dynamic polishing head may rotate with different axes of rotation to remove material and even out any irregular topography of the semiconductor device, making the semiconductor device flat or planar.

The plating tool 112 is a semiconductor processing tool that is capable of plating a substrate (e.g., a wafer, a semiconductor device, and/or the like) or a portion thereof with one or more metals. For example, the plating tool 112 may include a copper electroplating device, an aluminum electroplating device, a nickel electroplating device, a tin electroplating device, a compound material or alloy (e.g., tin-silver, tin-lead, and/or the like) electroplating device, and/or an electroplating device for one or more other types of conductive materials, metals, and/or similar types of materials.

The ion implantation tool 114 is a semiconductor processing tool that is capable of implanting ions into a substrate. The ion implantation tool 114 may generate ions in an arc chamber from a source material such as a gas or a solid. The source material may be provided into the arc chamber, and an arc voltage is discharged between a cathode and an electrode to produce a plasma containing ions of the source material. One or more extraction electrodes may be used to extract the ions from the plasma in the arc chamber and accelerate the ions to form an ion beam. The ion beam may be directed toward the substrate such that the ions are implanted below the surface of the substrate.

The wafer/die transport tool 116 may be included in a cluster tool or another type of tool that includes a plurality of processing chambers, and may be configured to transport substrates and/or semiconductor devices between the plurality of processing chambers, to transport substrates and/or semiconductor devices between a processing chamber and a buffer area, to transport substrates and/or semiconductor devices between a processing chamber and an interface tool such as an equipment front end module (EFEM), and/or to transport substrates and/or semiconductor devices between a processing chamber and a transport carrier (e.g., a front opening unified pod (FOUP)), among other examples. In some implementations, a wafer/die transport tool 116 may be included in a multi-chamber (or cluster) deposition tool 102, which may include a pre-clean processing chamber (e.g., for cleaning or removing oxides, oxidation, and/or other types of contamination or byproducts from a substrate and/or semiconductor device) and a plurality of types of deposition processing chambers (e.g., processing chambers for depositing different types of materials, processing chambers for performing different types of deposition operations).

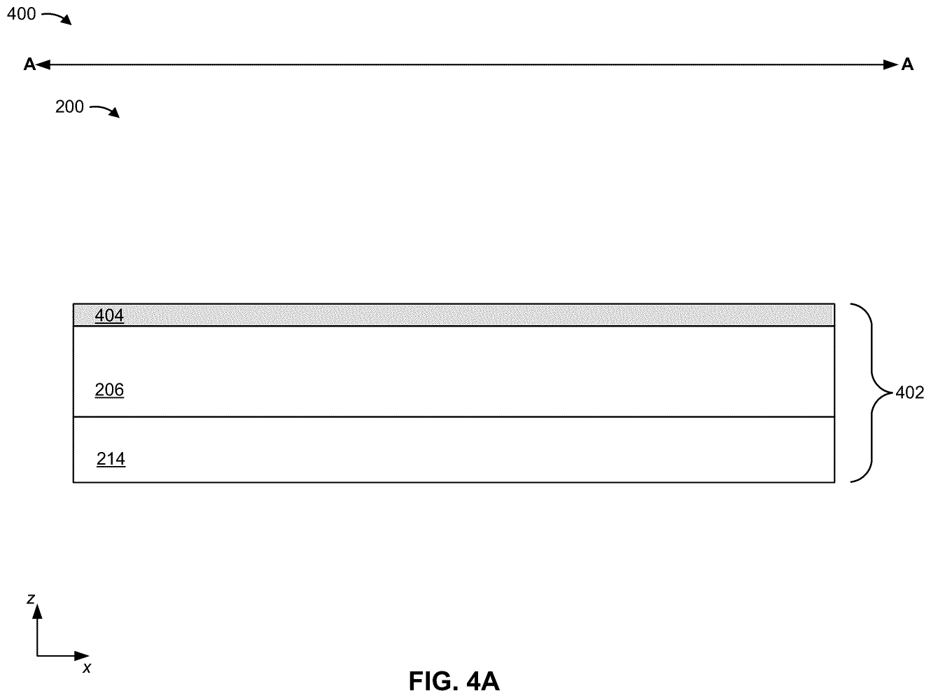

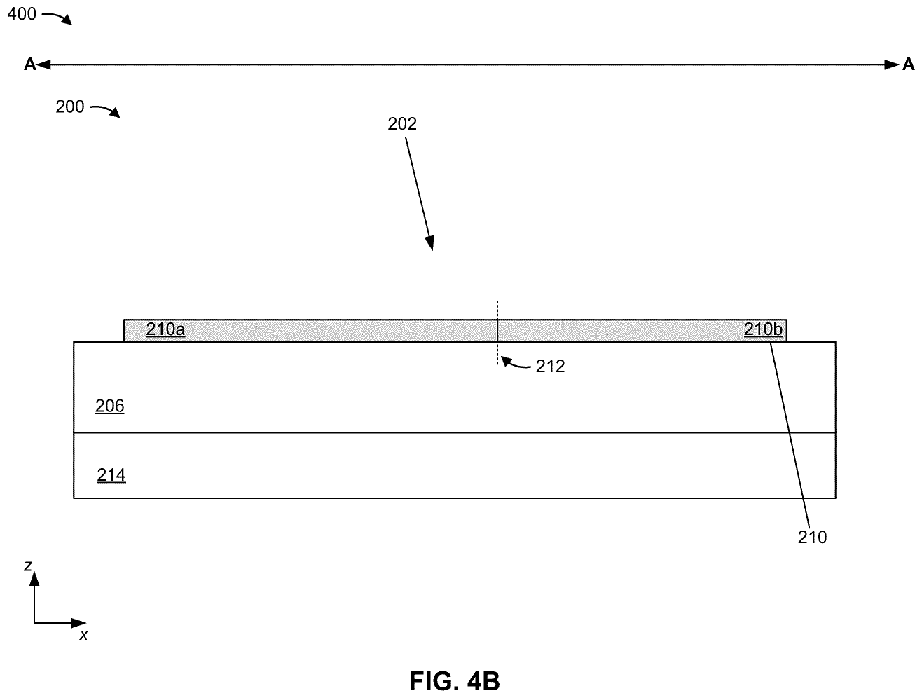

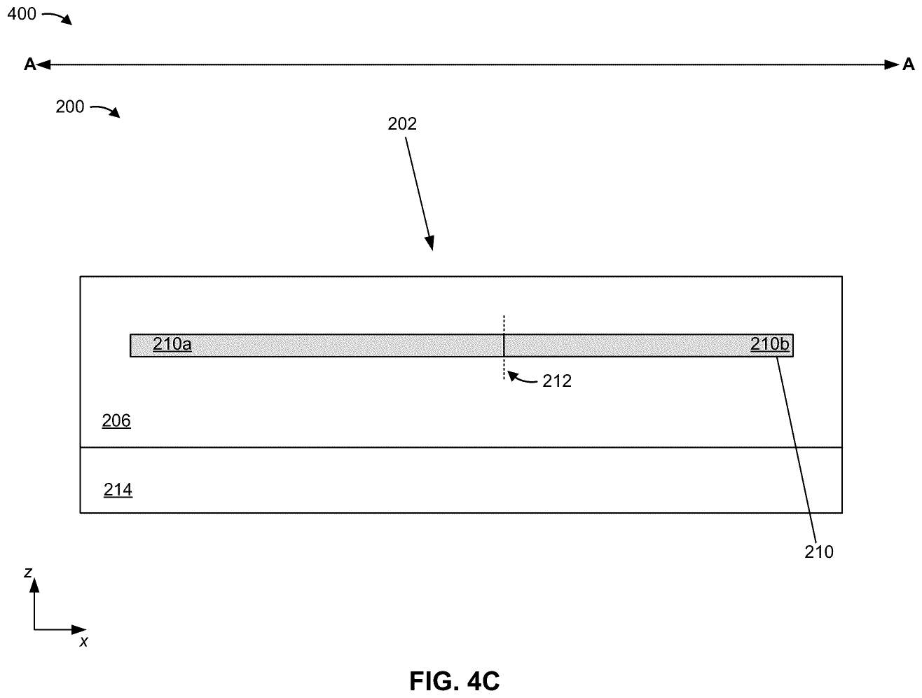

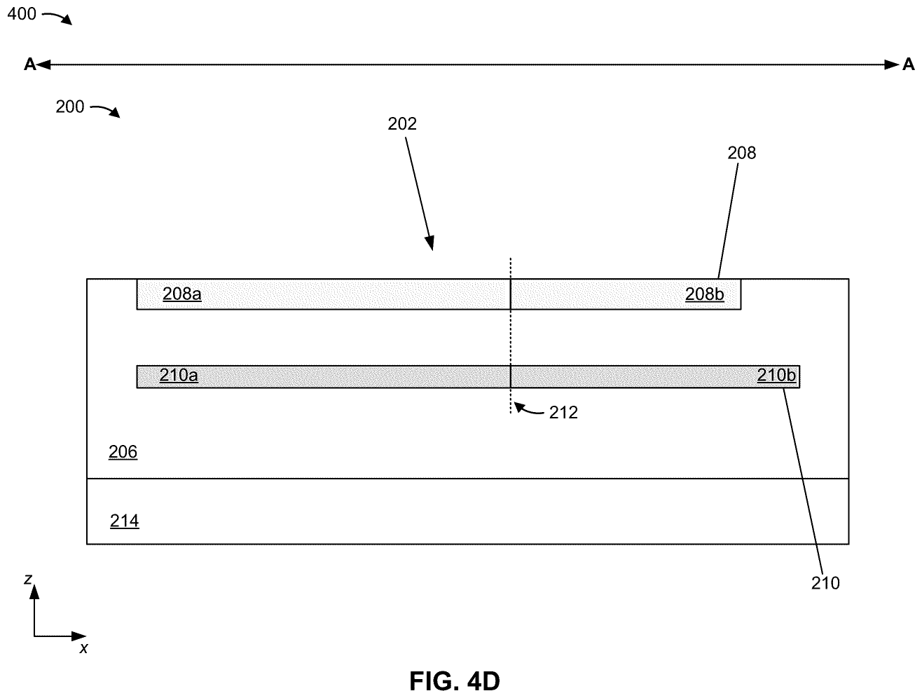

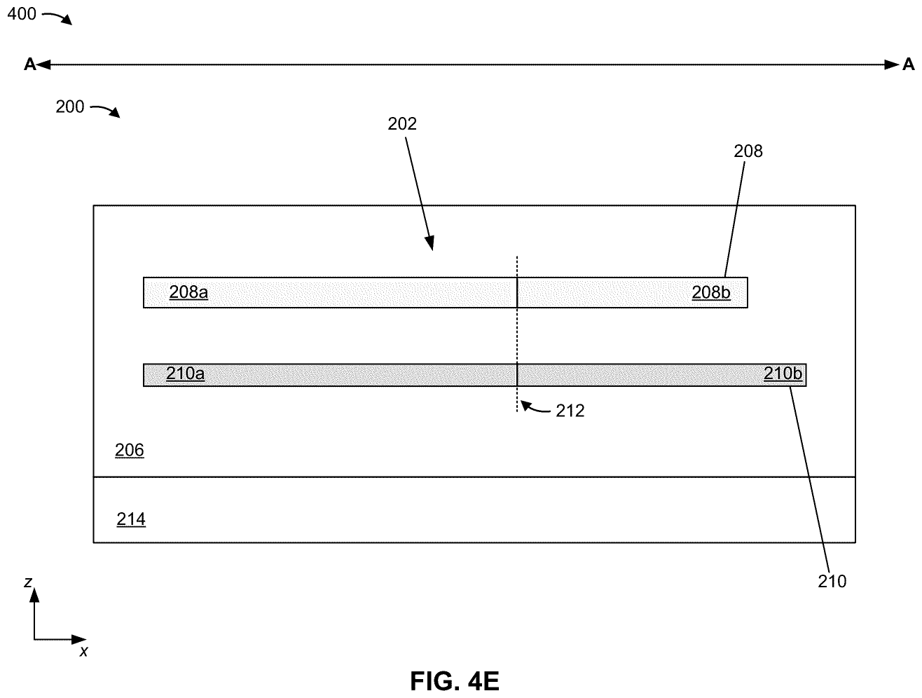

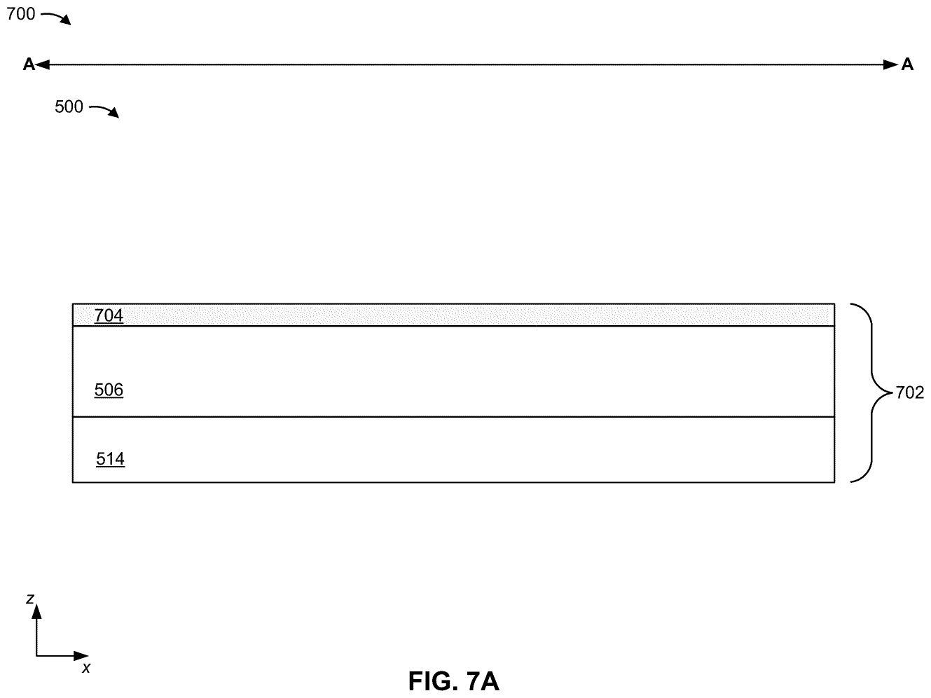

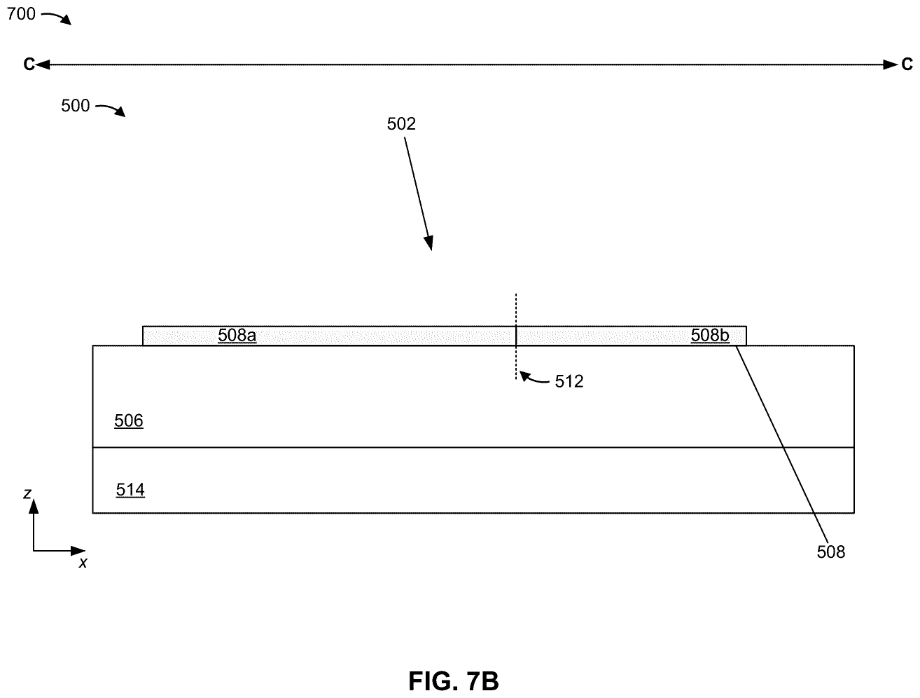

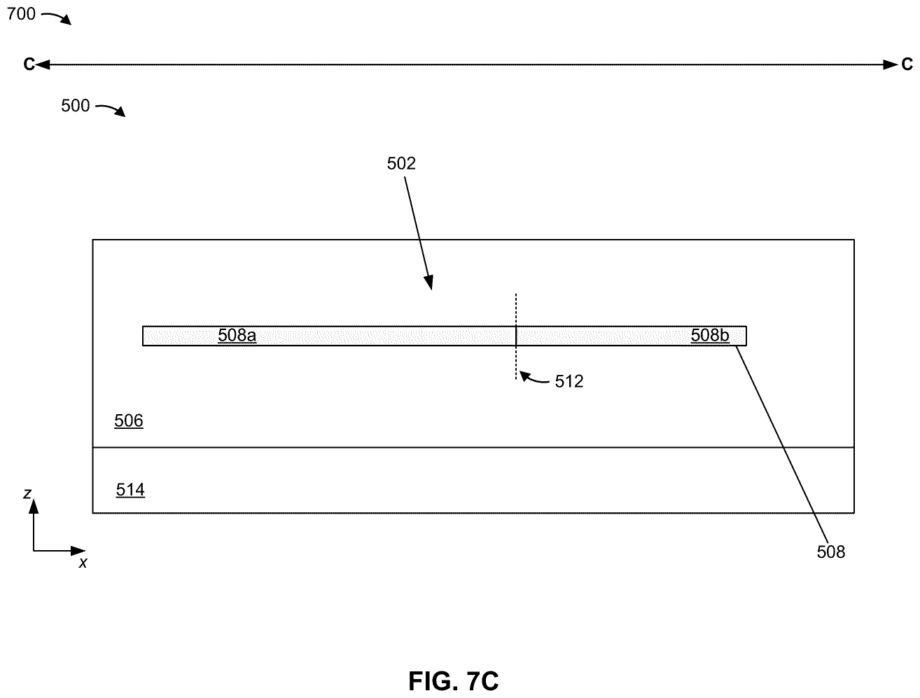

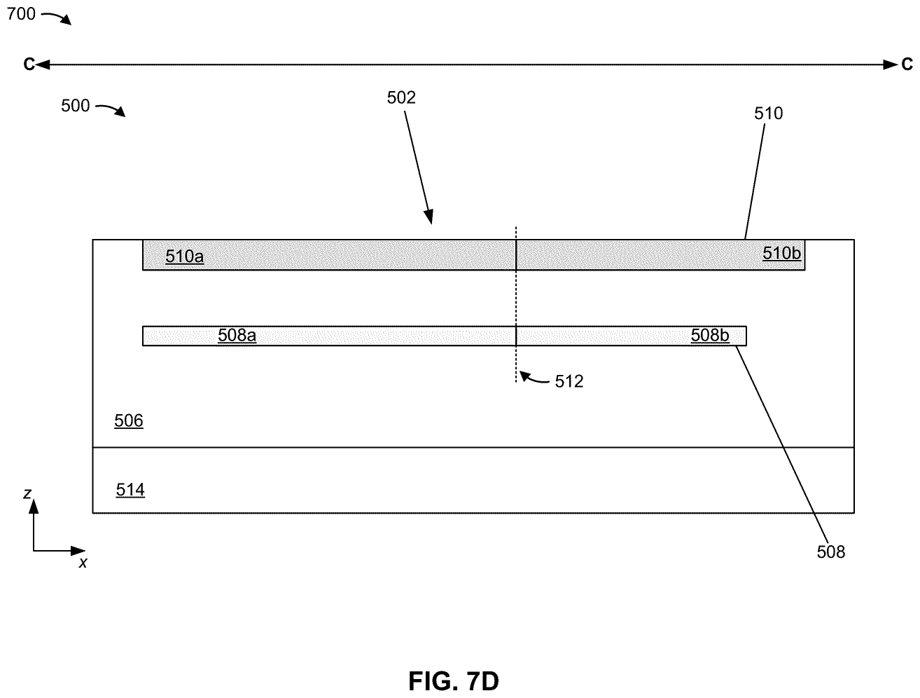

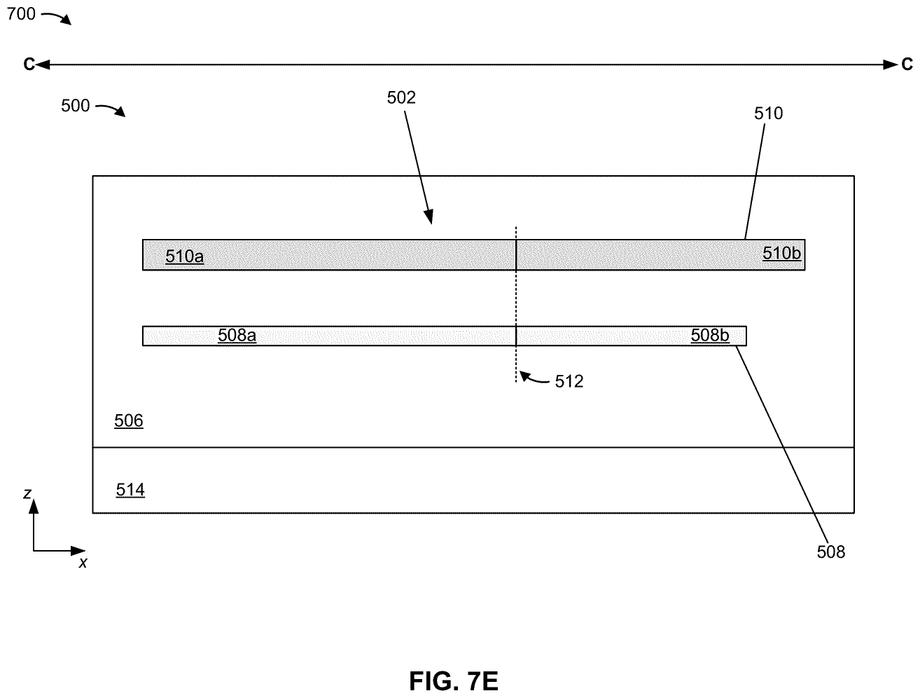

In some implementations, one or more of the semiconductor processing tools 102-114 may perform one or more semiconductor processing operations described herein. For example, one or more of the semiconductor processing tools 102-114 may be used to form a dielectric layer of a semiconductor photonics device; may be used to form, in the dielectric layer, a first optical coupler layer of a multiple-layer optical coupler; and/or may be used to form, adjacent to the first optical coupler layer in the dielectric layer, a second optical coupler layer of the multiple-layer optical coupler, among other examples. One or more of the semiconductor processing tools 102-114 may perform other semiconductor processing operations described herein, such as in connection with FIGS. 4A-4E, 7A-7E, and/or 18, among other examples.

The number and arrangement of devices shown in FIG. 1 are provided as one or more examples. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the example environment 100 may perform one or more functions described as being performed by another set of devices of the example environment 100.

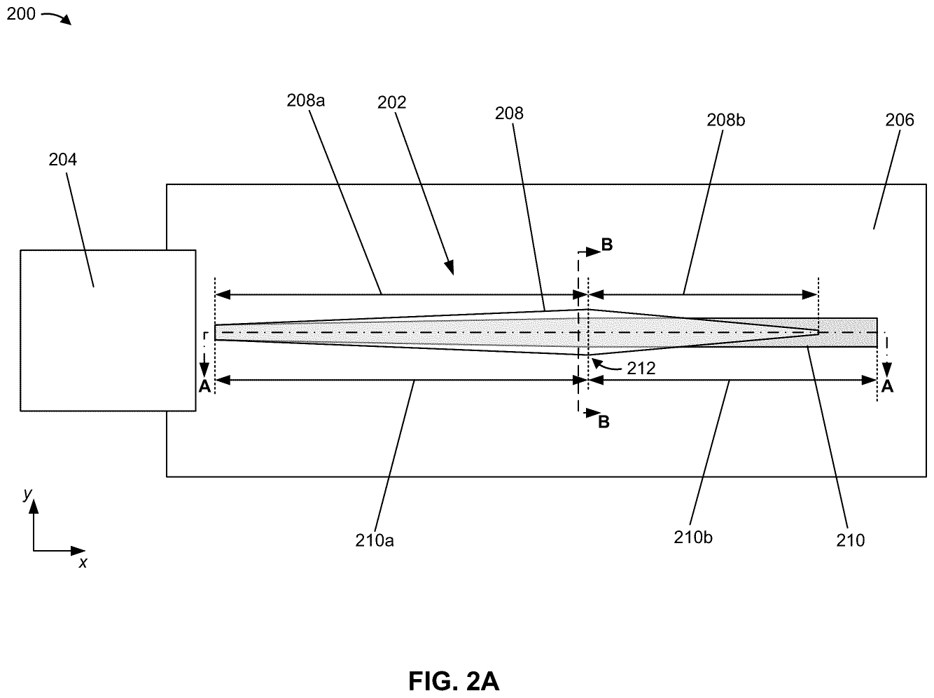

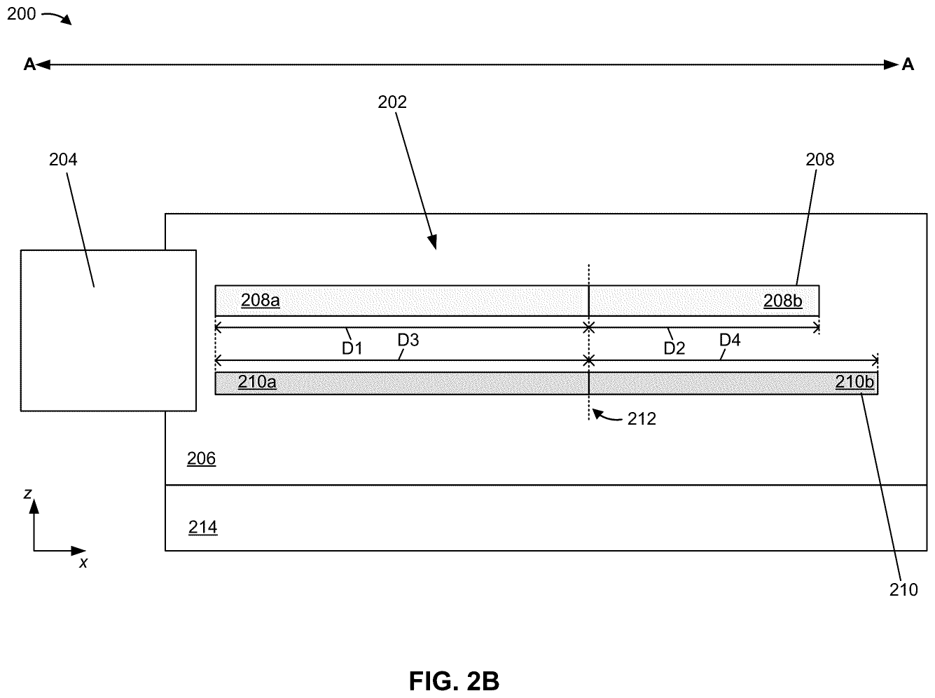

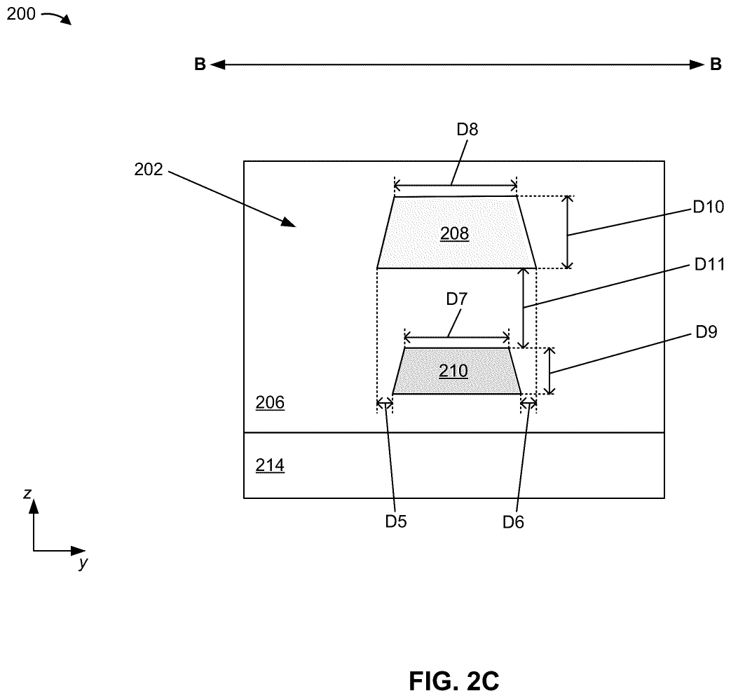

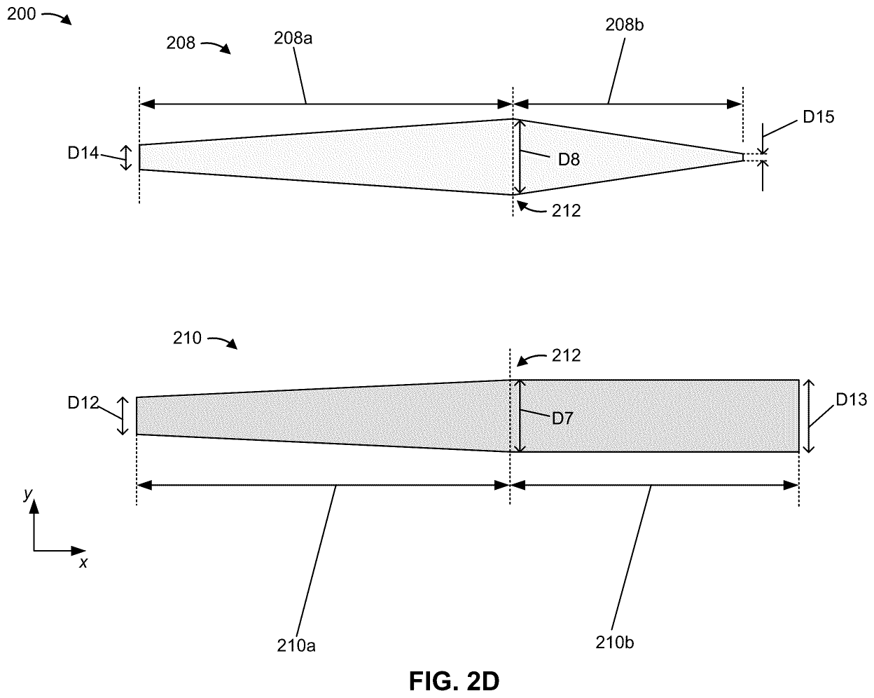

FIGS. 2A-2D are diagrams of an example semiconductor photonics device 200 described herein. The semiconductor photonics device 200 may include an optical coupling circuit such as an edge coupler or edge coupling circuit. The semiconductor photonics device 200 may be configured to provide optical signals between an optical signal input/output (I/O) (e.g., an optical fiber) and a photonic integrated circuit (PIC) for high-bandwidth optical communications.

FIG. 2A is a top-down view of an x-y plane of the semiconductor photonics device 200. As shown in FIG. 2A, the semiconductor photonics device 200 includes a multiple-layer coupler structure 202. The multiple-layer coupler structure 202 is optically coupled with an optical signal I/O 204 such as an optical fiber or fiber optic cable. The multiple-layer coupler structure 202 may be configured to provide optical signals between the optical signal I/O 204 and another structure of the semiconductor photonics device 200 such as a PIC (not shown). For example, the multiple-layer coupler structure 202 may receive an optical signal from the optical signal I/O 204 and provide the optical signal to a PIC. As another example, the multiple-layer coupler structure 202 may receive an optical signal from a PIC and provide the optical signal to the optical signal I/O 204.

The multiple-layer coupler structure 202 may be included in a dielectric layer 206 of the semiconductor photonics device 200. The dielectric layer 206 may include one or more dielectric materials, such as a silicon oxide (SiOₓ), a silicon nitride (SiₓN_{y}), a silicon oxynitride (SiON), tetraethyl orthosilicate oxide, phosphosilicate glass (PSG), borophosphosilicate glass (BPSG), fluorinated silicate glass (FSG), carbon doped silicon oxide, and/or another dielectric material.

The multiple-layer coupler structure 202 includes a plurality of optical coupler layers, such as an optical coupler layer 208 and an optical coupler layer 210. The optical coupler layers 208 and 210 may each include a waveguide structure that enables optical signals to be transferred between and through the optical coupler layers 208 and 210. The optical coupler layer 208 is adjacent to the optical coupler layer 210 in the dielectric layer 206. In some implementations, the optical coupler layers 208 and 210 are vertically adjacent in the semiconductor photonics device 200 in that the optical coupler layers 208 and 210 are arranged in a direction that is approximately perpendicular to the top surface of the dielectric layer 206. For example, the optical coupler layer 208 may be located above the optical coupler layer 210. In some implementations, the optical coupler layers 208 and 210 are horizontally adjacent in the semiconductor photonics device 200 in that the optical coupler layers 208 and 210 are side by side in the y-direction in the semiconductor photonics device 200.

Including a plurality of optical coupler layers in the multiple-layer coupler structure 202 enables one or more properties of the optical coupler layers 208 and/or 210 to be configured to achieve efficient optical coupling for a broad spectrum of optical wavelengths for the multiple-layer coupler structure 202. For example, the materials, refractive indices, shapes, sizes, positioning of the optical coupler layers 208 and/or 210 may be selected to achieve a high amount of confinement of optical signals for particular optical frequencies and/or a plurality of optical frequencies. This enables the advantages of the optical coupler layers 208 and/or 210 to be emphasized while ensuring compatibility between the optical coupler layers 208 and 210, which may reduce optical loss and may increase optical efficiency for the multiple-layer coupler structure 202 without unduly increasing the size of the multiple-layer coupler structure 202. This enables the multiple-layer coupler structure 202 to handle wide bandwidth optical signals, which enables the semiconductor photonics device 200 to support high-bandwidth optical communication applications while achieving a small form factor for the semiconductor photonics device 200.

As an example of the above, and as shown in the top-down view in FIG. 2A, the optical coupler layers 208 and 210 have different top view profiles. The optical coupler layer 208 has a segment 208a and a segment 208b. A top view width of the segment 208a (e.g., in the y-direction) increases from a first end of the optical coupler layer 208 facing the optical signal I/O 204 to an intermediate point 212 along the optical coupler layer 208 in the x-direction. The top view width of the segment 208b (e.g., in the y-direction) decreases from the intermediate point 212 along the optical coupler layer 208 in the x-direction to a second end of the optical coupler layer 208 opposing the first end. Thus, the segments 208a and 208b are tapered segments in the top-down view of the semiconductor photonics device 200, where the segments 208a and 208b have substantially straight-lined (or linear) tapered sidewalls. The intermediate point 212 is a location along the optical coupler layer 208 at which the taper of the optical coupler layer 208 transitions between the segment 208a and the segment 208b.

The optical coupler layer 210 has a segment 210a and a segment 210b. A top view width of the segment 210a (e.g., in the y-direction) increases from a first end of the optical coupler layer 210 facing the optical signal I/O 204 to the intermediate point 212 along the optical coupler layer 210 in the x-direction. The first ends and the intermediate points 212 of the optical coupler layers 208 and 210 may be substantially aligned. Thus, the segments 208a and 210a have approximately the same x-direction length. The segment 210b of the optical coupler layer 210 has a greater x-direction length than the segment 208b of the optical coupler layer 208. Thus, the segment 210b of the optical coupler layer 210 extends laterally outward in the x-direction from the segment 208b of the optical coupler layer 208.

The top view width of the segment 210b (e.g., in the y-direction) is substantially uniform between the intermediate point 212 along the optical coupler layer 210 in the x-direction and a second end of the optical coupler layer 210 opposing the first end. The top view width of the optical coupler layer 208 at the intermediate point 212 is greater than the top view width of the optical coupler layer 210 at the intermediate point 212, which enables optical signals to be confined in the optical coupler layer 208 with low optical loss before the optical signals are transferred to the optical coupler layer 210. The decreasing top view width of the optical coupler layer 208 along the segment 208b, and/or the greater x-direction length of the segment 210b, promotes the transfer of optical signals from the optical coupler layer 208 to the optical coupler layer 210.

As another example, the optical coupler layers 208 and 210 may be formed of different material compositions. The material compositions of the optical coupler layers 208 and 210 may be selected so that the respective refractive indices of the optical coupler layers 208 and 210 promote compatibility of the optical coupler layers 208 and 210 for optical coupling purposes. For example, the material composition of the optical coupler layer 208 may be selected such that the optical coupler layer 208 has a first refractive index, and the material composition of the optical coupler layer 210 may be selected such that the optical coupler layer 210 has a second refractive index that is greater than the first refractive index, which enables optical signals to be transferred from the optical coupler layer 208 to the optical coupler layer 210 with low optical loss.

The material composition of the optical coupler layer 208 may include one or more dielectrics materials having a low refractive index, and the material composition of the optical coupler layer 210 may include one or more semiconductor materials having a greater refractive index than the material composition of the optical coupler layer 208. As used herein, the term “low refractive index” refers to a refractive index that is less than the refractive index of silicon (Si) (e.g., less than approximately 3.5). Examples of dielectric materials for the optical coupler layer 208 include a silicon nitride material (SiₓN_{y} such as Si₃N₄), an aluminum oxide material (AlₓO_{y} such as Al₂O₃), an aluminum nitride material (AlN), a hafnium oxide material (HfOₓ such as HfO₂), a titanium oxide material (TiOₓ such as TiO₂), a zinc oxide material (ZnO), and/or a germanium oxide material (GeOₓ such as GeO₂), among other examples. Examples of semiconductor materials for the optical coupler layer 210 include silicon (Si), germanium (Ge), and/or another semiconductor material.

FIG. 2B illustrates a cross-section view of the semiconductor photonics device 200 along the line A-A in FIG. 2A in the x-direction through the centers of the optical coupler layers 208 and 210. As shown in FIG. 2B, the semiconductor photonics device 200 may further include a semiconductor substrate 214 above which the dielectric layer 206 is located. The semiconductor substrate 214 may include a silicon (Si) substrate, a germanium (Ge) substrate, and/or another type of semiconductor substrate. The optical coupler layers 208 and 210 are arranged in a z-direction in the semiconductor photonics device 200, which is approximately perpendicular to a surface of the semiconductor substrate 214. For example, the optical coupler layer 208 is located above the optical coupler layer 210. Alternatively, the optical coupler layers 208 and 210 may be arranged such that the optical coupler layers 208 and 210 are adjacent in the y-direction.

As further shown in FIG. 2B, the optical coupler layer 208 may have a dimension D1 and a dimension D2, and the optical coupler layer 210 may have a dimension D3 and a dimension D4. The dimension D1 corresponds to the x-direction length of the segment 208a of the optical coupler layer 208, and the dimension D2 corresponds to the x-direction length of the segment 208b of the optical coupler layer 208. In some implementations, the dimension D1 is greater than the dimension D2 to facilitate optical coupling of optical signals from the optical coupler layer 208 to the optical coupler layer 210. The dimension D4 may also be greater than the dimension D2 to facilitate optical coupling of optical signals from the optical coupler layer 208 to the optical coupler layer 210.

FIG. 2C illustrates a cross-section view of the semiconductor photonics device 200 along the line B-B in FIG. 2A in the y-direction through the optical coupler layers 208 and 210 at the intermediate point 212. As shown in FIG. 2C, the optical coupler layer 208 extends laterally outward from the optical coupler layer 210 on opposing sides of the optical coupler layer 210 in the y-direction by a dimension D5 and a dimension D6. In some implementations, the dimension D5 and the dimension D6 are approximately equal distances, while in other implementations the dimension D5 and the dimension D6 are different distances. The lateral extension of the optical coupler layer 208 occurs due to a y-direction width (indicated in FIG. 2C as dimension D7) of the optical coupler layer 210 being less than a y-direction width (indicated in FIG. 2C as dimension D8) of the optical coupler layer 208 at the intermediate point 212.

As further shown in FIG. 2C, the optical coupler layer 210 may have a dimension D9 corresponding to a z-direction thickness of the optical coupler layer 210. The optical coupler layer 208 may have a dimension D10 corresponding to a z-direction thickness of the optical coupler layer 208. The dimension D10 may be greater than the dimension D9. For example, a ratio of the dimension D10 to the dimension D9 may be greater than approximately 1:1 and less than or approximately equal to approximately 100:1. However, other values for the ratio of the dimension D10 to the dimension D9 are within the scope of the present disclosure. In some implementations, the dimension D9 is included in a range from approximately 0.01 microns to approximately 0.8 microns. However, other values for the range are within the scope of the present disclosure. In some implementations, the dimension D10 is included in a range from approximately 0.01 microns to approximately 1 micron. However, other values for the range are within the scope of the present disclosure.

As further shown in FIG. 2C, the optical coupler layers 208 and 210 are spaced apart by the dielectric layer 206 such that the optical coupler layers 208 and 210 are not in direct contact with each other. The distance between the optical coupler layers 208 and 210 (indicated in FIG. 2C as dimension D11) may be included in a range of approximately 0.02 microns to approximately 5 microns to minimize damage to the optical coupler layer 210 during formation of the optical coupler layer 208 while providing sufficient spacing between the optical coupler layers 208 and 210 to facilitate optical coupling between the optical coupler layers 208 and 210. If the dimension D11 is less than approximately 0.02 microns, the optical coupler layer 208 may be damaged due to etching of the dielectric layer 206 during formation of the optical coupler layer 210. If the dimension D11 is greater than approximately 5 microns, optical signals may experience a high amount of optical loss between the optical coupler layers 208 and 210. However, other values for the dimension D11, and ranges other than approximately 0.02 microns to approximately 5 microns, are within the scope of the present disclosure.

FIG. 2D illustrates a top-down view of the optical coupler layers 208 and 210. As shown in FIG. 2D, the top view width of the segment 210a (e.g., in the y-direction) increases from the first end of the optical coupler layer 210 facing the optical signal I/O 204 to the intermediate point 212 along the optical coupler layer 210 in the x-direction. Thus, the top view width of the segment 210a at the first end (indicated in FIG. 2D as dimension D12) is less than the top view width of the segment 210a at the intermediate point 212 (indicated in FIG. 2B as the dimension D7). The top view width of the segment 210b (e.g., in the y-direction) is substantially uniform between the intermediate point 212 along the optical coupler layer 210 in the x-direction and the second end of the optical coupler layer 210. Thus, the top view width of the segment 210b at the second end (indicated in FIG. 2D as dimension D13) is approximately equal to the top view width of the segment 210a at the intermediate point 212 (indicated in FIG. 2B as the dimension D7).

As further shown in FIG. 2D, the top view width of the segment 208a (e.g., in the y-direction) increases from the first end of the optical coupler layer 208 facing the optical signal I/O 204 to an intermediate point 212 along the optical coupler layer 208 in the x-direction. Thus, the top view width of the segment 208a at the first end (indicated in FIG. 2D as dimension D14) is less than the top view width of the segment 208a at the intermediate point 212 (indicated in FIG. 2B as the dimension D8). The top view width of the segment 208b (e.g., in the y-direction) decreases from the intermediate point 212 along the optical coupler layer 208 in the x-direction to the second end of the optical coupler layer 208 opposing the first end. Thus, the top view width of the segment 208b at the second end (indicated in FIG. 2D as dimension D15) is less than the top view width of the segment 208b at the intermediate point 212 (indicated in FIG. 2B as the dimension D8).

The width of the first end of the optical coupler layer 210 (D12) and the width of the first end of the optical coupler layer 208 (D14) may be approximately equal. The width of the second end of the optical coupler layer 210 (D13) may be greater than the width of the second end of the optical coupler layer 208 (D15) to facilitate optical coupling of optical signals from the optical coupler layer 208 to the optical coupler layer 210.

As indicated above, FIGS. 2A-2D are provided as an example. Other examples may differ from what is described with regard to FIGS. 2A-2D.

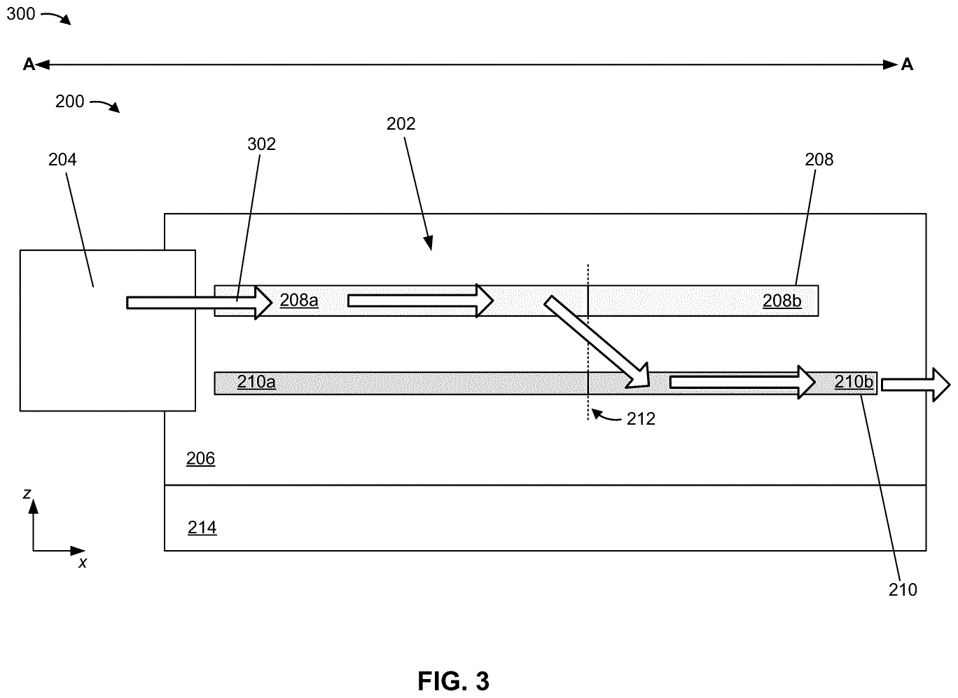

FIG. 3 is a diagram of an example implementation 300 of optical coupling in the semiconductor photonics device 200 described herein. As shown in FIG. 3, an optical signal path 302 of an optical signal may start at the optical signal I/O 204. The optical signal may propagate along the optical signal path 302 from the optical signal I/O 204 to the segment 208a of the optical coupler layer 208. Thus, the optical coupler layer 208 is optically coupled with the optical signal I/O 204. The optical signal may propagate along the segment 208a to the intermediate point 212 and may then transfer (e.g., downward) to the segment 210b of the optical coupler layer 210. Thus, the optical coupler layer 210 is optically coupled with the optical coupler layer 208. The optical signal may be transferred from the segment 210b of the optical coupler layer 210 to a PIC (not shown) and/or to another location in the semiconductor photonics device 200.

As indicated above, FIG. 3 is provided as an example. Other examples may differ from what is described with regard to FIG. 3.

FIGS. 4A-4E are diagrams of an example implementation 400 of forming the semiconductor photonics device 200 described herein. In some implementations, one or more of the semiconductor processing operations described in connection with FIGS. 4A-4E may be performed using one or more of the semiconductor processing tools 102-114 described herein. In some implementations, one or more of the semiconductor processing operations described in connection with FIGS. 4A-4E may be performed using another semiconductor processing tool.

Turning to FIG. 4A, a substrate 402 may be provided. The substrate 402 may include a silicon on insulator (SOI) substrate (or SOI wafer) that includes the semiconductor substrate 214 (e.g., a silicon (Si) substrate and/or another type of semiconductor substrate), a portion of the dielectric layer 206 (e.g., a buried oxide or bottom oxide (BOX) layer and/or another type of insulator layer) over and/or on the semiconductor substrate 214, and a semiconductor layer 404 (e.g., a silicon (Si) layer and/or another type of semiconductor layer) over and/or on the portion of the dielectric layer 206.

Alternatively, the semiconductor substrate 214 may be provided as a semiconductor wafer, and a deposition tool 102 may be used to form the portion of the dielectric layer 206 over and/or on the semiconductor substrate 214, and may form the semiconductor layer 404 over and/or on the portion of the dielectric layer 206. A deposition tool 102 may be used to form the portion of the dielectric layer 206 using a CVD technique, a PVD technique, an oxidation technique (e.g., a thermal oxidation technique), and/or another type of deposition technique. A deposition tool 102 may be used to form the semiconductor layer 404 using a CVD technique, a PVD technique, an epitaxy technique, and/or another type of deposition technique.

As shown in FIG. 4B, the optical coupler layer 210 may be formed in the semiconductor layer 404. In some implementations, a pattern in a hard mask layer is used to etch the semiconductor layer 404 to form the optical coupler layer 210. For example, a deposition tool 102 may be used to form the hard mask layer on the semiconductor layer 404 (e.g., using a CVD technique, a PVD technique, and/or another type of deposition technique), and may be used to form a photoresist layer on the hard mask layer (e.g., using a spin-coating technique and/or another type of deposition technique). An exposure tool 104 may be used to expose the photoresist layer to a radiation source to form a pattern in the photoresist layer. A developer tool 106 may be used to develop and remove portions of the photoresist layer to expose the pattern. An etch tool 108 may be used to etch the hard mask layer to transfer the pattern from the photoresist layer to the hard mask layer.

An etch tool 108 may be used to etch the semiconductor layer 404 based on the pattern in the hard mask layer to form the optical coupler layer 210 by removing portions of the semiconductor layer 404 based on the pattern. In some implementations, the etch operation includes a plasma etch operation, a wet chemical etch operation, and/or another type of etch operation. In some implementations, a photoresist removal tool removes the remaining portions of the photoresist layer (e.g., using a chemical stripper, plasma ashing, and/or another technique). In some implementations, a photoresist removal tool removes the remaining portions of the photoresist layer (e.g., using a chemical stripper, plasma ashing, and/or another technique). In some implementations, a planarization tool 110 is used to remove the remaining portions of the hard mask layer using a CMP technique and/or another type of planarization technique.

As shown in FIG. 4C, additional material for the dielectric layer 206 may be deposited to encapsulate the optical coupler layer 210. A deposition tool 102 may be used to deposit the additional material for the dielectric layer 206 using a CVD technique, a PVD technique, an oxidation technique (e.g., a thermal oxidation technique), and/or another type of deposition technique. In some implementations, a planarization tool 110 is used to planarize the dielectric layer 206 after the additional material of the dielectric layer 206 is deposited.

As shown in FIG. 4D, the optical coupler layer 208 is formed in the dielectric layer 206. The optical coupler layer 208 may be formed above the optical coupler layer 210. The optical coupler layer 208 may be formed in a recess in the dielectric layer 206. In some implementations, a pattern in a photoresist layer is used to etch the dielectric layer 206 to form the recess. In these implementations, the deposition tool 102 may be used to form the photoresist layer on the dielectric layer 206. The exposure tool 104 may be used to expose the photoresist layer to a radiation source to pattern the photoresist layer. The developer tool 106 may be used to develop and remove portions of the photoresist layer to expose the pattern. The etch tool 108 may be used to etch the dielectric layer 206 based on the pattern to form the recess in the dielectric layer 206. In some implementations, the etch operation includes a plasma etch operation, a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the dielectric layer 206 based on a pattern.

A deposition tool 102 may be used to deposit the optical coupler layer 208 in the recess using a CVD technique, a PVD technique, an oxidation technique (e.g., a thermal oxidation technique), and/or another type of deposition technique. In some implementations, a planarization tool 110 is used to planarize the optical coupler layer 208 and/or the dielectric layer 206 after the optical coupler layer 208 is deposited.

As shown in FIG. 4E, additional material for the dielectric layer 206 may be deposited to encapsulate the optical coupler layer 208. A deposition tool 102 may be used to deposit the additional material for the dielectric layer 206 using a CVD technique, a PVD technique, an oxidation technique (e.g., a thermal oxidation technique), and/or another type of deposition technique. In some implementations, a planarization tool 110 is used to planarize the dielectric layer 206 after the additional material of the dielectric layer 206 is deposited.

As indicated above, FIGS. 4A-4E are provided as an example. Other examples may differ from what is described with regard to FIGS. 4A-4E.

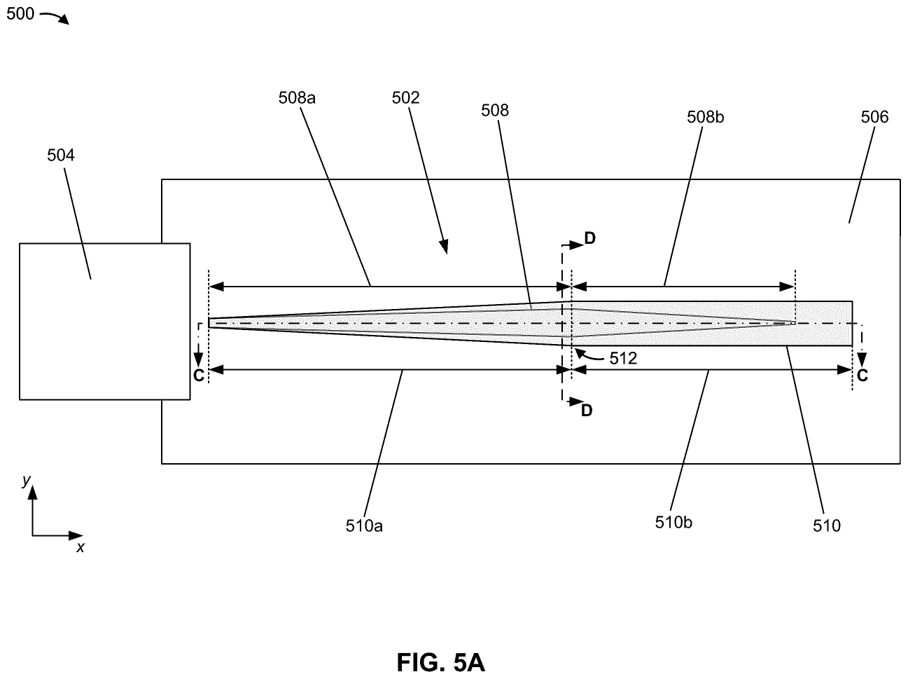

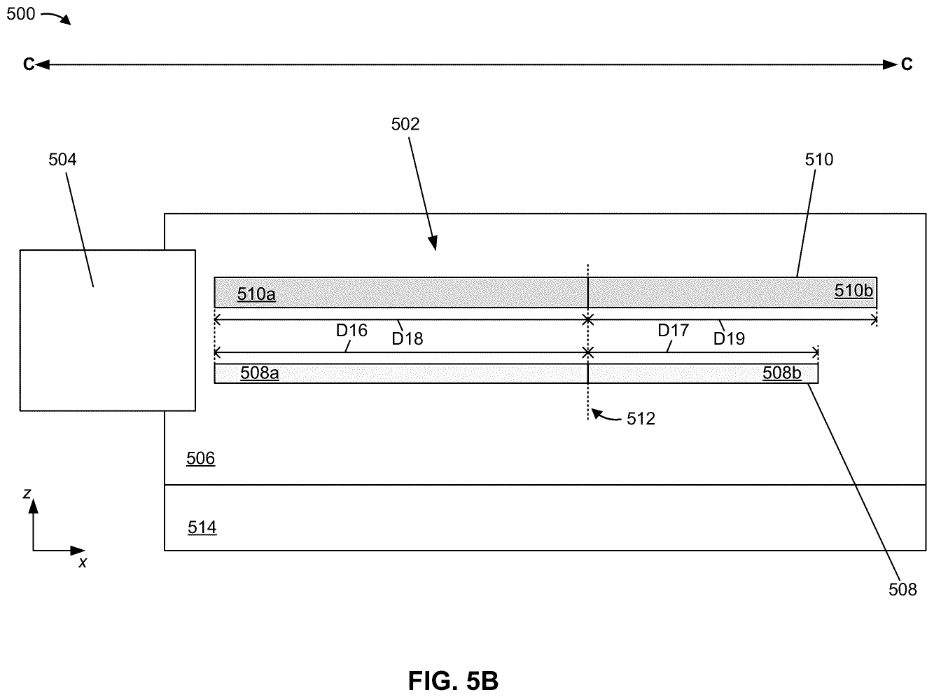

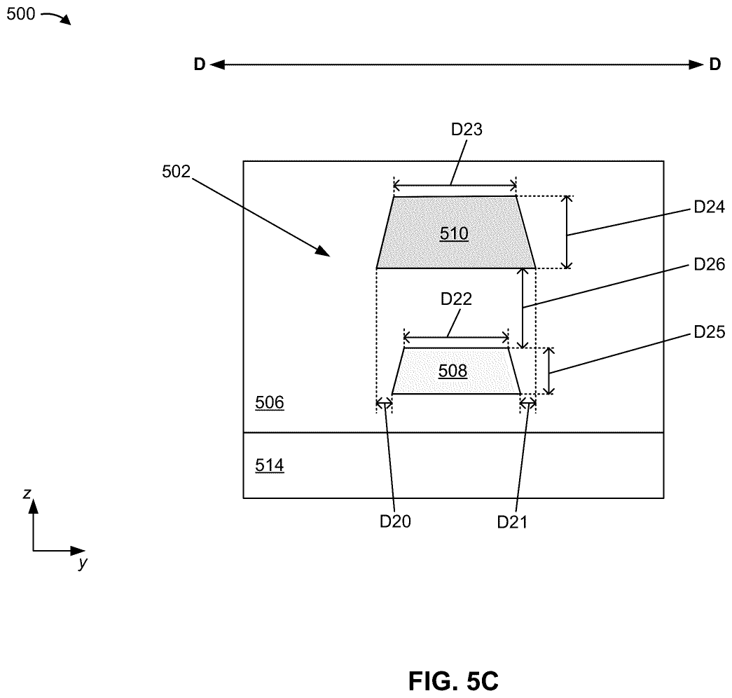

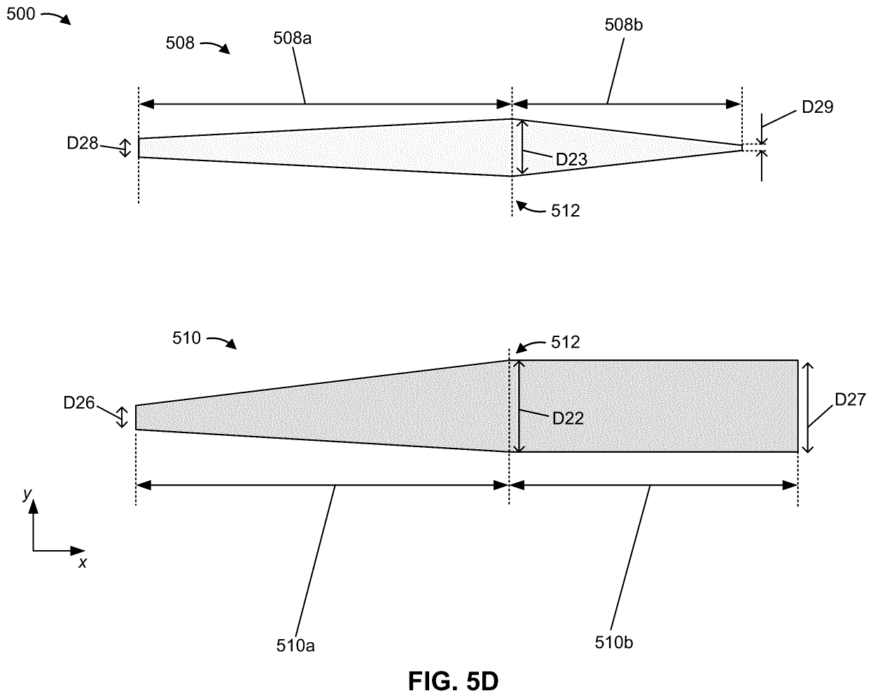

FIGS. 5A-5D are diagrams of an example semiconductor photonics device 500 described herein. The semiconductor photonics device 500 may include an optical coupling circuit such as an edge coupler or edge coupling circuit. The semiconductor photonics device 500 may be configured to provide optical signals between an optical signal I/O (e.g., an optical fiber) and a PIC for high-bandwidth optical communications.

FIG. 5A is a top-down view of an x-y plane of the semiconductor photonics device 500. As shown in FIG. 5A, the semiconductor photonics device 500 includes a multiple-layer coupler structure 502. The multiple-layer coupler structure 502 is optically coupled with an optical signal I/O 504. The multiple-layer coupler structure 502 may be configured to provide optical signals between the optical signal I/O 504 and another structure of the semiconductor photonics device 500 such as a PIC (not shown). For example, the multiple-layer coupler structure 502 may receive an optical signal from the optical signal I/O 504 and provide the optical signal to a PIC. As another example, the multiple-layer coupler structure 502 may receive an optical signal from a PIC and provide the optical signal to the optical signal I/O 504.

The multiple-layer coupler structure 502 may be included in a dielectric layer 506 of the semiconductor photonics device 500. The dielectric layer 506 may include one or more dielectric materials, such as a silicon oxide (SiOₓ), a silicon nitride (SiₓN_{y}), a silicon oxynitride (SiON), tetraethyl orthosilicate oxide, phosphosilicate glass (PSG), borophosphosilicate glass (BPSG), fluorinated silicate glass (FSG), carbon doped silicon oxide, and/or another dielectric material.

The multiple-layer coupler structure 502 includes a plurality of optical coupler layers, such as an optical coupler layer 508 and an optical coupler layer 510. The optical coupler layers 508 and 510 may each include a waveguide structure that enables optical signals to be transferred between and through the optical coupler layers 508 and 510. The optical coupler layer 508 is adjacent to the optical coupler layer 510 in the dielectric layer 506. In some implementations, the optical coupler layers 508 and 510 are vertically adjacent in the semiconductor photonics device 500 in that the optical coupler layers 508 and 510 are arranged in a direction that is approximately perpendicular to the top surface of the dielectric layer 506. For example, the optical coupler layer 510 may be located above the optical coupler layer 508. In some implementations, the optical coupler layers 508 and 510 are horizontally adjacent in the semiconductor photonics device 500 in that the optical coupler layers 508 and 510 are side by side in the y-direction in the semiconductor photonics device 500.

As shown in the top-down view in FIG. 5A, the optical coupler layers 508 and 510 have different top view profiles. The optical coupler layer 508 has a segment 508a and a segment 508b. A top view width of the segment 508a (e.g., in the y-direction) increases from a first end of the optical coupler layer 508 facing the optical signal I/O 504 to an intermediate point 512 along the optical coupler layer 508 in the x-direction. The top view width of the segment 508b (e.g., in the y-direction) decreases from the intermediate point 512 along the optical coupler layer 508 in the x-direction to a second end of the optical coupler layer 508 opposing the first end. Thus, the segments 508a and 508b are tapered segments in the top-down view of the semiconductor photonics device 500, where the segments 508a and 508b have substantially straight-lined tapered sidewalls. The intermediate point 512 is a location along the optical coupler layer 508 at which the taper of the optical coupler layer 508 transitions between the segment 508a and the segment 508b.

The optical coupler layer 510 has a segment 510a and a segment 510b. A top view width of the segment 510a (e.g., in the y-direction) increases from a first end of the optical coupler layer 510 facing the optical signal I/O 504 to the intermediate point 512 along the optical coupler layer 510 in the x-direction. The first ends and the intermediate points 512 of the optical coupler layers 508 and 510 may be substantially aligned. Thus, the segments 508a and 510a have approximately the same x-direction length. The segment 510b of the optical coupler layer 510 has a greater x-direction length than the segment 508b of the optical coupler layer 508. Thus, the segment 510b of the optical coupler layer 510 extends laterally outward in the x-direction from the segment 508b of the optical coupler layer 508.

The top view width of the segment 510b (e.g., in the y-direction) is substantially uniform between the intermediate point 512 along the optical coupler layer 510 in the x-direction and a second end of the optical coupler layer 510 opposing the first end. The top view width of the optical coupler layer 510 at the intermediate point 512 is greater than the top view width of the optical coupler layer 508 at the intermediate point 512. The decreasing top view width of the optical coupler layer 508 along the segment 508b, and/or the greater x-direction length of the segment 510b, promotes the transfer of optical signals from the optical coupler layer 508 to the optical coupler layer 510.

Additionally and/or alternatively to the different top view profiles, the optical coupler layers 508 and 510 may be formed of different material compositions. The material compositions of the optical coupler layers 508 and 510 may be selected so that the respective refractive indices of the optical coupler layers 508 and 510 promote compatibility of the optical coupler layers 508 and 510 for optical coupling purposes. For example, the material composition of the optical coupler layer 508 may be selected such that the optical coupler layer 508 has a first refractive index, and the material composition of the optical coupler layer 510 may be selected such that the optical coupler layer 510 has a second refractive index that is less than the first refractive index. The combination of the lower refractive index and lesser top view width in the y-direction of the optical coupler layer 508 enables optical signals to be transferred from the optical coupler layer 508 to the optical coupler layer 510 with low optical loss.

The material composition of the optical coupler layer 508 may include one or more semiconductor materials having a greater refractive index than the material composition of the optical coupler layer 510, and the material composition of the optical coupler layer 510 may include one or more dielectrics materials having a low refractive index. Examples of dielectric materials for the optical coupler layer 510 include a silicon nitride material (SiₓN_{y} such as Si₃N₄), an aluminum oxide material (AlₓO_{y} such as Al₂O₃), an aluminum nitride material (AlN), a hafnium oxide material (HfOₓ such as HfO₂), a titanium oxide material (TiOₓ such as TiO₂), a zinc oxide material (ZnO), and/or a germanium oxide material (GeOₓ such as GeO₂), among other examples. Examples of semiconductor materials for the optical coupler layer 508 include silicon (Si), germanium (Ge), and/or another semiconductor material.

FIG. 5B illustrates a cross-section view of the semiconductor photonics device 500 along the line C-C in FIG. 5A in the x-direction through the centers of the optical coupler layers 508 and 510. As shown in FIG. 5B, the semiconductor photonics device 500 may further include a semiconductor substrate 514 above which the dielectric layer 506 is located. The semiconductor substrate 514 may include a semiconductor substrate such as a silicon (Si) substrate, a germanium (Ge) substrate, and/or another type of semiconductor substrate. The optical coupler layers 508 and 510 are arranged in a z-direction in the semiconductor photonics device 500, which is approximately perpendicular to a surface of the semiconductor substrate 514. For example, the optical coupler layer 510 is located above the optical coupler layer 508. Alternatively, the optical coupler layers 508 and 510 may be arranged such that the optical coupler layers 508 and 510 are adjacent in the y-direction.

As further shown in FIG. 5B, the optical coupler layer 508 may have a dimension D16 and a dimension D17, and the optical coupler layer 510 may have a dimension D18 and a dimension D19. The dimension D16 corresponds to the x-direction length of the segment 508a of the optical coupler layer 508, and the dimension D17 corresponds to the x-direction length of the segment 508b of the optical coupler layer 508. In some implementations, the dimension D16 is greater than the dimension D17 to facilitate optical coupling of optical signals from the optical coupler layer 508 to the optical coupler layer 510. The dimension D19 may also be greater than the dimension D17 to facilitate optical coupling of optical signals from the optical coupler layer 508 to the optical coupler layer 510.

FIG. 5C illustrates a cross-section view of the semiconductor photonics device 500 along the line D-D in FIG. 5A in the y-direction through the optical coupler layers 508 and 510 at the intermediate point 512. As shown in FIG. 5C, the optical coupler layer 510 extends laterally outward from the optical coupler layer 508 on opposing sides of the optical coupler layer 508 in the y-direction by a dimension D20 and a dimension D21. In some implementations, the dimension D20 and the dimension D21 are approximately equal distances, while in other implementations the dimension D20 and the dimension D21 are different distances. The lateral extension of the optical coupler layer 510 occurs due to a y-direction width (indicated in FIG. 5C as dimension D22) of the optical coupler layer 508 being less than a y-direction width (indicated in FIG. 5C as dimension D23) of the optical coupler layer 510 at the intermediate point 512.

As further shown in FIG. 5C, the optical coupler layer 510 may have a dimension D24 corresponding to a z-direction thickness of the optical coupler layer 510. The optical coupler layer 508 may have a dimension D25 corresponding to a z-direction thickness of the optical coupler layer 508. The dimension D24 may be greater than the dimension D25. For example, a ratio of the dimension D24 to the dimension D25 may be greater than approximately 1:1 and less than or approximately equal to approximately 100:1. However, other values for the ratio of the dimension D24 to the dimension D25 are within the scope of the present disclosure. In some implementations, the dimension D24 is included in a range from approximately 0.01 microns to approximately 0.8 microns. However, other values for the range are within the scope of the present disclosure. In some implementations, the dimension D25 is included in a range from approximately 0.01 microns to approximately 1 micron. However, other values for the range are within the scope of the present disclosure.

As further shown in FIG. 5C, the optical coupler layers 508 and 510 are spaced apart by the dielectric layer 506 such that the optical coupler layers 508 and 510 are not in direct contact with each other. The distance between the optical coupler layers 508 and 510 (indicated in FIG. 5C as dimension D26) may be included in a range of approximately 0.02 microns to approximately 5 microns to minimize damage to the optical coupler layer 510 during formation of the optical coupler layer 508, while providing sufficient spacing between the optical coupler layers 508 and 510 to facilitate optical coupling between the optical coupler layers 508 and 510. If the dimension D26 is less than approximately 0.02 microns, the optical coupler layer 508 may be damaged due to etching of the dielectric layer 506 during formation of the optical coupler layer 510. If the dimension D26 is greater than approximately 5 microns, optical signals may experience a high amount of optical loss between the optical coupler layers 508 and 510. However, other values for the dimension D26, and ranges other than approximately 0.02 microns to approximately 5 microns, are within the scope of the present disclosure.

FIG. 5D illustrates a top-down view of the optical coupler layers 508 and 510. As shown in FIG. 5D, the top view width of the segment 510a (e.g., in the y-direction) increases from the first end of the optical coupler layer 510 facing the optical signal I/O 504 to the intermediate point 512 along the optical coupler layer 510 in the x-direction. Thus, the top view width of the segment 510a at the first end (indicated in FIG. 5D as dimension D26) is less than the top view width of the segment 510a at the intermediate point 512 (indicated in FIG. 5B as the dimension D22). The top view width of the segment 510b (e.g., in the y-direction) is substantially uniform between the intermediate point 512 along the optical coupler layer 510 in the x-direction and the second end of the optical coupler layer 510. Thus, the top view width of the segment 510b at the second end (indicated in FIG. 5D as dimension D27) is approximately equal to the top view width of the segment 510a at the intermediate point 512 (indicated in FIG. 5B as the dimension D22).

As further shown in FIG. 5D, the top view width of the segment 508a (e.g., in the y-direction) increases from the first end of the optical coupler layer 508 facing the optical signal I/O 504 to an intermediate point 512 along the optical coupler layer 508 in the x-direction. Thus, the top view width of the segment 508a at the first end (indicated in FIG. 5D as dimension D28) is less than the top view width of the segment 508a at the intermediate point 512 (indicated in FIG. 5B as the dimension D23). The top view width of the segment 508b (e.g., in the y-direction) decreases from the intermediate point 512 along the optical coupler layer 508 in the x-direction to the second end of the optical coupler layer 508 opposing the first end. Thus, the top view width of the segment 508b at the second end (indicated in FIG. 5D as dimension D29) is less than the top view width of the segment 508b at the intermediate point 512 (indicated in FIG. 5B as the dimension D23).

The width of the first end of the optical coupler layer 510 (D26) and the width of the first end of the optical coupler layer 508 (D28) may be approximately equal. The width of the second end of the optical coupler layer 510 (D27) may be greater than the width of the second end of the optical coupler layer 508 (D29) to facilitate optical coupling of optical signals from the optical coupler layer 508 to the optical coupler layer 510.

As indicated above, FIGS. 5A-5D are provided as an example. Other examples may differ from what is described with regard to FIGS. 5A-5D.

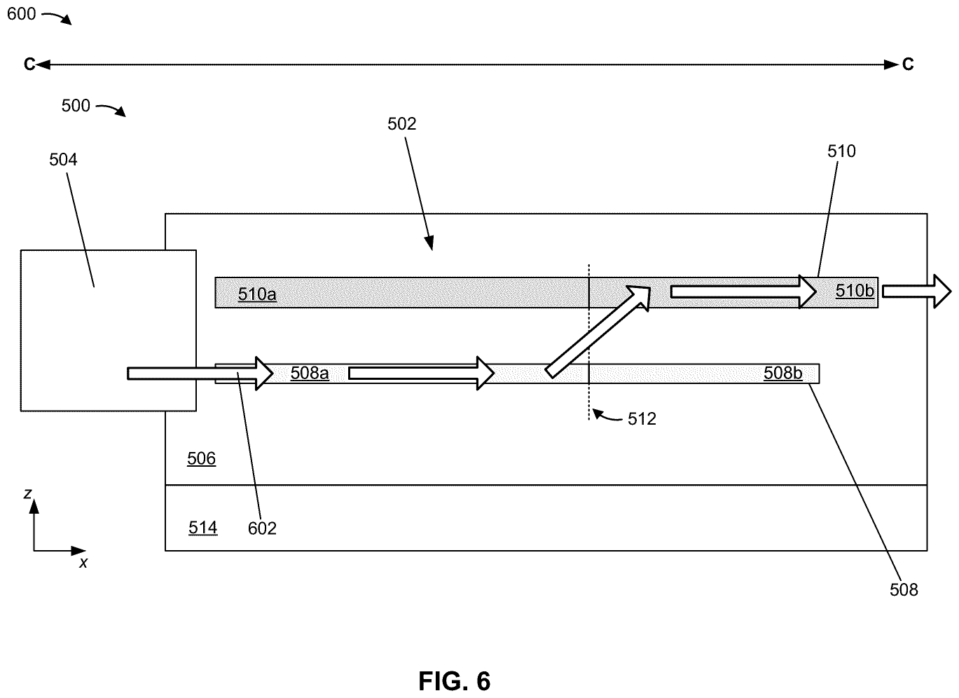

FIG. 6 is a diagram of an example implementation 600 of optical coupling in the semiconductor photonics device 500 described herein. As shown in FIG. 6, an optical signal path 602 of an optical signal may start at the optical signal I/O 504. The optical signal may propagate along the optical signal path 602 from the optical signal I/O 504 to the segment 508a of the optical coupler layer 508. Thus, the optical coupler layer 508 is optically coupled with the optical signal I/O 504. The optical signal may propagate along the segment 508a to the intermediate point 512 and may then transfer (e.g., upward) to the segment 510b of the optical coupler layer 510. Thus, the optical coupler layer 510 is optically coupled with the optical coupler layer 508. The optical signal may be transferred from the segment 510b of the optical coupler layer 510 to a PIC (not shown) and/or to another location in the semiconductor photonics device 500.

As indicated above, FIG. 6 is provided as an example. Other examples may differ from what is described with regard to FIG. 6.

FIGS. 7A-7E are diagrams of an example implementation 700 of forming the semiconductor photonics device 500 described herein. In some implementations, one or more of the semiconductor processing operations described in connection with FIGS. 7A-7E may be performed using one or more of the semiconductor processing tools 102-114 described herein. In some implementations, one or more of the semiconductor processing operations described in connection with FIGS. 7A-7E may be performed using another semiconductor processing tool.

Turning to FIG. 7A, a substrate 702 may be provided. The substrate 702 may include an SOI substrate (or SOI wafer) that includes the semiconductor substrate 514 (e.g., a silicon (Si) substrate and/or another type of semiconductor substrate), a portion of the dielectric layer 506 (e.g., a BOX layer and/or another type of insulator layer) over and/or on the semiconductor substrate 514, and a semiconductor layer 704 (e.g., a silicon (Si) layer and/or another type of semiconductor layer) over and/or on the portion of the dielectric layer 506.

Alternatively, the semiconductor substrate 514 may be provided as a semiconductor wafer, and a deposition tool 102 may be used to form the portion of the dielectric layer 506 over and/or on the semiconductor substrate 514, and may form the semiconductor layer 704 over and/or on the portion of the dielectric layer 506. A deposition tool 102 may be used to form the portion of the dielectric layer 506 using a CVD technique, a PVD technique, an oxidation technique (e.g., a thermal oxidation technique), and/or another type of deposition technique. A deposition tool 102 may be used to form the semiconductor layer 704 using a CVD technique, a PVD technique, an epitaxy technique, and/or another type of deposition technique.

As shown in FIG. 7B, the optical coupler layer 508 may be formed in the semiconductor layer 704. In some implementations, a pattern in a hard mask layer is used to etch the semiconductor layer 704 to form the optical coupler layer 508. For example, a deposition tool 102 may be used to form the hard mask layer on the semiconductor layer 704 (e.g., using a CVD technique, a PVD technique, and/or another type of deposition technique), and may be used to form a photoresist layer on the hard mask layer (e.g., using a spin-coating technique and/or another type of deposition technique). An exposure tool 104 may be used to expose the photoresist layer to a radiation source to form a pattern in the photoresist layer. A developer tool 106 may be used to develop and remove portions of the photoresist layer to expose the pattern. An etch tool 108 may be used to etch the hard mask layer to transfer the pattern from the photoresist layer to the hard mask layer.

An etch tool 108 may be used to etch the semiconductor layer 704 based on the pattern in the hard mask layer to form the optical coupler layer 508 by removing portions of the semiconductor layer 704 based on the pattern. In some implementations, the etch operation includes a plasma etch operation, a wet chemical etch operation, and/or another type of etch operation. In some implementations, a photoresist removal tool removes the remaining portions of the photoresist layer (e.g., using a chemical stripper, plasma ashing, and/or another technique). In some implementations, a photoresist removal tool removes the remaining portions of the photoresist layer (e.g., using a chemical stripper, plasma ashing, and/or another technique). In some implementations, a planarization tool 110 is used to remove the remaining portions of the hard mask layer using a CMP technique and/or another type of planarization technique.

As shown in FIG. 7C, additional material for the dielectric layer 506 may be deposited to encapsulate the optical coupler layer 508. A deposition tool 102 may be used to deposit the additional material for the dielectric layer 506 using a CVD technique, a PVD technique, an oxidation technique (e.g., a thermal oxidation technique), and/or another type of deposition technique. In some implementations, a planarization tool 110 is used to planarize the dielectric layer 506 after the additional material of the dielectric layer 506 is deposited.

As shown in FIG. 7D, the optical coupler layer 510 is formed in the dielectric layer 506. The optical coupler layer 510 may be formed above the optical coupler layer 508. The optical coupler layer 510 may be formed in a recess in the dielectric layer 506. In some implementations, a pattern in a photoresist layer is used to etch the dielectric layer 506 to form the recess. In these implementations, the deposition tool 102 may be used to form the photoresist layer on the dielectric layer 506. The exposure tool 104 may be used to expose the photoresist layer to a radiation source to pattern the photoresist layer. The developer tool 106 may be used to develop and remove portions of the photoresist layer to expose the pattern. The etch tool 108 may be used to etch the dielectric layer 506 based on the pattern to form the recess in the dielectric layer 506. In some implementations, the etch operation includes a plasma etch operation, a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the dielectric layer 506 based on a pattern.

A deposition tool 102 may be used to deposit the optical coupler layer 510 in the recess using a CVD technique, a PVD technique, an oxidation technique (e.g., a thermal oxidation technique), and/or another type of deposition technique. In some implementations, a planarization tool 110 is used to planarize the optical coupler layer 510 and/or the dielectric layer 506 after the optical coupler layer 510 is deposited.

As shown in FIG. 7E, additional material for the dielectric layer 506 may be deposited to encapsulate the optical coupler layer 510. A deposition tool 102 may be used to deposit the additional material for the dielectric layer 506 using a CVD technique, a PVD technique, an oxidation technique (e.g., a thermal oxidation technique), and/or another type of deposition technique. In some implementations, a planarization tool 110 is used to planarize the dielectric layer 506 after the additional material of the dielectric layer 506 is deposited.

As indicated above, FIGS. 7A-7E are provided as an example. Other examples may differ from what is described with regard to FIGS. 7A-7E.

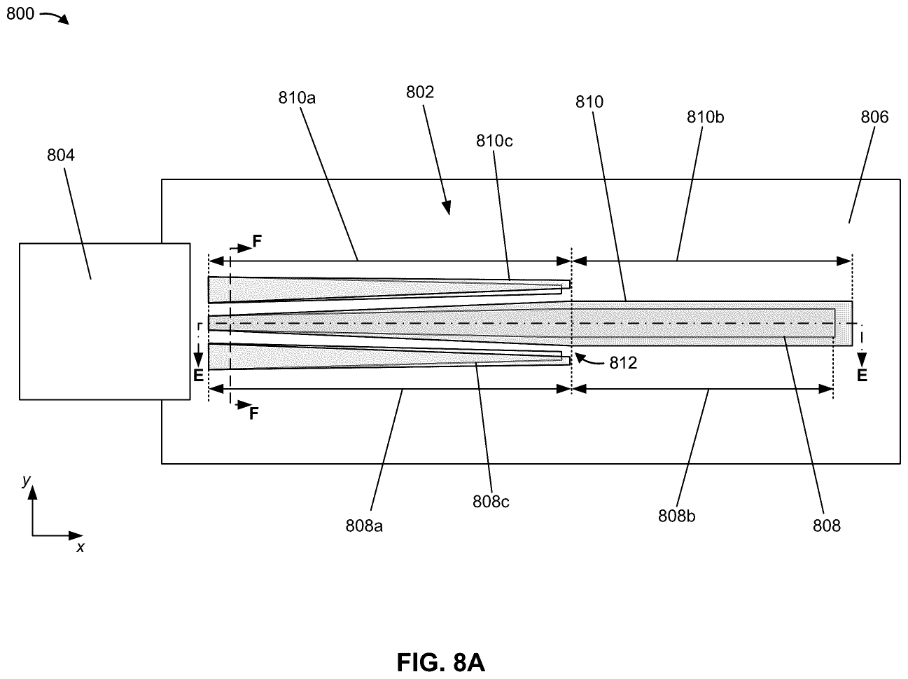

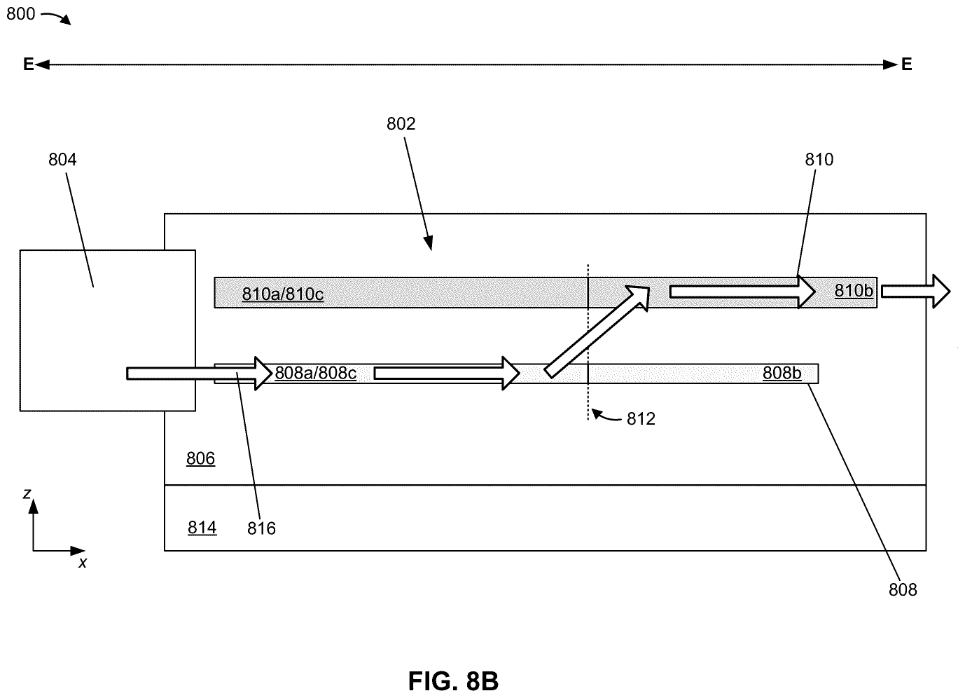

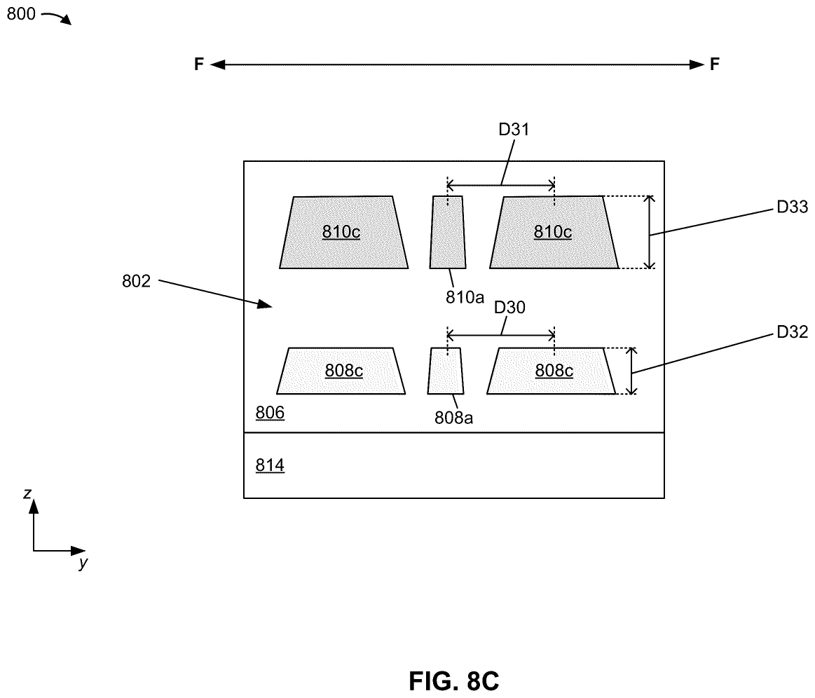

FIGS. 8A-8C are diagrams of an example semiconductor photonics device 800 described herein. The semiconductor photonics device 800 may include an optical coupling circuit such as an edge coupler or edge coupling circuit. The semiconductor photonics device 800 may be configured to provide optical signals between an optical signal I/O (e.g., an optical fiber) and a PIC for high-bandwidth optical communications.

FIG. 8A is a top-down view of an x-y plane of the semiconductor photonics device 800. As shown in FIG. 8A, the semiconductor photonics device 800 includes a multiple-layer coupler structure 802. The multiple-layer coupler structure 802 is optically coupled with an optical signal I/O 804. The multiple-layer coupler structure 802 may be configured to provide optical signals between the optical signal I/O 804 and another structure of the semiconductor photonics device 800 such as a PIC (not shown). For example, the multiple-layer coupler structure 802 may receive an optical signal from the optical signal I/O 804 and provide the optical signal to a PIC. As another example, the multiple-layer coupler structure 802 may receive an optical signal from a PIC and provide the optical signal to the optical signal I/O 804.

The multiple-layer coupler structure 802 may be included in a dielectric layer 806 of the semiconductor photonics device 800. The dielectric layer 806 may include one or more dielectric materials, such as a silicon oxide (SiOₓ), a silicon nitride (SiₓN_{y}), a silicon oxynitride (SiON), tetraethyl orthosilicate oxide, phosphosilicate glass (PSG), borophosphosilicate glass (BPSG), fluorinated silicate glass (FSG), carbon doped silicon oxide, and/or another dielectric material.

The multiple-layer coupler structure 802 includes a plurality of optical coupler layers, such as an optical coupler layer 808 and an optical coupler layer 810. The optical coupler layers 808 and 810 may each include a plurality of waveguides that enable optical signals to be transferred between and through the optical coupler layers 808 and 810. The plurality of waveguides of the optical coupler layer 808 correspond to a segment 808a and a segment 808b being a first waveguide, and a plurality of segments 808c on opposing sides of the segment 808a in the y-direction being a plurality of second waveguides. The plurality of waveguides of the optical coupler layer 810 correspond to a segment 810a and a segment 810b being a first waveguide, and a plurality of segments 810c on opposing sides of the segment 810a in the y-direction being a plurality of second waveguides.

The optical coupler layer 808 is adjacent to the optical coupler layer 810 in the dielectric layer 806. In some implementations, the optical coupler layers 808 and 810 are vertically adjacent in the semiconductor photonics device 800 in that the optical coupler layers 808 and 810 are arranged in a direction that is approximately perpendicular to the top surface of the dielectric layer 806. For example, the optical coupler layer 810 may be located above the optical coupler layer 808. In some implementations, the optical coupler layers 808 and 810 are horizontally adjacent in the semiconductor photonics device 800 in that the optical coupler layers 808 and 810 are side by side in the y-direction in the semiconductor photonics device 800.

The optical coupler layers 808 and 810 have different top view profiles. A top view width of the segment 808a (e.g., in the y-direction) increases from a first end of the optical coupler layer 808 facing the optical signal I/O 804 to an intermediate point 812 along the optical coupler layer 808 in the x-direction. Thus, the segment 808a is a tapered segment in the top-down view of the semiconductor photonics device 800, where the segment 808a has substantially straight-lined tapered sidewalls. A top view width of the segment 808b (e.g., in the y-direction) is substantially uniform between the intermediate point 812 along the optical coupler layer 808 in the x-direction and a second end of the optical coupler layer 808 opposing the first end. A top view width of the segments 808c (e.g., in the y-direction) decreases from the first end of the optical coupler layer 808 facing the optical signal I/O 804 to the intermediate point 812 along the optical coupler layer 808 in the x-direction. Thus, the segments 808c are tapered segments in the top-down view of the semiconductor photonics device 800, where the segments 808c have substantially straight-lined tapered sidewalls. The segment 808a and the segments 808c having different widths along the y-direction enables optical signals to be confined within and/or between the segment 808a and the segments 808c. Moreover, the tapers of the segment 808a and the segments 808c enable optical signals to be focused and merged before the optical signals are transferred to the optical coupler layer 810.

A top view width of the segment 810a (e.g., in the y-direction) increases from a first end of the optical coupler layer 810 facing the optical signal I/O 804 to the intermediate point 812 along the optical coupler layer 810 in the x-direction. The first ends and the intermediate points 812 of the optical coupler layers 808 and 810 may be substantially aligned. Thus, the segments 808a and 810a have approximately the same x-direction length. The segment 810b of the optical coupler layer 810 has a greater x-direction length than the segment 808b of the optical coupler layer 808. Thus, the segment 810b of the optical coupler layer 810 extends laterally outward in the x-direction from the segment 808b of the optical coupler layer 808.

The top view width of the segment 810b (e.g., in the y-direction) is substantially uniform between the intermediate point 812 along the optical coupler layer 810 in the x-direction and a second end of the optical coupler layer 810 opposing the first end. The top view width of the optical coupler layer 810 at the intermediate point 812 is greater than the top view width of the optical coupler layer 808 at the intermediate point 812. The decreasing top view width of the optical coupler layer 808 along the segment 808b, and/or the greater x-direction length of the segment 810b, promotes the transfer of optical signals from the optical coupler layer 808 to the optical coupler layer 810.

A top view width of the segments 810c (e.g., in the y-direction) decreases from the first end of the optical coupler layer 810 facing the optical signal I/O 804 to the intermediate point 812 along the optical coupler layer 810 in the x-direction. Thus, the segments 810c are tapered segments in the top-down view of the semiconductor photonics device 800, where the segments 810c have substantially straight-lined tapered sidewalls. The segment 808a and the segments 810c having different widths along the y-direction enable optical signals to be confined within and/or between the segment 810a and the segments 810c. In some implementations, the segments 808c and the segments 810c have approximately the same x-direction length. In some implementations, the segments 810c have a greater x-direction length than the x-direction length of the segments 808c.

Additionally and/or alternatively to the different top view profiles, the optical coupler layers 808 and 810 may be formed of different material compositions. The material compositions of the optical coupler layers 808 and 810 may be selected so that the respective refractive indices of the optical coupler layers 808 and 810 promote compatibility of the optical coupler layers 808 and 810 for optical coupling purposes. For example, the material composition of the optical coupler layer 808 may be selected such that the optical coupler layer 808 has a first refractive index, the material composition of the optical coupler layer 810 may be selected such that the optical coupler layer 810 has a second refractive index that is less than the first refractive index. The combination of the lower refractive index and lesser top view width in the y-direction of the optical coupler layer 808 enables optical signals to be transferred from the optical coupler layer 808 to the optical coupler layer 810 with low optical loss.

The material composition of the optical coupler layer 808 may include one or more semiconductor materials having a greater refractive index than the material composition of the optical coupler layer 810, and the material composition of the optical coupler layer 810 may include one or more dielectrics materials having a low refractive index. Examples of dielectric materials for the optical coupler layer 810 include a silicon nitride material (SiₓN_{y} such as Si₃N₄), an aluminum oxide material (AlₓO_{y} such as Al₂O₃), an aluminum nitride material (AlN), a hafnium oxide material (HfOₓ such as HfO₂), a titanium oxide material (TiOₓ such as TiO₂), a zinc oxide material (ZnO), and/or a germanium oxide material (GeOₓ such as GeO₂), among other examples. Examples of semiconductor materials for the optical coupler layer 808 include silicon (Si), germanium (Ge), and/or another semiconductor material.

FIG. 8B illustrates a cross-section view of the semiconductor photonics device 800 along the line E-E in FIG. 8A in the x-direction through the centers of the optical coupler layers 808 and 810. As shown in FIG. 8B, the semiconductor photonics device 800 may further include a semiconductor substrate 814 above which the dielectric layer 806 is located. The semiconductor substrate 814 may include a semiconductor substrate such as a silicon (Si) substrate, a germanium (Ge) substrate, and/or another type of semiconductor substrate. The optical coupler layers 808 and 810 are arranged in a z-direction in the semiconductor photonics device 800, which is approximately perpendicular to a surface of the semiconductor substrate 814. For example, the optical coupler layer 810 is located above the optical coupler layer 808. Alternatively, the optical coupler layers 808 and 810 may be arranged such that the optical coupler layers 808 and 810 are adjacent in the y-direction. The optical coupler layers 808 and 810 are spaced apart by the dielectric layer 806 such that the optical coupler layers 808 and 810 are not in direct contact with each other.

As further shown in FIG. 8B, an optical signal path 816 of an optical signal may start at the optical signal I/O 804. The optical signal may propagate along the optical signal path 816 from the optical signal I/O 804 to the segments 808a and 808c of the optical coupler layer 808. Thus, the optical coupler layer 808 is optically coupled with the optical signal I/O 804. The optical signal may propagate along the segments 808c to the segment 808a, from the segment 808a to the intermediate point 812. The optical signal may then transfer (e.g., upward) to the segment 810b of the optical coupler layer 810. Thus, the optical coupler layer 810 is optically coupled with the optical coupler layer 808. The optical signal may be transferred from the segment 810b of the optical coupler layer 810 to a PIC (not shown) and/or to another location in the semiconductor photonics device 800.

FIG. 8C illustrates a cross-section view of the semiconductor photonics device 800 along the line F-F in FIG. 8A in the y-direction through the optical coupler layers 808 and 810 at the first ends of the optical coupler layers 808 and 810. As shown in FIG. 8C, the optical coupler layer 808 may have a dimension D30 corresponding to a pitch between a segment 808c and the segment 808a of the optical coupler layer 808. As further shown in FIG. 8C, the optical coupler layer 810 may have a dimension D31 corresponding to a pitch between a segment 810c and the segment 810a of the optical coupler layer 810. In some implementations, the dimension D30 and the dimension D31 are approximately equal. In some implementations, the dimension D30 and the dimension D31 are different pitches.

As further shown in FIG. 8C, the optical coupler layer 808 may have a dimension D32 corresponding to a z-direction thickness of the optical coupler layer 808. The optical coupler layer 810 may have a dimension D33 corresponding to a z-direction thickness of the optical coupler layer 810. The dimension D33 may be greater than the dimension D32. For example, a ratio of the dimension D33 to the dimension D32 may be greater than approximately 1:1 and less than or approximately equal to approximately 100:1. However, other values for the ratio of the dimension D33 to the dimension D32 are within the scope of the present disclosure. In some implementations, the dimension D32 is included in a range from approximately 0.01 microns to approximately 0.8 microns. However, other values for the range are within the scope of the present disclosure. In some implementations, the dimension D33 is included in a range from approximately 0.01 microns to approximately 1 micron. However, other values for the range are within the scope of the present disclosure.

Similar semiconductor processing operations and/or techniques described in connection with FIGS. 4A-4E and/or 7A-7E may be used to form the semiconductor photonics device 800. For example, the optical coupler layer 808 may be formed in a semiconductor layer above the dielectric layer 806. Additional material for the dielectric layer 806 may be deposited to encapsulate the optical coupler layer 808. The optical coupler layer 810 may be formed above the optical coupler layer 808 in the dielectric layer 806. Additional material for the dielectric layer 806 may be deposited to encapsulate the optical coupler layer 810.

As indicated above, FIGS. 8A-8C are provided as an example. Other examples may differ from what is described with regard to FIGS. 8A-8C.

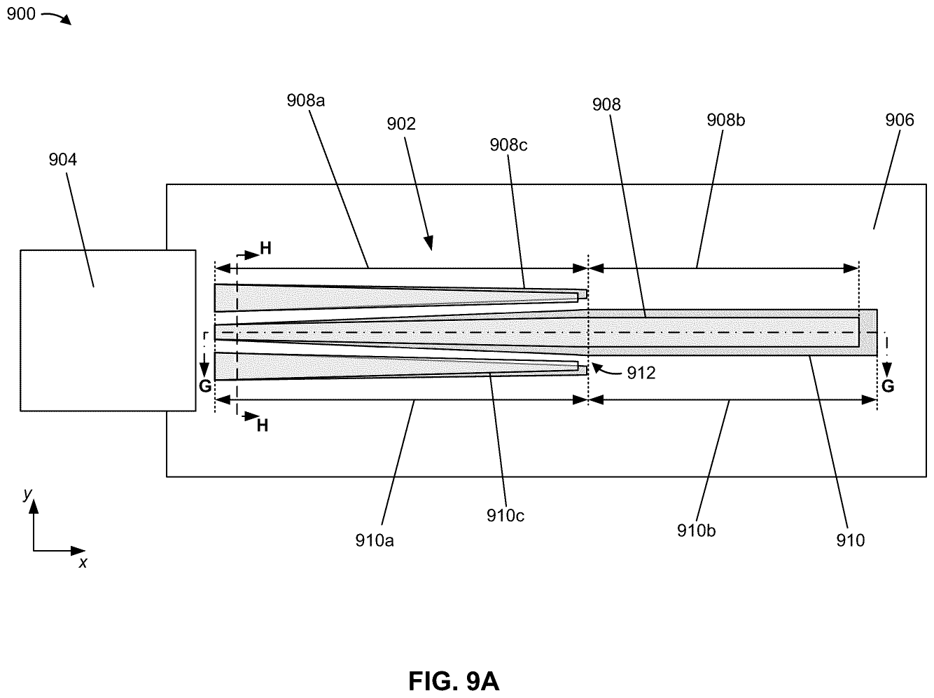

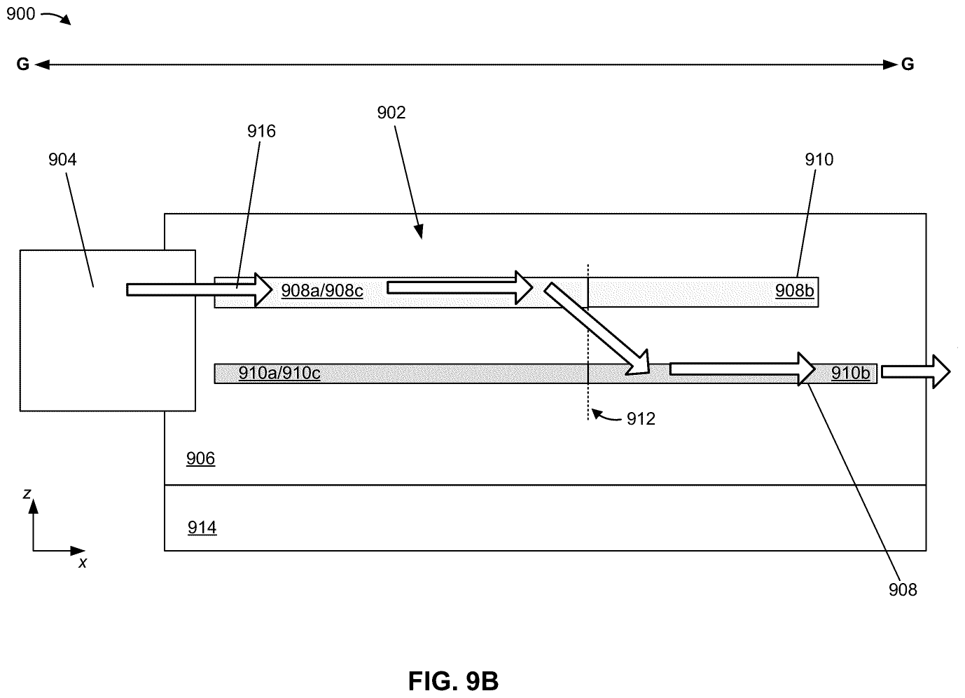

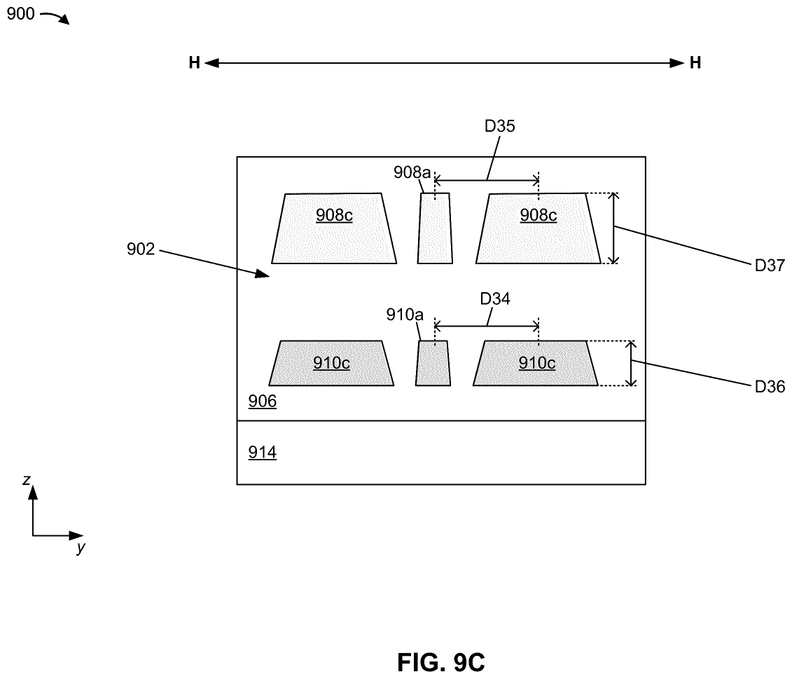

FIGS. 9A-9C are diagrams of an example semiconductor photonics device 900 described herein. The semiconductor photonics device 900 may include an optical coupling circuit such as an edge coupler or edge coupling circuit. The semiconductor photonics device 900 may be configured to provide optical signals between an optical signal I/O (e.g., an optical fiber) and a PIC for high-bandwidth optical communications.

FIG. 9A is a top-down view of an x-y plane of the semiconductor photonics device 900. As shown in FIG. 9A, the semiconductor photonics device 900 includes a multiple-layer coupler structure 902. The multiple-layer coupler structure 902 is optically coupled with an optical signal I/O 904. The multiple-layer coupler structure 902 may be configured to provide optical signals between the optical signal I/O 904 and another structure of the semiconductor photonics device 900 such as a PIC (not shown). For example, the multiple-layer coupler structure 902 may receive an optical signal from the optical signal I/O 904 and provide the optical signal to a PIC. As another example, the multiple-layer coupler structure 902 may receive an optical signal from a PIC and provide the optical signal to the optical signal I/O 904.

The multiple-layer coupler structure 902 may be included in a dielectric layer 906 of the semiconductor photonics device 900. The dielectric layer 906 may include one or more dielectric materials, such as a silicon oxide (SiOₓ), a silicon nitride (SiₓN_{y}), a silicon oxynitride (SiON), tetraethyl orthosilicate oxide, phosphosilicate glass (PSG), borophosphosilicate glass (BPSG), fluorinated silicate glass (FSG), carbon doped silicon oxide, and/or another dielectric material.

The multiple-layer coupler structure 902 includes a plurality of optical coupler layers, such as an optical coupler layer 908 and an optical coupler layer 910. The optical coupler layers 908 and 910 may each include a plurality of waveguides that enable optical signals to be transferred between and through the optical coupler layers 908 and 910. The plurality of waveguides of the optical coupler layer 908 correspond to a segment 908a and a segment 908b being a first waveguide, and a plurality of segments 908c on opposing sides of the segment 908a in the y-direction being a plurality of second waveguides. The plurality of waveguides of the optical coupler layer 910 correspond to a segment 910a and a segment 910b being a first waveguide, and a plurality of segments 910c on opposing sides of the segment 910a in the y-direction being a plurality of second waveguides.

The optical coupler layer 908 is adjacent to the optical coupler layer 910 in the dielectric layer 906. In some implementations, the optical coupler layers 908 and 910 are vertically adjacent in the semiconductor photonics device 900 in that the optical coupler layers 908 and 910 are arranged in a direction that is approximately perpendicular to the top surface of the dielectric layer 906. For example, the optical coupler layer 908 may be located above the optical coupler layer 910. In some implementations, the optical coupler layers 908 and 910 are horizontally adjacent in the semiconductor photonics device 900 in that the optical coupler layers 908 and 910 are side by side in the y-direction in the semiconductor photonics device 900.

The optical coupler layers 908 and 910 have different top view profiles. A top view width of the segment 908a (e.g., in the y-direction) increases from a first end of the optical coupler layer 908 facing the optical signal I/O 904 to an intermediate point 912 along the optical coupler layer 908 in the x-direction. Thus, the segment 908a is a tapered segment in the top-down view of the semiconductor photonics device 900, where the segment 908a has substantially straight-lined tapered sidewalls. A top view width of the segment 908b (e.g., in the y-direction) is substantially uniform between the intermediate point 912 along the optical coupler layer 908 in the x-direction and a second end of the optical coupler layer 908 opposing the first end. A top view width of the segments 908c (e.g., in the y-direction) decreases from the first end of the optical coupler layer 908 facing the optical signal I/O 904 to the intermediate point 912 along the optical coupler layer 908 in the x-direction. Thus, the segments 908c are tapered segments in the top-down view of the semiconductor photonics device 900, where the segments 908c have substantially straight-lined tapered sidewalls. The segment 908a and the segments 908c having different widths along the y-direction enables optical signals to be confined within and/or between the segment 908a and the segments 908c. Moreover, the tapers of the segment 908a and the segments 908c enable optical signals to be focused and merged before the optical signals are transferred to the optical coupler layer 910.

A top view width of the segment 910a (e.g., in the y-direction) increases from a first end of the optical coupler layer 910 facing the optical signal I/O 904 to the intermediate point 912 along the optical coupler layer 910 in the x-direction. The first ends and the intermediate points 912 of the optical coupler layers 908 and 910 may be substantially aligned. Thus, the segments 908a and 910a have approximately the same x-direction length. The segment 910b of the optical coupler layer 910 has a greater x-direction length than the segment 908b of the optical coupler layer 908. Thus, the segment 910b of the optical coupler layer 910 extends laterally outward in the x-direction from the segment 908b of the optical coupler layer 908.

The top view width of the segment 910b (e.g., in the y-direction) is substantially uniform between the intermediate point 912 along the optical coupler layer 910 in the x-direction and a second end of the optical coupler layer 910 opposing the first end. The top view width of the optical coupler layer 910 at the intermediate point 912 is greater than the top view width of the optical coupler layer 908 at the intermediate point 912. The decreasing top view width of the optical coupler layer 908 along the segment 908b, and/or the greater x-direction length of the segment 910b, promotes the transfer of optical signals from the optical coupler layer 908 to the optical coupler layer 910.

A top view width of the segments 910c (e.g., in the y-direction) decreases from the first end of the optical coupler layer 910 facing the optical signal I/O 904 to the intermediate point 912 along the optical coupler layer 910 in the x-direction. Thus, the segments 910c are tapered segments in the top-down view of the semiconductor photonics device 900, where the segments 910c have substantially straight-lined tapered sidewalls. The segment 908a and the segments 910c having different widths along the y-direction enables optical signals to be confined within and/or between the segment 910a and the segments 910c. In some implementations, the segments 908c and the segments 910c have approximately the same x-direction length. In some implementations, the segments 910c have a greater x-direction length than the x-direction length of the segments 908c.

Additionally and/or alternatively to the different top view profiles, the optical coupler layers 908 and 910 may be formed of different material compositions. The material compositions of the optical coupler layers 908 and 910 may be selected so that the respective refractive indices of the optical coupler layers 908 and 910 promote compatibility of the optical coupler layers 908 and 910 for optical coupling purposes. For example, the material composition of the optical coupler layer 908 may be selected such that the optical coupler layer 908 has a first refractive index, and the material composition of the optical coupler layer 910 may be selected such that the optical coupler layer 910 has a second refractive index that is greater than the first refractive index, which enables optical signals to be transferred from the optical coupler layer 908 to the optical coupler layer 910 with low optical loss.

The material composition of the optical coupler layer 908 may include one or more dielectrics materials having a low refractive index, and the material composition of the optical coupler layer 910 may include one or more semiconductor materials having a greater refractive index than the material composition of the optical coupler layer 908. Examples of dielectric materials for the optical coupler layer 908 include a silicon nitride material (SiₓN_{y} such as Si₃N₄), an aluminum oxide material (AlₓO_{y} such as Al₂O₃), an aluminum nitride material (AlN), a hafnium oxide material (HfOₓ such as HfO₂), a titanium oxide material (TiOₓ such as TiO₂), a zinc oxide material (ZnO), and/or a germanium oxide material (GeOₓ such as GeO₂), among other examples. Examples of semiconductor materials for the optical coupler layer 910 include silicon (Si), germanium (Ge), and/or another semiconductor material.

FIG. 9B illustrates a cross-section view of the semiconductor photonics device 900 along the line G-G in FIG. 9A in the x-direction through the centers of the optical coupler layers 908 and 910. As shown in FIG. 9B, the semiconductor photonics device 900 may further include a semiconductor substrate 914 above which the dielectric layer 906 is located. The semiconductor substrate 914 may include a semiconductor substrate such as a silicon (Si) substrate, a germanium (Ge) substrate, and/or another type of semiconductor substrate. The optical coupler layers 908 and 910 are arranged in a z-direction in the semiconductor photonics device 900, which is approximately perpendicular to a surface of the semiconductor substrate 914. For example, the optical coupler layer 908 is located above the optical coupler layer 910. Alternatively, the optical coupler layers 908 and 910 may be arranged such that the optical coupler layers 908 and 910 are adjacent in the y-direction. The optical coupler layers 908 and 910 are spaced apart by the dielectric layer 906 such that the optical coupler layers 908 and 910 are not in direct contact with each other.

As further shown in FIG. 9B, an optical signal path 916 of an optical signal may start at the optical signal I/O 904. The optical signal may propagate along the optical signal path 916 from the optical signal I/O 904 to the segments 908a and 908c of the optical coupler layer 908. Thus, the optical coupler layer 908 is optically coupled with the optical signal I/O 904. The optical signal may propagate along the segments 908c to the segment 908a, from the segment 908a to the intermediate point 912. The optical signal may then transfer (e.g., downward) to the segment 910b of the optical coupler layer 910. Thus, the optical coupler layer 910 is optically coupled with the optical coupler layer 908. The optical signal may be transferred from the segment 910b of the optical coupler layer 910 to a PIC (not shown) and/or to another location in the semiconductor photonics device 900.

FIG. 9C illustrates a cross-section view of the semiconductor photonics device 900 along the line H-H in FIG. 9A in the y-direction through the optical coupler layers 908 and 910 at the first ends of the optical coupler layers 908 and 910. As shown in FIG. 9C, the optical coupler layer 910 may have a dimension D34 corresponding to a pitch between a segment 910c and the segment 910a of the optical coupler layer 910. As further shown in FIG. 9C, the optical coupler layer 910 may have a dimension D35 corresponding to a pitch between a segment 908c and the segment 908a of the optical coupler layer 908. In some implementations, the dimension D34 and the dimension D35 are approximately equal. In some implementations, the dimension D34 and the dimension D35 are different pitches.

As further shown in FIG. 9C, the optical coupler layer 910 may have a dimension D36 corresponding to a z-direction thickness of the optical coupler layer 910. The optical coupler layer 908 may have a dimension D37 corresponding to a z-direction thickness of the optical coupler layer 908. The dimension D37 may be greater than the dimension D36. For example, a ratio of the dimension D37 to the dimension D36 may be greater than approximately 1:1 and less than or approximately equal to approximately 100:1. However, other values for the ratio of the dimension D37 to the dimension D36 are within the scope of the present disclosure. In some implementations, the dimension D36 is included in a range from approximately 0.01 microns to approximately 0.8 microns. However, other values for the range are within the scope of the present disclosure. In some implementations, the dimension D37 is included in a range from approximately 0.01 microns to approximately 1 micron. However, other values for the range are within the scope of the present disclosure.

Similar semiconductor processing operations and/or techniques described in connection with FIGS. 4A-4E and/or 7A-7E may be used to form the semiconductor photonics device 900. For example, the optical coupler layer 910 may be formed in a semiconductor layer above the dielectric layer 906. Additional material for the dielectric layer 906 may be deposited to encapsulate the optical coupler layer 910. The optical coupler layer 908 may be formed above the optical coupler layer 910 in the dielectric layer 906. Additional material for the dielectric layer 906 may be deposited to encapsulate the optical coupler layer 908.

As indicated above, FIGS. 9A-9C are provided as an example. Other examples may differ from what is described with regard to FIGS. 9A-9C.

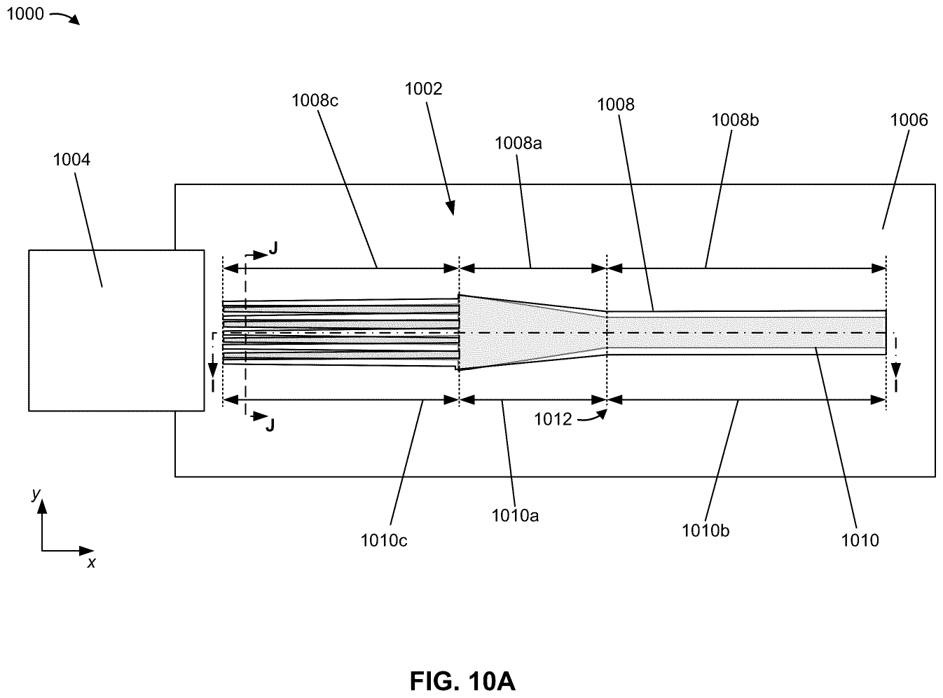

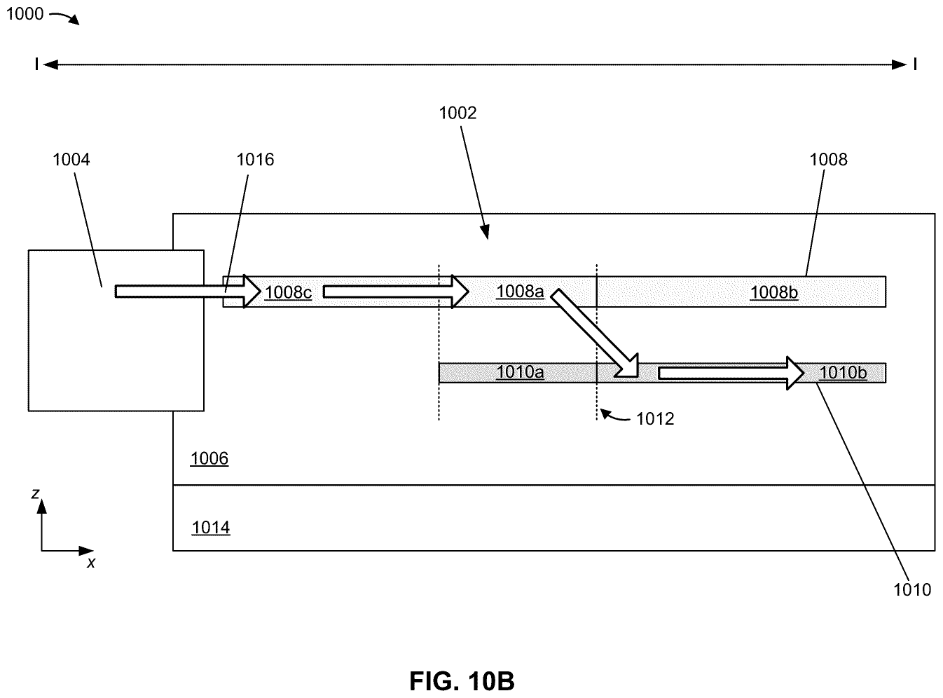

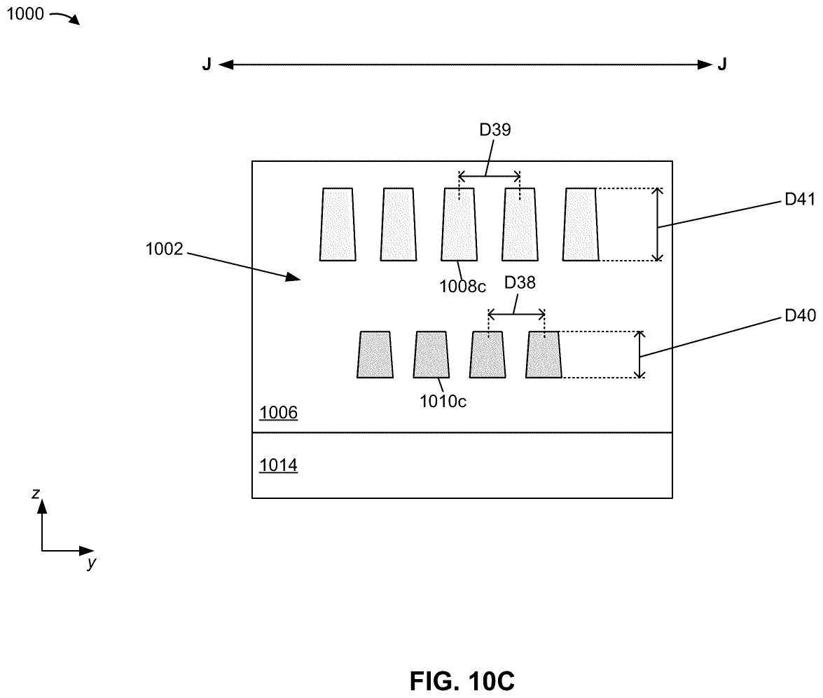

FIGS. 10A-10C are diagrams of an example semiconductor photonics device 1000 described herein. The semiconductor photonics device 1000 may include an optical coupling circuit such as an edge coupler or edge coupling circuit. The semiconductor photonics device 1000 may be configured to provide optical signals between an optical signal I/O (e.g., an optical fiber) and a PIC for high-bandwidth optical communications.

FIG. 10A is a top-down view of an x-y plane of the semiconductor photonics device 1000. As shown in FIG. 10A, the semiconductor photonics device 1000 includes a multiple-layer coupler structure 1002. The multiple-layer coupler structure 1002 is optically coupled with an optical signal I/O 1004. The multiple-layer coupler structure 1002 may be configured to provide optical signals between the optical signal I/O 1004 and another structure of the semiconductor photonics device 1000 such as a PIC (not shown). For example, the multiple-layer coupler structure 1002 may receive an optical signal from the optical signal I/O 1004 and provide the optical signal to a PIC. As another example, the multiple-layer coupler structure 1002 may receive an optical signal from a PIC and provide the optical signal to the optical signal I/O 1004.

The multiple-layer coupler structure 1002 may be included in a dielectric layer 1006 of the semiconductor photonics device 1000. The dielectric layer 1006 may include one or more dielectric materials, such as a silicon oxide (SiOₓ), a silicon nitride (SiₓN_{y}), a silicon oxynitride (SiON), tetraethyl orthosilicate oxide, phosphosilicate glass (PSG), borophosphosilicate glass (BPSG), fluorinated silicate glass (FSG), carbon doped silicon oxide, and/or another dielectric material.

The multiple-layer coupler structure 1002 includes a plurality of optical coupler layers, such as an optical coupler layer 1008 and an optical coupler layer 1010. The optical coupler layers 1008 and 1010 may each include a waveguide that enables optical signals to be transferred between and through the optical coupler layers 1008 and 1010. The optical coupler layer 1008 is adjacent to the optical coupler layer 1010 in the dielectric layer 1006. In some implementations, the optical coupler layers 1008 and 1010 are vertically adjacent in the semiconductor photonics device 1000 in that the optical coupler layers 1008 and 1010 are arranged in a direction that is approximately perpendicular to the top surface of the dielectric layer 1006. For example, the optical coupler layer 1010 may be located above the optical coupler layer 1008. In some implementations, the optical coupler layers 1008 and 1010 are horizontally adjacent in the semiconductor photonics device 1000 in that the optical coupler layers 1008 and 1010 are side by side in the y-direction in the semiconductor photonics device 1000.

In the top-down view of the multiple-layer coupler structure 1002, the optical coupler layer 1008 includes a segment 1008a, a segment 1008b optically coupled and/or physically coupled with the segment 1008a at a first end of the segment 1008a, and a plurality of segments 1008c optically coupled and/or physically coupled with the segment 1008a at a second end of the segment 1008a opposing the first end. The segments 1008a, 1008b, and 1008c are arranged in the x-direction, and the plurality of segments 1008c are arranged in the y-direction in the semiconductor photonics device 1000. The segments 1008c enable optical signals to be coupled to the optical coupler layer 1008 from the optical signal I/O 1004, and to be provided from the segments 1008c to the segment 1008a.

In the top-down view of the multiple-layer coupler structure 1002, the optical coupler layer 1010 includes a segment 1010a, a segment 1010b optically coupled and/or physically coupled with the segment 1010a at a first end of the segment 1010a, and a plurality of segments 1010c optically coupled and/or physically coupled with the segment 1010a at a second end of the segment 1010a opposing the first end. The segments 1010a, 1010b, and 1010c are arranged in the x-direction, and the plurality of segments 1010c are arranged in the y-direction in the semiconductor photonics device 1000.

A top view width of the segment 1008a (e.g., in the y-direction) decreases from the second end of the optical coupler layer 1008 facing the segments 1008c to an intermediate point 1012 along the optical coupler layer 1008 in the x-direction. Thus, the segment 1008a is a tapered segment in the top-down view of the semiconductor photonics device 1000, where the segment 1008a has substantially straight-lined tapered sidewalls. A top view width of the segment 1008b (e.g., in the y-direction) is substantially uniform between the intermediate point 1012 along the optical coupler layer 1008 in the x-direction and a second end of the optical coupler layer 1008 opposing the first end. A top view width of the segments 1008c (e.g., in the y-direction) increases from the first end of the optical coupler layer 1008 facing the optical signal I/O 1004 to the segment 1008a along the optical coupler layer 1008 in the x-direction. Thus, the segments 1008c are tapered segments in the top-down view of the semiconductor photonics device 1000, where the segments 1008c have substantially straight-lined tapered sidewalls. The segments 1008c having lesser widths in the y-direction than the segments 1008a and 1008b, which enables optical signals to be distributed to the segment 1008a. Moreover, the taper of the segment 1008a enables optical signals to be focused and merged before the optical signals are transferred to the optical coupler layer 1010.

A top view width of the segment 1010a (e.g., in the y-direction) decreases from a first end of the optical coupler layer 1010 facing the optical signal I/O 1004 to the intermediate point 1012 along the optical coupler layer 1010 in the x-direction. The top view width of the segment 1010b (e.g., in the y-direction) is substantially uniform between the intermediate point 1012 along the optical coupler layer 1010 in the x-direction and a second end of the optical coupler layer 1010 opposing the first end. A top view width of the segments 1010c (e.g., in the y-direction) increases from the first end of the optical coupler layer 1010 facing the optical signal I/O 1004 to the segment 1010a along the optical coupler layer 1010 in the x-direction. Thus, the segments 1010c are tapered segments in the top-down view of the semiconductor photonics device 1000, where the segments 1010c have substantially straight-lined tapered sidewalls.

The optical coupler layers 1008 and 1010 have different top view profiles. For example, the top view width of the optical coupler layer 1008 at the intermediate point 1012 is greater than the top view width of the optical coupler layer 1010 at the intermediate point 1012. As another example, the quantity of the segments 1008c may be greater than the quantity of the segments 1010c. As another example, the segments 1008c and the segments 1010c may be non-overlapping or partially overlapping in the top-down view of the semiconductor photonics device 1000. As another example, the top view width of the segment 1008b may be greater than the top view width of the segment 1010b.

Additionally and/or alternatively to the different top view profiles, the optical coupler layers 1008 and 1010 may be formed of different material compositions. The material compositions of the optical coupler layers 1008 and 1010 may be selected so that the respective refractive indices of the optical coupler layers 1008 and 1010 promote compatibility of the optical coupler layers 1008 and 1010 for optical coupling purposes. For example, the material composition of the optical coupler layer 1008 may be selected such that the optical coupler layer 1008 has a first refractive index, and the material composition of the optical coupler layer 1010 may be selected such that the optical coupler layer 1010 has a second refractive index that is greater than the first refractive index.

The material composition of the optical coupler layer 1008 may include one or more semiconductor materials having a lesser refractive index than the material composition of the optical coupler layer 1010. The material composition of the optical coupler layer 1008 may include one or more dielectrics materials having a low refractive index. Examples of dielectric materials for the optical coupler layer 1008 include a silicon nitride material (SiₓN_{y} such as Si₃N₄), an aluminum oxide material (AlₓO_{y} such as Al₂O₃), an aluminum nitride material (AlN), a hafnium oxide material (HfOₓ such as HfO₂), a titanium oxide material (TiOₓ such as TiO₂), a zinc oxide material (ZnO), and/or a germanium oxide material (GeOₓ such as GeO₂), among other examples. Examples of semiconductor materials for the optical coupler layer 1010 include silicon (Si), germanium (Ge), and/or another semiconductor material.

FIG. 10B illustrates a cross-section view of the semiconductor photonics device 1000 along the line I-I in FIG. 10A in the x-direction through the centers of the optical coupler layers 1008 and 1010. As shown in FIG. 10B, the semiconductor photonics device 1000 may further include a semiconductor substrate 1014 above which the dielectric layer 1006 is located. The semiconductor substrate 1014 may include a semiconductor substrate such as a silicon (Si) substrate, a germanium (Ge) substrate, and/or another type of semiconductor substrate. The optical coupler layers 1008 and 1010 are arranged in a z-direction in the semiconductor photonics device 1000, which is approximately perpendicular to a surface of the semiconductor substrate 1014. For example, the optical coupler layer 1008 is located above the optical coupler layer 1010. Alternatively, the optical coupler layers 1008 and 1010 may be arranged such that the optical coupler layers 1008 and 1010 are adjacent in the y-direction. The optical coupler layers 1008 and 1010 are spaced apart by the dielectric layer 1006 such that the optical coupler layers 1008 and 1010 are not in direct contact with each other.

As further shown in FIG. 10B, an optical signal path 1016 of an optical signal may start at the optical signal I/O 1004. The optical signal may propagate along the optical signal path 1016 from the optical signal I/O 1004 to the segments 1008c of the optical coupler layer 1008. Thus, the optical coupler layer 1008 is optically coupled with the optical signal I/O 1004. The optical signal may propagate along the segments 1008c to the segment 1008a, from the segment 1008a to the intermediate point 1012. The optical signal may then transfer (e.g., downward) to the segment 1010b of the optical coupler layer 1010. Thus, the optical coupler layer 1010 is optically coupled with the optical coupler layer 1008. The optical signal may be transferred from the segment 1010b of the optical coupler layer 1010 to a PIC (not shown) and/or to another location in the semiconductor photonics device 1000.

FIG. 10C illustrates a cross-section view of the semiconductor photonics device 1000 along the line J-J in FIG. 10A in the y-direction through the optical coupler layers 1008 and 1010 at the first ends of the optical coupler layers 1008 and 1010. As shown in FIG. 10C, the optical coupler layer 1010 may have a dimension D38 corresponding to a pitch between adjacent segments 1010c of the optical coupler layer 1010. As further shown in FIG. 10C, the optical coupler layer 1008 may have a dimension D39 corresponding to a pitch between adjacent segments 1008c of the optical coupler layer 1008. In some implementations, the dimension D38 and the dimension D39 are approximately equal. In some implementations, the dimension D38 and the dimension D39 are different pitches.

As further shown in FIG. 10C, the optical coupler layer 1010 may have a dimension D40 corresponding to a z-direction thickness of the optical coupler layer 1010. The optical coupler layer 1008 may have a dimension D41 corresponding to a z-direction thickness of the optical coupler layer 1008. The dimension D41 may be greater than the dimension D40. For example, a ratio of the dimension D41 to the dimension D40 may be greater than approximately 1:1 and less than or approximately equal to approximately 100:1. However, other values for the ratio of the dimension D41 to the dimension D40 are within the scope of the present disclosure. In some implementations, the dimension D40 is included in a range from approximately 0.01 microns to approximately 0.8 microns. However, other values for the range are within the scope of the present disclosure. In some implementations, the dimension D41 is included in a range from approximately 0.01 microns to approximately 1 micron. However, other values for the range are within the scope of the present disclosure.

Similar semiconductor processing operations and/or techniques described in connection with FIGS. 4A-4E and/or 7A-7E may be used to form the semiconductor photonics device 1000. For example, the optical coupler layer 1010 may be formed in a semiconductor layer above the dielectric layer 1006. Additional material for the dielectric layer 1006 may be deposited to encapsulate the optical coupler layer 1010. The optical coupler layer 1008 may be formed above the optical coupler layer 1010 in the dielectric layer 1006. Additional material for the dielectric layer 1006 may be deposited to encapsulate the optical coupler layer 1008.

As indicated above, FIGS. 10A-10C are provided as an example. Other examples may differ from what is described with regard to FIGS. 10A-10C.

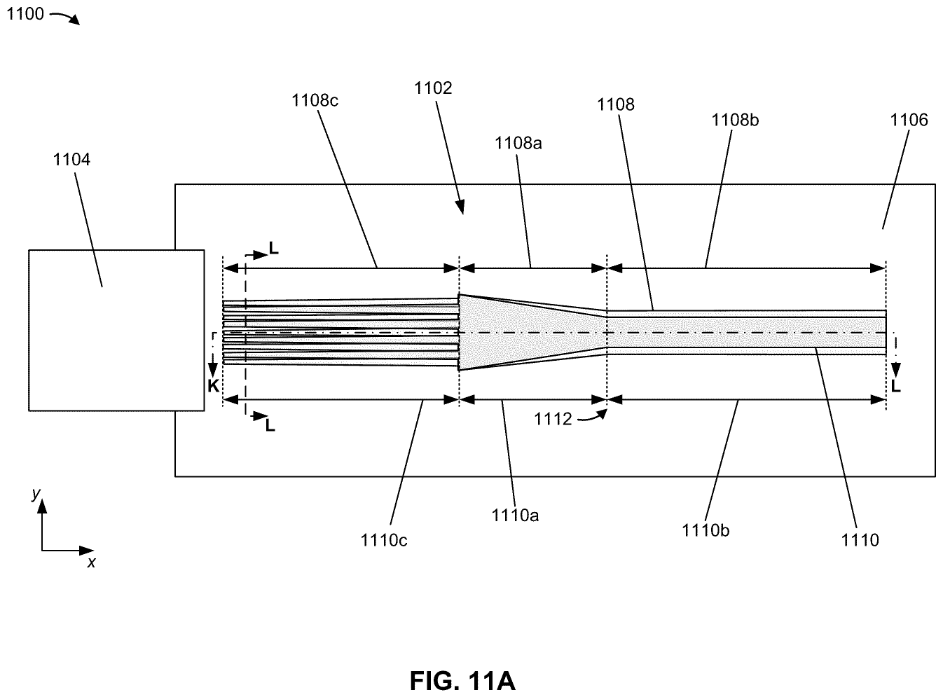

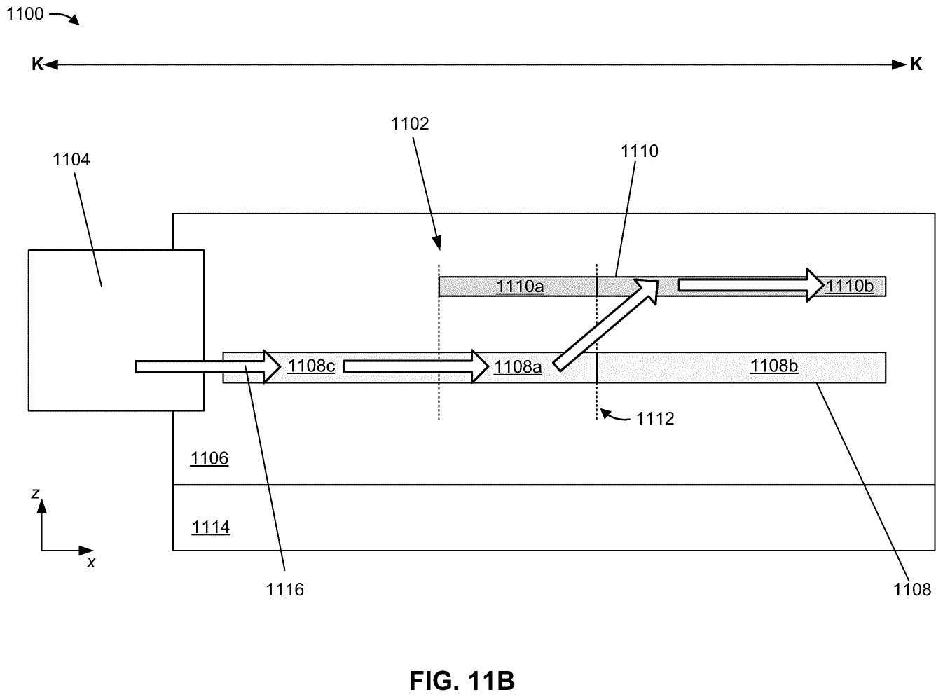

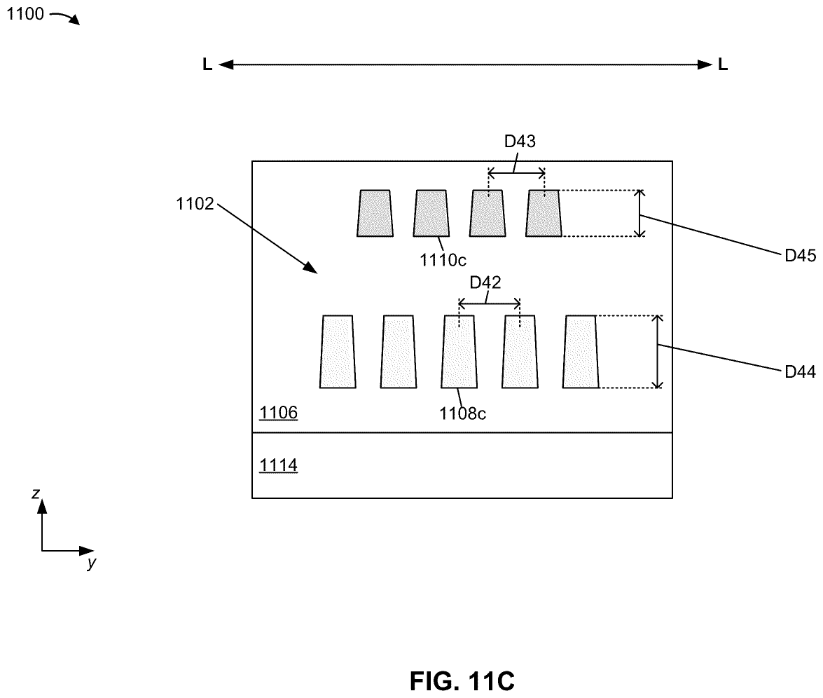

FIGS. 11A-11C are diagrams of an example semiconductor photonics device 1100 described herein. The semiconductor photonics device 1100 may include an optical coupling circuit such as an edge coupler or edge coupling circuit. The semiconductor photonics device 1100 may be configured to provide optical signals between an optical signal I/O (e.g., an optical fiber) and a PIC for high-bandwidth optical communications.

FIG. 11A is a top-down view of an x-y plane of the semiconductor photonics device 1100. As shown in FIG. 11A, the semiconductor photonics device 1100 includes a multiple-layer coupler structure 1102. The multiple-layer coupler structure 1102 is optically coupled with an optical signal I/O 1104. The multiple-layer coupler structure 1102 may be configured to provide optical signals between the optical signal I/O 1104 and another structure of the semiconductor photonics device 1100 such as a PIC (not shown). For example, the multiple-layer coupler structure 1102 may receive an optical signal from the optical signal I/O 1104 and provide the optical signal to a PIC. As another example, the multiple-layer coupler structure 1102 may receive an optical signal from a PIC and provide the optical signal to the optical signal I/O 1104.

The multiple-layer coupler structure 1102 may be included in a dielectric layer 1006 of the semiconductor photonics device 1100. The dielectric layer 1106 may include one or more dielectric materials, such as a silicon oxide (SiOₓ), a silicon nitride (SiₓN_{y}), a silicon oxynitride (SiON), tetraethyl orthosilicate oxide, phosphosilicate glass (PSG), borophosphosilicate glass (BPSG), fluorinated silicate glass (FSG), carbon doped silicon oxide, and/or another dielectric material.

The multiple-layer coupler structure 1102 includes a plurality of optical coupler layers, such as an optical coupler layer 1108 and an optical coupler layer 1110. The optical coupler layers 1108 and 1110 may each include a waveguide that enables optical signals to be transferred between and through the optical coupler layers 1108 and 1110. The optical coupler layer 1108 is adjacent to the optical coupler layer 1110 in the dielectric layer 1106. In some implementations, the optical coupler layers 1108 and 1110 are vertically adjacent in the semiconductor photonics device 1100 in that the optical coupler layers 1108 and 1110 are arranged in a direction that is approximately perpendicular to the top surface of the dielectric layer 1106. For example, the optical coupler layer 1110 may be located above the optical coupler layer 1108. In some implementations, the optical coupler layers 1108 and 1110 are horizontally adjacent in the semiconductor photonics device 1100 in that the optical coupler layers 1108 and 1110 are side by side in the y-direction in the semiconductor photonics device 1100.

In the top-down view of the multiple-layer coupler structure 1102, the optical coupler layer 1108 includes a segment 1108a, a segment 1108b optically coupled and/or physically coupled with the segment 1108a at a first end of the segment 1108a, and a plurality of segments 1108c optically coupled and/or physically coupled with the segment 1108a at a second end of the segment 1108a opposing the first end. The segments 1108a, 1108b, and 1108c are arranged in the x-direction, and the plurality of segments 1108c are arranged in the y-direction in the semiconductor photonics device 1100. The segments 1108c enable optical signals to be coupled to the optical coupler layer 1108 from the optical signal I/O 1104, and to be provided from the segments 1108c to the segment 1108a.

In the top-down view of the multiple-layer coupler structure 1102, the optical coupler layer 1110 includes a segment 1110a, a segment 1110b optically coupled and/or physically coupled with the segment 1110a at a first end of the segment 1110a, and a plurality of segments 1110c optically coupled and/or physically coupled with the segment 1110a at a second end of the segment 1110a opposing the first end. The segments 1110a, 1110b, and 1110c are arranged in the x-direction, and the plurality of segments 1110c are arranged in the y-direction in the semiconductor photonics device 1100.

A top view width of the segment 1108a (e.g., in the y-direction) decreases from the second end of the optical coupler layer 1108 facing the segments 1108c to an intermediate point 1112 along the optical coupler layer 1108 in the x-direction. Thus, the segment 1108a is a tapered segment in the top-down view of the semiconductor photonics device 1100, where the segment 1108a has substantially straight-lined tapered sidewalls. A top view width of the segment 1108b (e.g., in the y-direction) is substantially uniform between the intermediate point 1112 along the optical coupler layer 1108 in the x-direction and a second end of the optical coupler layer 1108 opposing the first end. A top view width of the segments 1108c (e.g., in the y-direction) increases from the first end of the optical coupler layer 1108 facing the optical signal I/O 1104 to the segment 1108a along the optical coupler layer 1108 in the x-direction. Thus, the segments 1108c are tapered segments in the top-down view of the semiconductor photonics device 1100, where the segments 1108c have substantially straight-lined tapered sidewalls. The segments 1108c having lesser widths in the y-direction than the segments 1108a and 1108b, which enables optical signals to be distributed to the segment 1108a. Moreover, the taper of the segment 1108a enables optical signals to be focused and merged before the optical signals are transferred to the optical coupler layer 1110.

A top view width of the segment 1110a (e.g., in the y-direction) decreases from a first end of the optical coupler layer 1110 facing the optical signal I/O 1104 to the intermediate point 1112 along the optical coupler layer 1110 in the x-direction. The top view width of the segment 1110b (e.g., in the y-direction) is substantially uniform between the intermediate point 1112 along the optical coupler layer 1110 in the x-direction and a second end of the optical coupler layer 1110 opposing the first end. A top view width of the segments 1110c (e.g., in the y-direction) increases from the first end of the optical coupler layer 1110 facing the optical signal I/O 1104 to the segment 1110a along the optical coupler layer 1110 in the x-direction. Thus, the segments 1110c are tapered segments in the top-down view of the semiconductor photonics device 1100, where the segments 1110c have substantially straight-lined tapered sidewalls.

The optical coupler layers 1108 and 1110 have different top view profiles. For example, the top view width of the optical coupler layer 1108 at the intermediate point 1112 is greater than the top view width of the optical coupler layer 1110 at the intermediate point 1112. As another example, the quantity of the segments 1108c may be greater than the quantity of the segments 1110c. As another example, the segments 1108c and the segments 1110c may be non-overlapping or partially overlapping in the top-down view of the semiconductor photonics device 1100. As another example, the top view width of the segment 1108b may be greater than the top view width of the segment 1110b.

Additionally and/or alternatively to the different top view profiles, the optical coupler layers 1108 and 1110 may be formed of different material compositions. The material compositions of the optical coupler layers 1108 and 1110 may be selected so that the respective refractive indices of the optical coupler layers 1108 and 1110 promote compatibility of the optical coupler layers 1108 and 1110 for optical coupling purposes. For example, the material composition of the optical coupler layer 1108 may be selected such that the optical coupler layer 1108 has a first refractive index, the material composition of the optical coupler layer 1110 may be selected such that the optical coupler layer 1110 has a second refractive index that is less than the first refractive index.

The material composition of the optical coupler layer 1108 may include one or more semiconductor materials having a greater refractive index than the material composition of the optical coupler layer 1110. Examples of semiconductor materials for the optical coupler layer 1108 include silicon (Si), germanium (Ge), and/or another semiconductor material. The material composition of the optical coupler layer 1110 may include one or more dielectrics materials having a low refractive index. Examples of dielectric materials for the optical coupler layer 1110 include a silicon nitride material (SiₓN_{y} such as Si₃N₄), an aluminum oxide material (AlₓO_{y} such as Al₂O₃), an aluminum nitride material (AlN), a hafnium oxide material (HfOₓ such as HfO₂), a titanium oxide material (TiOₓ such as TiO₂), a zinc oxide material (ZnO), and/or a germanium oxide material (GeOₓ such as GeO₂), among other examples.

FIG. 11B illustrates a cross-section view of the semiconductor photonics device 1100 along the line K-K in FIG. 11A in the x-direction through the centers of the optical coupler layers 1108 and 1110. As shown in FIG. 11B, the semiconductor photonics device 1100 may further include a semiconductor substrate 1114 above which the dielectric layer 1106 is located. The semiconductor substrate 1114 may include a semiconductor substrate such as a silicon (Si) substrate, a germanium (Ge) substrate, and/or another type of semiconductor substrate. The optical coupler layers 1108 and 1110 are arranged in a z-direction in the semiconductor photonics device 1100, which is approximately perpendicular to a surface of the semiconductor substrate 1114. For example, the optical coupler layer 1110 is located above the optical coupler layer 1108. Alternatively, the optical coupler layers 1108 and 1110 may be arranged such that the optical coupler layers 1108 and 1110 are adjacent in the y-direction. The optical coupler layers 1108 and 1110 are spaced apart by the dielectric layer 1106 such that the optical coupler layers 1108 and 1110 are not in direct contact with each other.

As further shown in FIG. 11B, an optical signal path 1116 of an optical signal may start at the optical signal I/O 1104. The optical signal may propagate along the optical signal path 1116 from the optical signal I/O 1104 to the segments 1108c of the optical coupler layer 1108. Thus, the optical coupler layer 1108 is optically coupled with the optical signal I/O 1104. The optical signal may propagate along the segments 1108c to the segment 1108a, from the segment 1108a to the intermediate point 1112. The optical signal may then transfer (e.g., upward) to the segment 1110b of the optical coupler layer 1110. Thus, the optical coupler layer 1110 is optically coupled with the optical coupler layer 1108. The optical signal may be transferred from the segment 1110b of the optical coupler layer 1110 to a PIC (not shown) and/or to another location in the semiconductor photonics device 1100.

FIG. 11C illustrates a cross-section view of the semiconductor photonics device 1100 along the line L-L in FIG. 11A in the y-direction through the optical coupler layers 1108 and 1110 at the first ends of the optical coupler layers 1108 and 1110. As shown in FIG. 11C, the optical coupler layer 1108 may have a dimension D42 corresponding to a pitch between adjacent segments 1108c of the optical coupler layer 1108. As further shown in FIG. 11C, the optical coupler layer 1110 may have a dimension D43 corresponding to a pitch between adjacent segments 1110c of the optical coupler layer 1110. In some implementations, the dimension D42 and the dimension D43 are approximately equal. In some implementations, the dimension D42 and the dimension D43 are different pitches.

As further shown in FIG. 11C, the optical coupler layer 1108 may have a dimension D44 corresponding to a z-direction thickness of the optical coupler layer 1108. The optical coupler layer 1110 may have a dimension D45 corresponding to a z-direction thickness of the optical coupler layer 1110. The dimension D44 may be greater than the dimension D45. For example, a ratio of the dimension D44 to the dimension D45 may be greater than approximately 1:1 and less than or approximately equal to approximately 100:1. However, other values for the ratio of the dimension D44 to the dimension D45 are within the scope of the present disclosure. In some implementations, the dimension D45 is included in a range from approximately 0.01 microns to approximately 0.8 microns. However, other values for the range are within the scope of the present disclosure. In some implementations, the dimension D44 is included in a range from approximately 0.01 microns to approximately 1 micron. However, other values for the range are within the scope of the present disclosure.

Similar semiconductor processing operations and/or techniques described in connection with FIGS. 4A-4E and/or 7A-7E may be used to form the semiconductor photonics device 1100. For example, the optical coupler layer 1108 may be formed in a semiconductor layer above the dielectric layer 1106. Additional material for the dielectric layer 1106 may be deposited to encapsulate the optical coupler layer 1108. The optical coupler layer 1110 may be formed above the optical coupler layer 1108 in the dielectric layer 1106. Additional material for the dielectric layer 1106 may be deposited to encapsulate the optical coupler layer 1110.

As indicated above, FIGS. 11A-11C are provided as an example. Other examples may differ from what is described with regard to FIGS. 11A-11C.

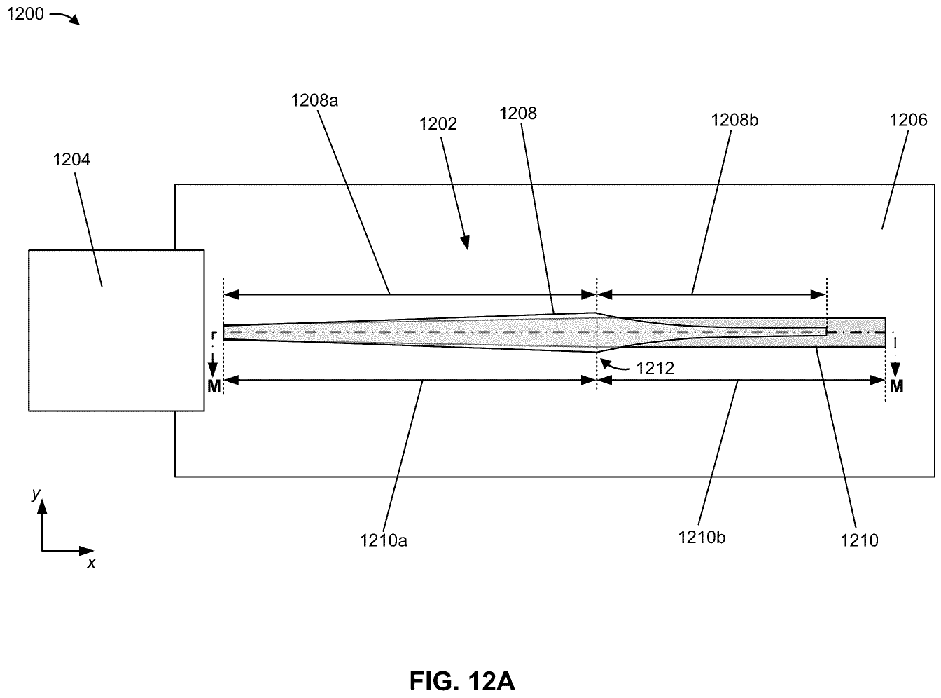

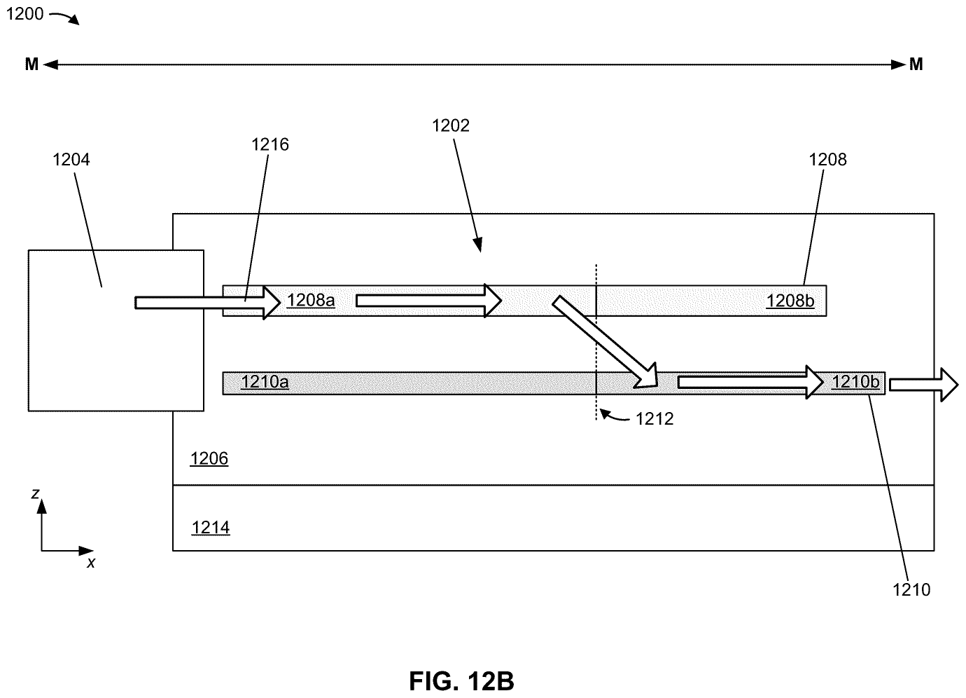

FIGS. 12A and 12B are diagrams of an example semiconductor photonics device 1200 described herein. The semiconductor photonics device 1200 may include an optical coupling circuit such as an edge coupler or edge coupling circuit. The semiconductor photonics device 1200 may be configured to provide optical signals between an optical signal I/O (e.g., an optical fiber) and a PIC for high-bandwidth optical communications.

As shown in FIGS. 12A and 12B, the semiconductor photonics device 1200 may include a similar combination and arrangement of layers and/or structures as the semiconductor photonics device 200, such as a multiple-layer coupler structure 1202 optically coupled with an optical signal I/O 1204, a dielectric layer 1206, an optical coupler layer 1208, an optical coupler layer 1210, an intermediate point 1212, and a semiconductor substrate 1214. The optical coupler layer 1208 is located adjacent to (e.g., above in the z-direction) the optical coupler layer 1210 and includes segments 1208a and 1208b. The optical coupler layer 1210 includes segments 1210a and 1210b.

However, in the semiconductor photonics device 1200, the segment 1208b is a tapered segment having curved sidewalls in the top-down view of the semiconductor photonics device 1200, as opposed to the substantially straight sidewalls of the segment 208b in the top-down view of the semiconductor photonics device 200. Thus, the top view width of the segment 1208b decreases in a non-linear manner from the intermediate point 1212 to the second end of the optical coupler layer 1208 opposing the first end facing the optical signal I/O 1204. The curved shape of the segment 1208b may effectively shorten the length of the transition of optical signals from the optical coupler layer 1208 to the optical coupler layer 1210, which may reduce optical loss between the optical coupler layer 1208 and the optical coupler layer 1210. In particular, the curved shape of the segment 1208b further confines and merges optical signals in the segment 1208b, increasing the intensity of the optical signals for increased transmission efficiency of optical signals from optical coupler layer 1208 to the optical coupler layer 1210. The shape of the curve and the amount of curvature of the sides of the segment 1208b may be selected to achieve confinement and merging of optical signals in the segment 1208b.

FIG. 12B illustrates a cross-section view of the semiconductor photonics device 1200 along the line M-M in FIG. 12A in the x-direction through the centers of the optical coupler layers 1208 and 1210. As shown in FIG. 12B, the optical coupler layers 1208 and 1210 are arranged in a z-direction in the semiconductor photonics device 1200, which is approximately perpendicular to a surface of the semiconductor substrate 1214. For example, the optical coupler layer 1208 is located above the optical coupler layer 1210. Alternatively, the optical coupler layers 1208 and 1210 may be arranged such that the optical coupler layers 1208 and 1210 are adjacent in the y-direction. The optical coupler layers 1208 and 1210 are spaced apart by the dielectric layer 1206 such that the optical coupler layers 1208 and 1210 are not in direct contact with each other.

As further shown in FIG. 12B, an optical signal path 1216 of an optical signal may start at the optical signal I/O 1204. The optical signal may propagate along the optical signal path 1216 from the optical signal I/O 1204 to the segment 1208a of the optical coupler layer 1208. Thus, the optical coupler layer 1208 is optically coupled with the optical signal I/O 1204. The optical signal may propagate along segment 1208a to the intermediate point 1212, and may transfer from the segment 1208a and/or 1208b (e.g., downward) to the segment 1210a and/or 1210b of the optical coupler layer 1210. Thus, the optical coupler layer 1210 is optically coupled with the optical coupler layer 1208. The optical signal may be transferred from the segment 1210b of the optical coupler layer 1210 to a PIC (not shown) and/or to another location in the semiconductor photonics device 1200. In general, the optical signal may be confined within and/or between the optical coupler layers 1208 and 1210, reducing interactions with the surrounding dielectric layer 1206 and minimizing energy loss from the optical signal.

As indicated above, FIGS. 12A and 12B are provided as an example. Other examples may differ from what is described with regard to FIGS. 12A and 12B.

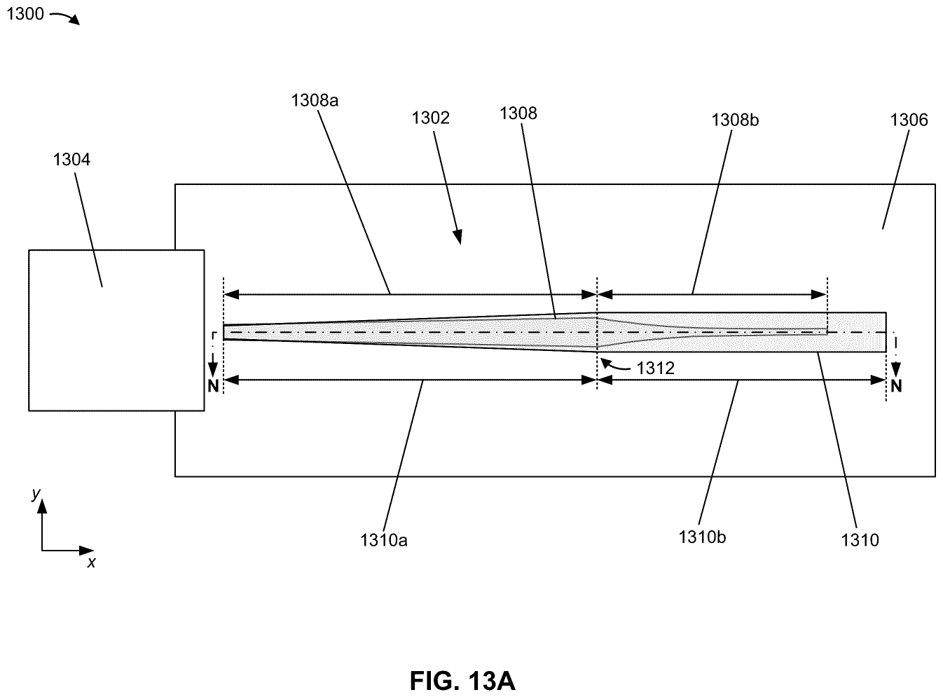

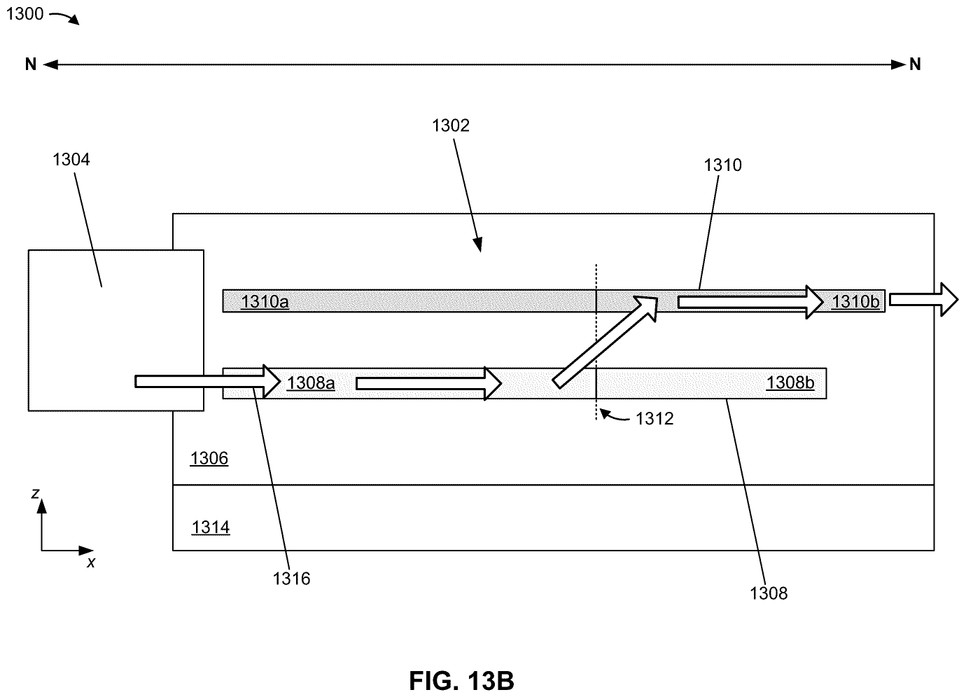

FIGS. 13A and 13B are diagrams of an example semiconductor photonics device 1300 described herein. The semiconductor photonics device 1300 may include an optical coupling circuit such as an edge coupler or edge coupling circuit. The semiconductor photonics device 1300 may be configured to provide optical signals between an optical signal I/O (e.g., an optical fiber) and a PIC for high-bandwidth optical communications.

As shown in FIGS. 13A and 13B, the semiconductor photonics device 1300 may include a similar combination and arrangement of layers and/or structures as the semiconductor photonics device 500, such as a multiple-layer coupler structure 1302 optically coupled with an optical signal I/O 1304, a dielectric layer 1306, an optical coupler layer 1308, an optical coupler layer 1310, an intermediate point 1312, and a semiconductor substrate 1314. The optical coupler layer 1308 is located adjacent to (e.g., below in the z-direction) the optical coupler layer 1310 and includes segments 1308a and 1308b. The optical coupler layer 1310 includes segments 1310a and 1310b.

However, in the semiconductor photonics device 1300, the segment 1308b is a tapered segment having curved sidewalls in the top-down view of the semiconductor photonics device 1300 as opposed to the substantially straight sidewalls of the segment 508b in the top-down view of the semiconductor photonics device 500. Thus, the top view width of the segment 1308b decreases in a non-linear manner from the intermediate point 1312 to the second end of the optical coupler layer 1308 opposing the first end facing the optical signal I/O 1304. The curved shape of the segment 1308b may effectively shorten the length of the transition of optical signals from the optical coupler layer 1308 to the optical coupler layer 1310, which may reduce optical loss between the optical coupler layer 1308 and the optical coupler layer 1310. In particular, the curved shape of the segment 1308b further confines and merges optical signals in the segment 1308b, increasing the intensity of the optical signals for increased transmission efficiency of optical signals from optical coupler layer 1308 to the optical coupler layer 1310. The shape of the curve and the amount of curvature of the sides of the segment 1308b may be selected to achieve confinement and merging of optical signals in the segment 1308b.

FIG. 13B illustrates a cross-section view of the semiconductor photonics device 1300 along the line N-N in FIG. 13A in the x-direction through the centers of the optical coupler layers 1308 and 1310. As shown in FIG. 13B, the optical coupler layers 1308 and 1310 are arranged in a z-direction in the semiconductor photonics device 1300, which is approximately perpendicular to a surface of the semiconductor substrate 1314. For example, the optical coupler layer 1310 is located above the optical coupler layer 1308. Alternatively, the optical coupler layers 1308 and 1310 may be arranged such that the optical coupler layers 1308 and 1310 are adjacent in the y-direction. The optical coupler layers 1308 and 1310 are spaced apart by the dielectric layer 1306 such that the optical coupler layers 1308 and 1310 are not in direct contact with each other.

As further shown in FIG. 13B, an optical signal path 1316 of an optical signal may start at the optical signal I/O 1304. The optical signal may propagate along the optical signal path 1316 from the optical signal I/O 1304 to the segment 1308a of the optical coupler layer 1308. Thus, the optical coupler layer 1308 is optically coupled with the optical signal I/O 1304. The optical signal may propagate along segment 1308a to the intermediate point 1312, and may transfer from the segment 1308a and/or 1308b (e.g., upward) to the segment 1310a and/or 1310b of the optical coupler layer 1310. Thus, the optical coupler layer 1310 is optically coupled with the optical coupler layer 1308. The optical signal may be transferred from the segment 1310b of the optical coupler layer 1310 to a PIC (not shown) and/or to another location in the semiconductor photonics device 1300. In general, the optical signal may be confined within and/or between the optical coupler layers 1308 and 1310, reducing interactions with the surrounding dielectric layer 1306 and minimizing energy loss from the optical signal.

As indicated above, FIGS. 13A and 13B are provided as an example. Other examples may differ from what is described with regard to FIGS. 13A and 13B.

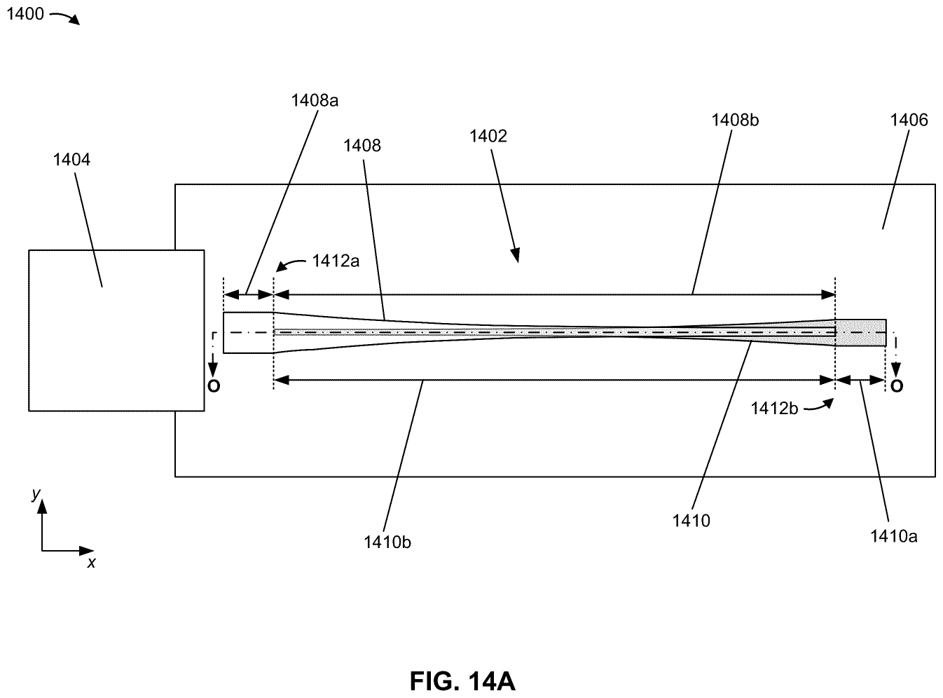

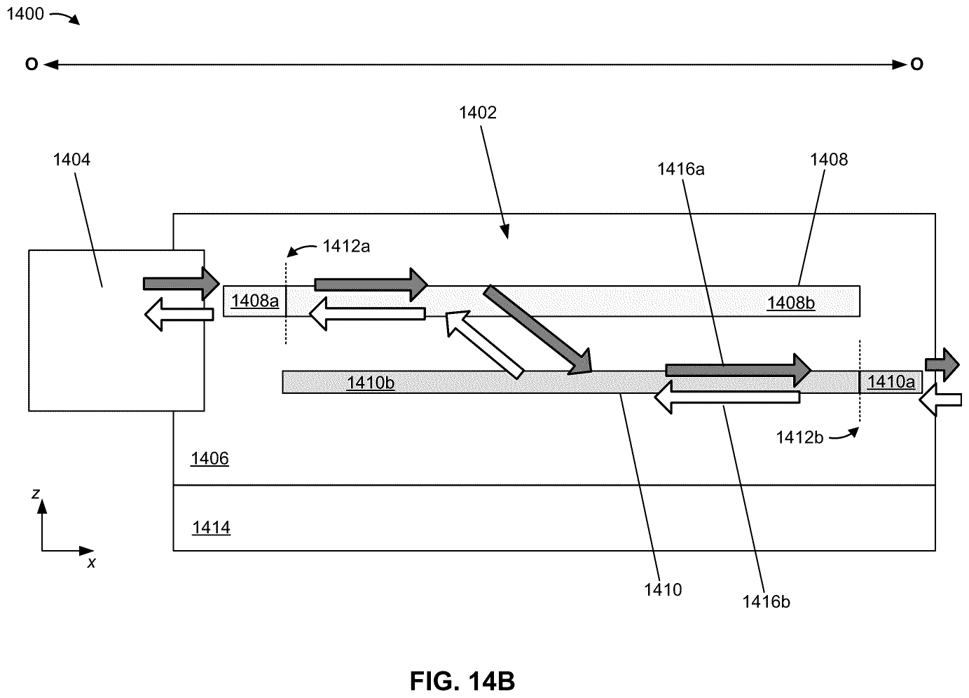

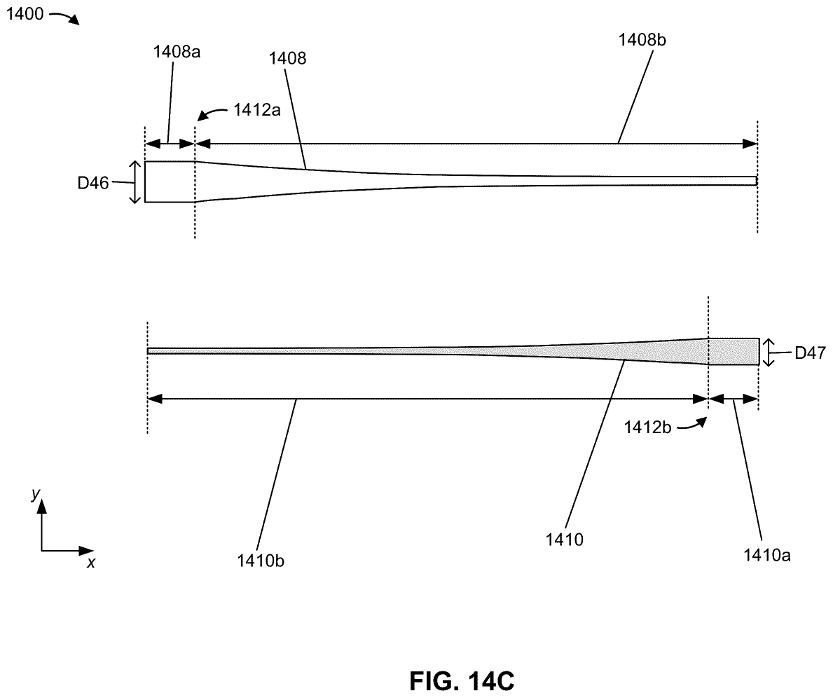

FIGS. 14A-14C are diagrams of an example semiconductor photonics device 1400 described herein. The semiconductor photonics device 1400 may include an optical coupling circuit such as an edge coupler or edge coupling circuit. The semiconductor photonics device 1400 may be configured to provide optical signals between an optical signal I/O (e.g., an optical fiber) and a PIC for high-bandwidth optical communications.

FIG. 14A is a top-down view of an x-y plane of the semiconductor photonics device 1400. As shown in FIG. 14A, the semiconductor photonics device 1400 includes a multiple-layer coupler structure 1402. The multiple-layer coupler structure 1402 is optically coupled with an optical signal I/O 1404. The multiple-layer coupler structure 1402 may be configured to provide optical signals between the optical signal I/O 1404 and another structure of the semiconductor photonics device 1400 such as a PIC (not shown). For example, the multiple-layer coupler structure 1402 may receive an optical signal from the optical signal I/O 1404 and provide the optical signal to a PIC. As another example, the multiple-layer coupler structure 1402 may receive an optical signal from a PIC and provide the optical signal to the optical signal I/O 1404.

The multiple-layer coupler structure 1402 may be included in a dielectric layer 1406 of the semiconductor photonics device 1400. The dielectric layer 1406 may include one or more dielectric materials, such as a silicon oxide (SiOₓ), a silicon nitride (SiₓN_{y}), a silicon oxynitride (SiON), tetraethyl orthosilicate oxide, phosphosilicate glass (PSG), borophosphosilicate glass (BPSG), fluorinated silicate glass (FSG), carbon doped silicon oxide, and/or another dielectric material.

The multiple-layer coupler structure 1402 includes a plurality of optical coupler layers, such as an optical coupler layer 1408 and an optical coupler layer 1410. The optical coupler layers 1408 and 1410 may each include a waveguide that enables optical signals to be transferred between and through the optical coupler layers 1408 and 1410. The optical coupler layer 1408 is adjacent to the optical coupler layer 1410 in the dielectric layer 1406. In some implementations, the optical coupler layers 1408 and 1410 are vertically adjacent in the semiconductor photonics device 1400 in that the optical coupler layers 1408 and 1410 are arranged in a direction that is approximately perpendicular to the top surface of the dielectric layer 1406. For example, the optical coupler layer 1408 may be located above the optical coupler layer 1410. In some implementations, the optical coupler layers 1408 and 1410 are horizontally adjacent in the semiconductor photonics device 1400 in that the optical coupler layers 1408 and 1410 are side by side in the y-direction in the semiconductor photonics device 1400.

The optical coupler layer 1408 includes a segment 1408a and a segment 1408b. The optical coupler layer 1410 includes a segment 1410a and a segment 1410b. A top view width of the segment 1408a (e.g., in the y-direction) increases from a first end of the optical coupler layer 1408 facing the optical signal I/O 1404 to an intermediate point 1412a along the optical coupler layer 1408 in the x-direction. Thus, the segment 1408a is a tapered segment in the top-down view of the semiconductor photonics device 1400, where the segment 1408a has substantially straight-lined tapered sidewalls. A top view width of the segment 1408b (e.g., in the y-direction) is substantially uniform between the intermediate point 1412a along the optical coupler layer 808 in the x-direction and a second end of the optical coupler layer 1408 opposing the first end. A top view width of the segments 1408c (e.g., in the y-direction) decreases from the first end of the optical coupler layer 1408 facing the optical signal I/O 1404 to the intermediate point 1412a along the optical coupler layer 1408 in the x-direction. Thus, the segments 1408c are tapered segments in the top-down view of the semiconductor photonics device 1400, where the segments 1408c have substantially straight-lined tapered sidewalls. The segment 1408a and the segments 1408c having different widths along the y-direction enables optical signals to be confined within and/or between the segment 1408a and the segments 1408c. Moreover, the tapers of the segment 1408a and the segments 1408c enable optical signals to be focused and merged before the optical signals are transferred to the optical coupler layer 1410.

A top view width of the segment 1408a (e.g., in the y-direction) is substantially uniform between a first end of the optical coupler layer 1408 facing the optical signal I/O 1404 and the intermediate point 1412a along the optical coupler layer 1408 in the x-direction. A top view width of the segment 1408b (e.g., in the y-direction) decreases from the intermediate point 1412a along the optical coupler layer 1408 in the x-direction to a second end of the optical coupler layer 1408 opposing the first end. Thus, the segment 1408b is a tapered segment, and may have curved sidewalls and/or substantially straight sidewalls.

A top view width of the segment 1410a (e.g., in the y-direction) is substantially uniform between a second end of the optical coupler layer 1410, adjacent to the second end of the optical coupler layer 1408, and an intermediate point 1412b along the optical coupler layer 1410 in the x-direction. A top view width of the segment 1410b (e.g., in the y-direction) decreases from the intermediate point 1412b along the optical coupler layer 1408 in the x-direction to a first end of the optical coupler layer 1410 facing the optical signal I/O 1404. Thus, the segment 1410b is a tapered segment, and may have curved sidewalls and/or substantially straight sidewalls. The segment 1408a extends laterally outward from the segment 1410b toward the optical signal I/O 1404 in the x-direction, and the segment 1410a extends laterally outward from the segment 1408b in the x-direction.

The optical coupler layers 1408 and 1410 have different top view profiles. For example, the top view profile of the optical coupler layer 1408 and the top view profile of the optical coupler layer 1410 are mirrored top view profiles. In particular, the segment 1408a is located adjacent to the optical signal I/O 1404 and to an end of the segment 1410b of the optical coupler layer 1410. The segment 1408b is located adjacent to the segment 1410a. As another example, the top view width of the segment 1408a of the optical coupler layer 1408 is greater than the top view width of the segment 1410a of the optical coupler layer 1410.

Additionally and/or alternatively to the different top view profiles, the optical coupler layers 1408 and 1410 may be formed of different material compositions. The material compositions of the optical coupler layers 1408 and 1410 may be selected so that the respective refractive indices of the optical coupler layers 1408 and 1410 promote compatibility of the optical coupler layers 1408 and 1410 for optical coupling purposes. For example, the material composition of the optical coupler layer 1408 may be selected such that the optical coupler layer 1408 has a first refractive index, the material composition of the optical coupler layer 1410 may be selected such that the optical coupler layer 1410 has a second refractive index that is greater than the first refractive index, which enables optical signals to be transferred from the optical coupler layer 1408 to the optical coupler layer 1410 with low optical loss.

The material composition of the optical coupler layer 1408 may include one or more dielectrics materials having a low refractive index, and the material composition of the optical coupler layer 1410 may include one or more semiconductor materials having a greater refractive index than the material composition of the optical coupler layer 1408. Examples of dielectric materials for the optical coupler layer 1408 include a silicon nitride material (SiₓN_{y} such as Si₃N₄), an aluminum oxide material (AlₓO_{y} such as Al₂O₃), an aluminum nitride material (AlN), a hafnium oxide material (HfOₓ such as HfO₂), a titanium oxide material (TiOₓ such as TiO₂), a zinc oxide material (ZnO), and/or a germanium oxide material (GeOₓ such as GeO₂), among other examples. Examples of semiconductor materials for the optical coupler layer 1410 include silicon (Si), germanium (Ge), and/or another semiconductor material.

FIG. 14B illustrates a cross-section view of the semiconductor photonics device 1400 along the line O-O in FIG. 14A in the x-direction through the centers of the optical coupler layers 1408 and 1410. As shown in FIG. 14B, the semiconductor photonics device 1400 may further include a semiconductor substrate 1414 above which the dielectric layer 1406 is located. The semiconductor substrate 1414 may include a semiconductor substrate such as a silicon (Si) substrate, a germanium (Ge) substrate, and/or another type of semiconductor substrate. The optical coupler layers 1408 and 1410 are arranged in a z-direction in the semiconductor photonics device 1400, which is approximately perpendicular to a surface of the semiconductor substrate 1414. For example, the optical coupler layer 1408 is located above the optical coupler layer 1410. Alternatively, the optical coupler layers 1408 and 1410 may be arranged such that the optical coupler layers 1408 and 1410 are adjacent in the y-direction. The optical coupler layers 1408 and 1410 are spaced apart by the dielectric layer 1406 such that the optical coupler layers 1408 and 1410 are not in direct contact with each other.

As further shown in FIG. 14B, the top view profiles of the optical coupler layers 1408 and 1410 enable bi-directional (or two-way) transmission of optical signals in the multiple-layer coupler structure 1402. For example, optical signals may propagate along a first optical signal path 1416a from the optical signal I/O 1404 to the segment 1408a of the optical coupler layer 1408, to the segment 1408b, may transfer (e.g., downward) to the segment 1410a and/or 1410b of the optical coupler layer 1410, and may be provided from the optical coupler layer 1410 to a PIC (not shown). As another example, optical signals may propagate along a second optical signal path 1416b from PIC (not shown) to the segment 1410a of the optical coupler layer 1410, to the segment 1410b, may transfer (e.g., upward) to the segment 1408a and/or 1408b of the optical coupler layer 1408, and may be provided from the optical coupler layer 1408 to the optical signal I/O 1404. Thus, the optical coupler layer 1408 is optically coupled with the optical signal I/O 1404, and the optical coupler layer 1410 is optically coupled with the optical coupler layer 1408.

FIG. 14C illustrates a top-down view of the optical coupler layers 1408 and 1410. As shown in FIG. 14C, a dimension D46 corresponds to the top view width of the segment 1408a (e.g., in the y-direction). A dimension D47 corresponds to the top view width of the segment 1410a (e.g., in the y-direction). In some implementations, the dimension D46 is greater than the dimension D47. In some implementations, the dimension D46 and the dimension D47 are approximately equal.

Similar semiconductor processing operations and/or techniques described in connection with FIGS. 4A-4E and/or 7A-7E may be used to form the semiconductor photonics device 1400. For example, the optical coupler layer 1410 may be formed in a semiconductor layer above the dielectric layer 1406. Additional material for the dielectric layer 1406 may be deposited to encapsulate the optical coupler layer 1410. The optical coupler layer 1408 may be formed above the optical coupler layer 1410 in the dielectric layer 1406. Additional material for the dielectric layer 1406 may be deposited to encapsulate the optical coupler layer 1408.

As indicated above, FIGS. 14A-14C are provided as an example. Other examples may differ from what is described with regard to FIGS. 14A-14C.

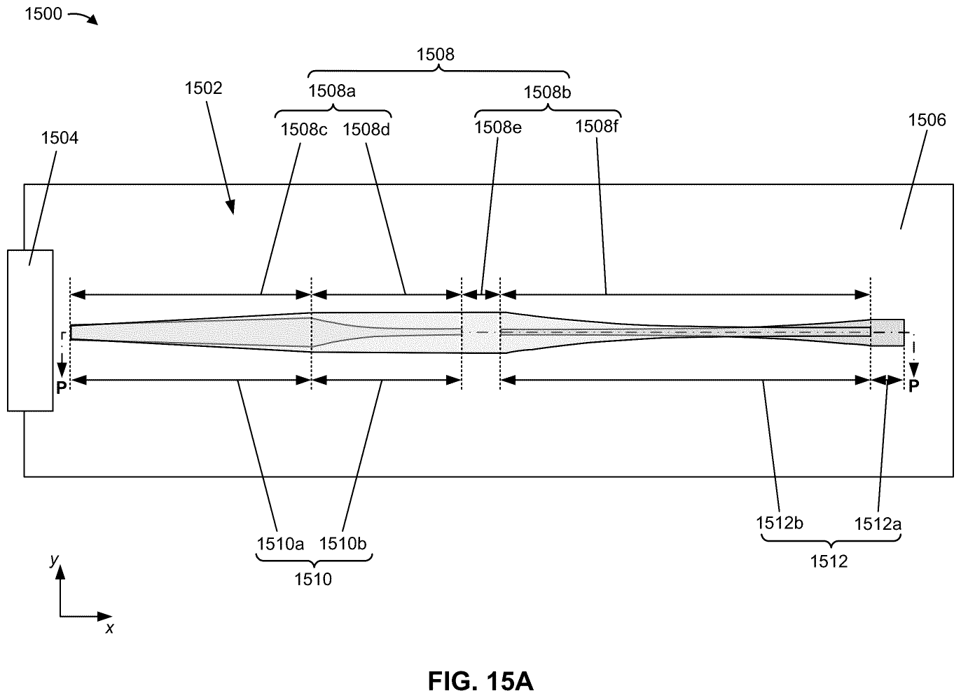

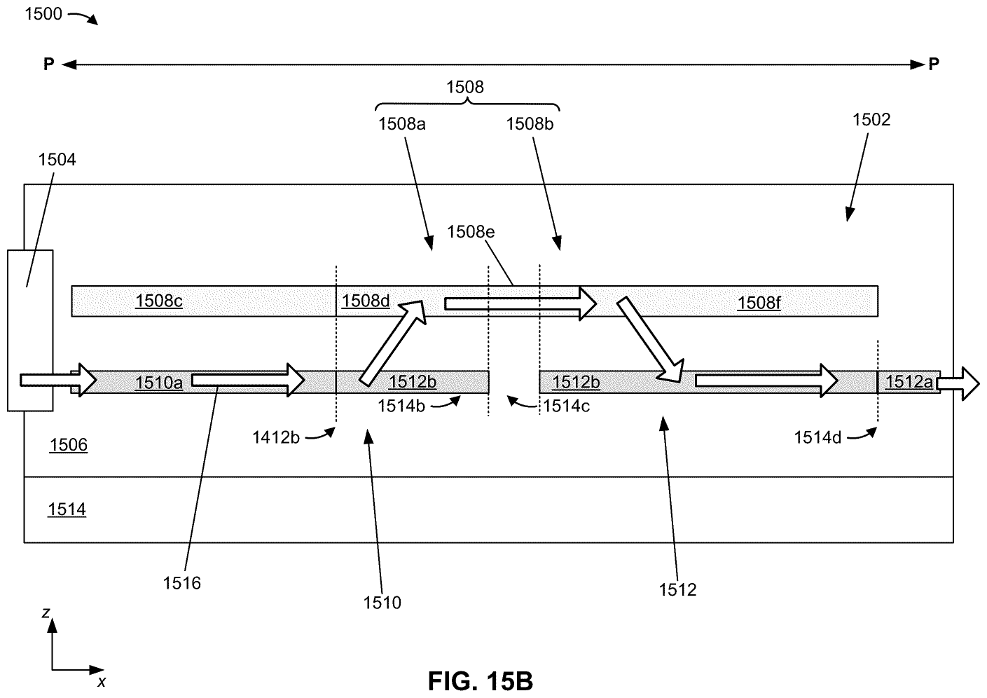

FIGS. 15A and 15B are diagrams of an example semiconductor photonics device 1500 described herein. The semiconductor photonics device 1500 may include an optical coupling circuit such as an edge coupler or edge coupling circuit. The semiconductor photonics device 1500 may be configured to provide optical signals between an optical signal I/O (e.g., an optical fiber) and a PIC for high-bandwidth optical communications.

FIG. 15A is a top-down view of an x-y plane of the semiconductor photonics device 1500. As shown in FIG. 15A, the semiconductor photonics device 1500 includes a multiple-layer coupler structure 1502. The multiple-layer coupler structure 1502 is optically coupled with an optical signal I/O 1504. The multiple-layer coupler structure 1502 may be configured to provide optical signals between the optical signal I/O 1504 and another structure of the semiconductor photonics device 1500 such as a PIC (not shown). For example, the multiple-layer coupler structure 1502 may receive an optical signal from the optical signal I/O 1504 and provide the optical signal to a PIC. As another example, the multiple-layer coupler structure 1502 may receive an optical signal from a PIC and provide the optical signal to the optical signal I/O 1504.

The multiple-layer coupler structure 1502 may be included in a dielectric layer 1506 of the semiconductor photonics device 1500. The dielectric layer 1506 may include one or more dielectric materials, such as a silicon oxide (SiOₓ), a silicon nitride (SiₓN_{y}), a silicon oxynitride (SiON), tetraethyl orthosilicate oxide, phosphosilicate glass (PSG), borophosphosilicate glass (BPSG), fluorinated silicate glass (FSG), carbon doped silicon oxide, and/or another dielectric material.

The multiple-layer coupler structure 1502 includes a plurality of optical coupler layers, such as an optical coupler layer 1508, an optical coupler layer 1510, and an optical coupler layer 1512. The optical coupler layers 1508, 1510, and 1512 may each include a waveguide that enables optical signals to be transferred between and through the optical coupler layers 1508, 1510, and/or 1512. The optical coupler layer 1508 is adjacent to the optical coupler layer 1510 and the optical coupler layer 1512 in the dielectric layer 1506. In some implementations, the optical coupler layer 1508 is vertically adjacent to the optical coupler layers 1510 and 1512 in the semiconductor photonics device 1500. Thus, the optical coupler layers 1508 and 1510 may be arranged in a direction that is approximately perpendicular to the top surface of the dielectric layer 1506, and the optical coupler layers 1508 and 1512 may be arranged in the direction that is approximately perpendicular to the top surface of the dielectric layer 1506. For example, the optical coupler layer 1508 may be located above the optical coupler layer 1510 and above the optical coupler layer 1512. In some implementations, the optical coupler layer 1508 is horizontally adjacent to the optical coupler layers 1510 and/or 1512 in the semiconductor photonics device 1500 in that the optical coupler layer 1508 is side by side in the y-direction in the semiconductor photonics device 1500 with the optical coupler layers 1510 and/or 1512.

The optical coupler layer 1510 is adjacent to the optical coupler layer 1512 in the dielectric layer 1506. In some implementations, the optical coupler layer 1510 and the optical coupler layer 1512 are horizontally adjacent in the semiconductor photonics device 1500. Thus, the optical coupler layers 1510 and 1512 may be arranged in a direction that is approximately parallel to the top surface of the dielectric layer 1506. For example, the optical coupler layer 1510 may be adjacent to the optical coupler layer 1512 in the x-direction in the semiconductor photonics device 1500.

The optical coupler layers 1508, 1510, and 1512 have different top view profiles. For example, the optical coupler layer 1508 may include a segment 1508a that has a similar top view profile to the optical coupler layer 1310, and another segment 1508b that has a similar top view profile to the optical coupler layer 1408. The optical coupler layer 1510 may have a similar top view profile to the optical coupler layer 1308, and the optical coupler layer 1512 may have a similar top view profile to the optical coupler layer 1410. Segments 1508c and 1508d of the optical coupler layer 1508 (corresponding to segments 1310a and 1310b of the optical coupler layer 1310) may be located above segments 1510a and 1510b of the optical coupler layer 1510 (corresponding to segments 1308a and 1308b of the optical coupler layer 1310). A segment 1508e of the optical coupler layer 1508 (corresponding to the segment 1408a of the optical coupler layer 1408) may be located above a gap between the optical coupler layers 1510 and 1512. A segment 1508f of the optical coupler layer 1508 (corresponding to the segment 1408b of the optical coupler layer 1408) may be located above a segment 1512b of the optical coupler layer 1512 (corresponding to the segment 1410b of the optical coupler layer 1410). A segment 1512a (corresponding to the segment 1410a of the optical coupler layer 1410) may extend laterally outward from the segment 1508f.

Additionally and/or alternatively to the different top view profiles, the optical coupler layers 1508, 1510, and/or 1512 may be formed of different material compositions. The material compositions of the optical coupler layers 1508, 1510, and/or 1512 may be selected so that the respective refractive indices of the optical coupler layers 1508, 1510, and/or 1512 promote compatibility of the optical coupler layers 1508, 1510, and/or 1512 for optical coupling purposes. For example, the material composition of the optical coupler layer 1508 may be selected such that the optical coupler layer 1508 has a first refractive index, and the material compositions of the optical coupler layers 1510 and 1512 may be selected such that the optical coupler layers 1510 and 1512 have a second refractive index that is greater than the first refractive index, which enables optical signals to be transferred between the optical coupler layers 1508 and 1510, and between the optical coupler layers 1508 and 1512, with low optical loss.

The material composition of the optical coupler layer 1508 may include one or more dielectrics materials having a low refractive index, and the material composition of the optical coupler layers 1510 and 1512 may include one or more semiconductor materials having a greater refractive index than the material composition of the optical coupler layer 1508. Examples of dielectric materials for the optical coupler layer 1508 include a silicon nitride material (SiₓN_{y} such as Si₃N₄), an aluminum oxide material (AlₓO_{y} such as Al₂O₃), an aluminum nitride material (AlN), a hafnium oxide material (HfOₓ such as HfO₂), a titanium oxide material (TiOₓ such as TiO₂), a zinc oxide material (ZnO), and/or a germanium oxide material (GeOₓ such as GeO₂), among other examples. Examples of semiconductor materials for the optical coupler layers 1510 and 1512 include silicon (Si), germanium (Ge), and/or another semiconductor material.

The combination of arrangements, top view profiles, and/or material compositions illustrated and described in connection with FIG. 15A are examples, and other combinations are within the scope of the present disclosure. For example, other combinations of optical coupler layers described herein may be combined in a multiple-layer coupler structure to achieve efficient and low-loss optical coupling for one or more wavelengths of optical signals.

FIG. 15B illustrates a cross-section view of the semiconductor photonics device 1500 along the line P-P in FIG. 15A in the x-direction through the centers of the optical coupler layers 1508, 1510, and 1512. As shown in FIG. 15B, the semiconductor photonics device 1500 may further include a semiconductor substrate 1514 above which the dielectric layer 1506 is located. The semiconductor substrate 1514 may include a semiconductor substrate such as a silicon (Si) substrate, a germanium (Ge) substrate, and/or another type of semiconductor substrate. The optical coupler layers 1508 and 1510 are arranged in a z-direction in the semiconductor photonics device 1500, which is approximately perpendicular to a surface of the semiconductor substrate 1514. For example, the optical coupler layer 1508 is located above the optical coupler layer 1510. The optical coupler layers 1508 and 1512 are arranged in the z-direction in the semiconductor photonics device 1500. For example, the optical coupler layer 1508 is located above the optical coupler layer 1512. The optical coupler layers 1510 and 1512 are arranged in the x-direction in the semiconductor photonics device 1500. For example, the optical coupler layer 1510 is located adjacent to the optical coupler layer 1512. Alternatively, the optical coupler layers 1508, 1510, and/or 1512 may be arranged in a different configuration.

The optical coupler layers 1508 and 1510 are spaced apart by the dielectric layer 1506 such that the optical coupler layers 1508 and 1510 are not in direct contact with each other. The optical coupler layers 1508 and 1512 are spaced apart by the dielectric layer 1506 such that the optical coupler layers 1508 and 1512 are not in direct contact with each other. The optical coupler layers 1510 and 1512 are spaced apart by the dielectric layer 1506 such that the optical coupler layers 1510 and 1512 are not in direct contact with each other.

As further shown in FIG. 15B, the arrangement, the top view profiles, and/or the material compositions of the optical coupler layers 1508, 1510, and/or 1512 enable optical signals to be transmitted between the optical coupler layers 1508 and 1510, and between the optical coupler layers 1508 and 1512. For example, optical signals may propagate along an optical signal path 1516 from the optical signal I/O 1504 to the optical coupler layer 1510, may transfer (e.g., upward) from the optical coupler layer 1510 to the optical coupler layer 1508, may transfer (e.g., downward) from the optical coupler layer 1508 to the optical coupler layer 1512, and may be provided from the optical coupler layer 1512 to a PIC (not shown). Thus, the optical coupler layer 1510 is optically coupled with the optical signal I/O 1504, the optical coupler layer 1508 is optically coupled with the optical coupler layers 1510 and 1512, and the optical coupler layer 1512 is optical coupled with the optical coupler layer 1508.

Similar semiconductor processing operations and/or techniques described in connection with FIGS. 4A-4E and/or 7A-7E may be used to form the semiconductor photonics device 1500. For example, the optical coupler layers 1510 and 1512 may be formed in a semiconductor layer above the dielectric layer 1506. Additional material for the dielectric layer 1506 may be deposited to encapsulate the optical coupler layers 1510 and 1512. The optical coupler layer 1508 may be formed above the optical coupler layers 1510 and 1512 in the dielectric layer 1506. Additional material for the dielectric layer 1506 may be deposited to encapsulate the optical coupler layer 1508.

As indicated above, FIGS. 15A and 15B are provided as an example. Other examples may differ from what is described with regard to FIGS. 15A and 15B.

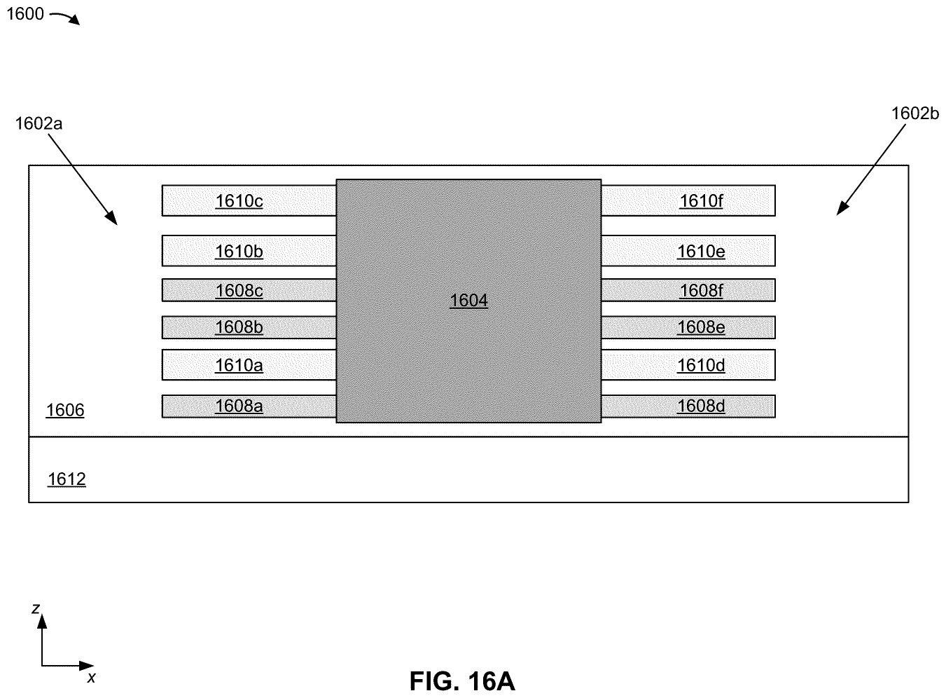

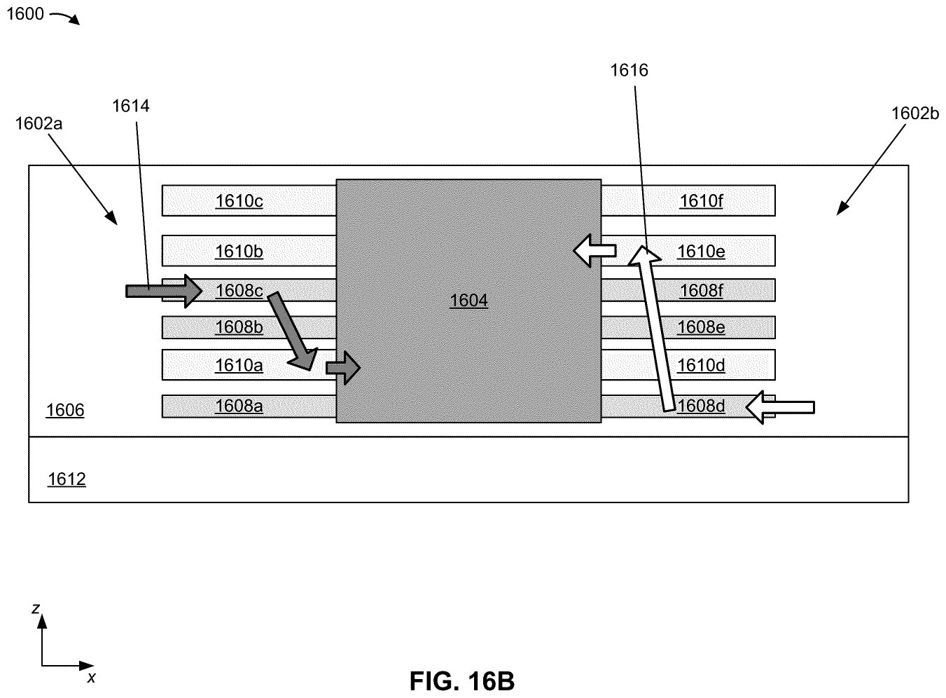

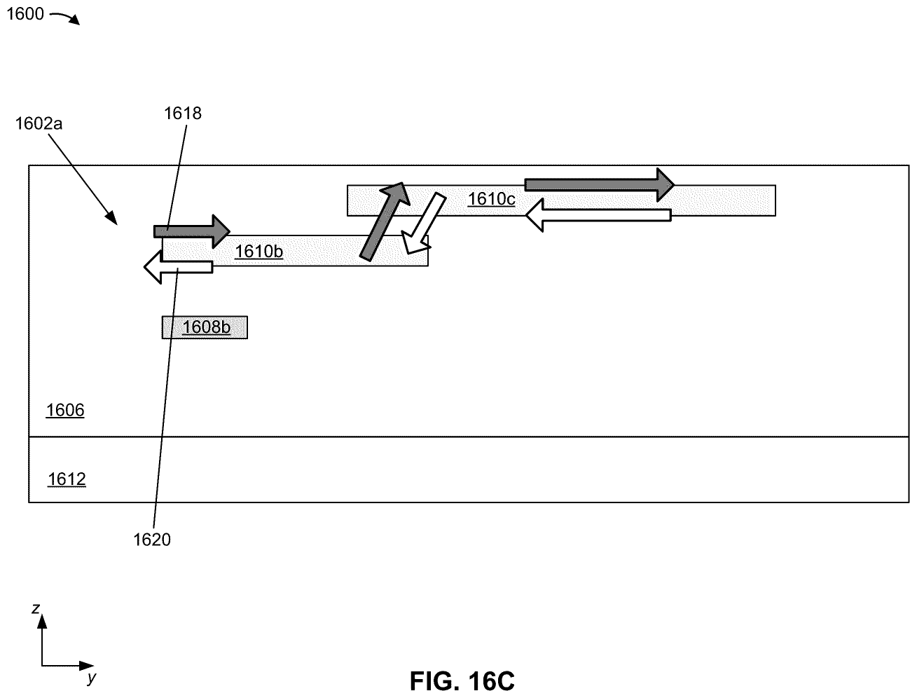

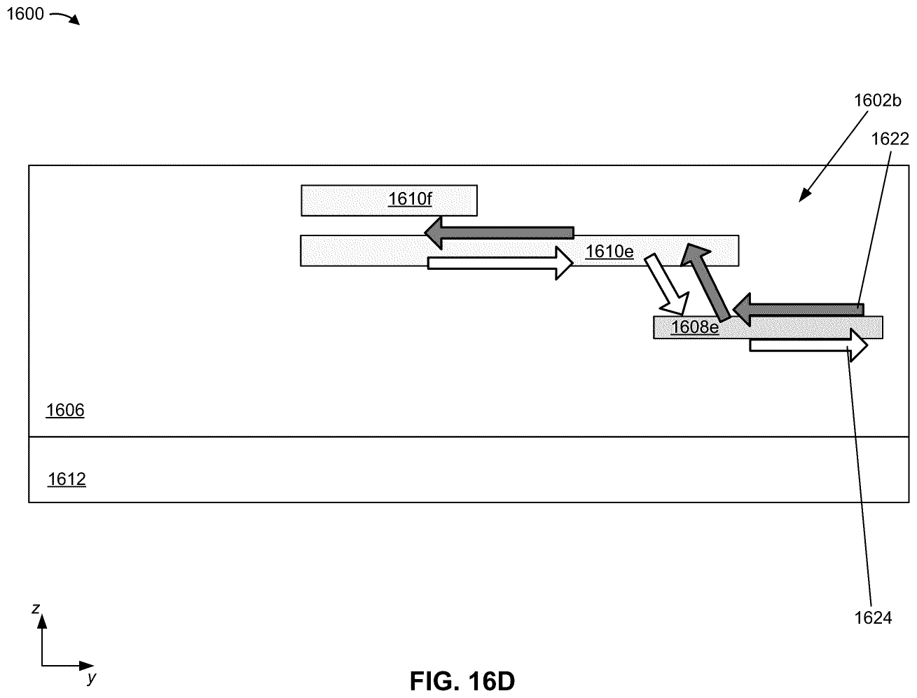

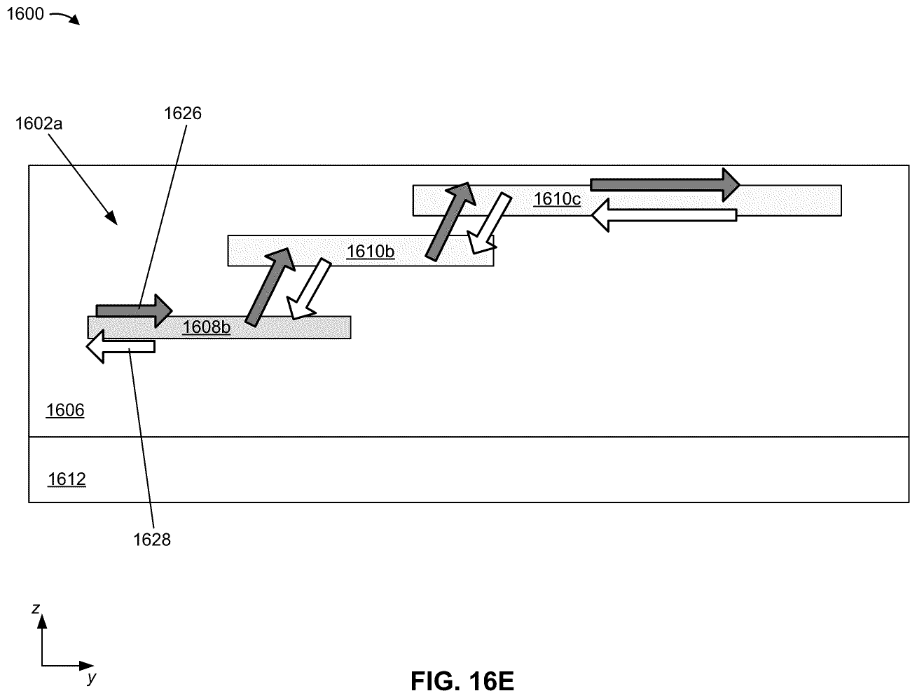

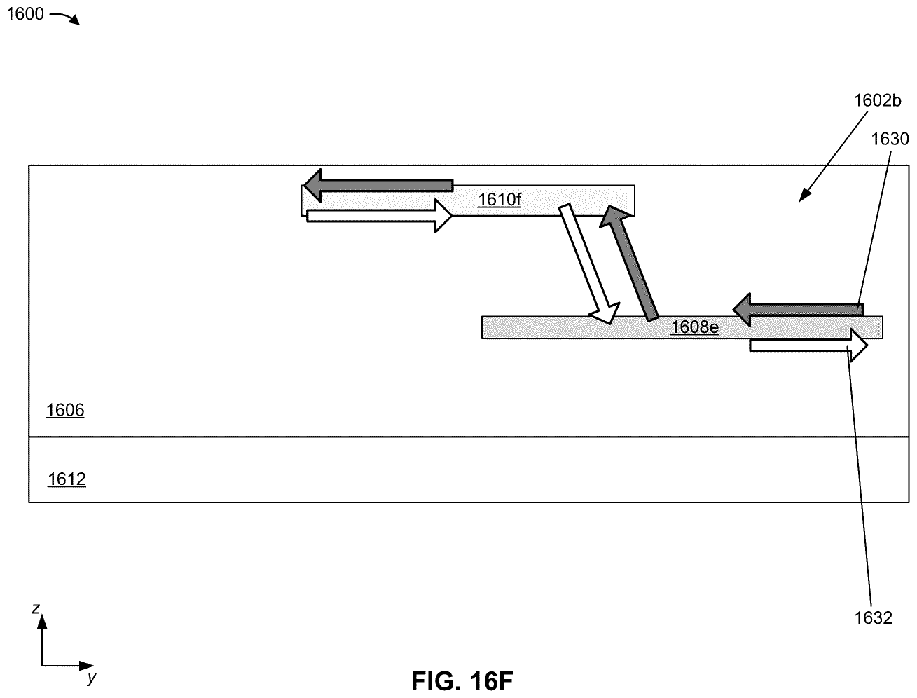

FIGS. 16A-16F are diagrams of an example semiconductor photonics device 1600 described herein. FIG. 16A illustrates a cross-section view of the semiconductor photonics device 1600. As shown in FIG. 16A, the semiconductor photonics device 1600 may include a plurality of multiple-layer coupler structures 1602a and 1602b that are optically coupled with a PIC 1604 of the semiconductor photonics device 1600. The multiple-layer coupler structures 1602a and 1602b may be configured to provide optical signals to and/or from the PIC 1604 for high-bandwidth optical communications. The PIC 1604 may include an optical modulator, an optical amplifier, and/or another type of PIC.

The multiple-layer coupler structures 1602a and 1602b, and the PIC 1604, may be included in a dielectric layer 1606 of the semiconductor photonics device 1600. The dielectric layer 1606 may include one or more dielectric materials, such as a silicon oxide (SiOₓ), a silicon nitride (SiₓN_{y}), a silicon oxynitride (SiON), tetraethyl orthosilicate oxide, phosphosilicate glass (PSG), borophosphosilicate glass (BPSG), fluorinated silicate glass (FSG), carbon doped silicon oxide, and/or another dielectric material.

The multiple-layer coupler structures 1602a and 1602b each include a plurality of optical coupler layers. For example, the multiple-layer coupler structure 1602a includes a plurality of optical coupler layers 1608a-1608c and 1610a-1610c that are vertically arranged (e.g., arranged in the z-direction that is approximately perpendicular with a semiconductor substrate 1612 of the semiconductor photonics device 1600). The multiple-layer coupler structure 1602b includes a plurality of optical coupler layers 1608d-1608f and 1610d-1610f that are vertically arranged (e.g., arranged in the z-direction that is approximately perpendicular with the semiconductor substrate 1612 of the semiconductor photonics device 1600). The optical coupler layers 1608a-1608f and 1610a-1610f may each include a waveguide that enables optical signals to be transferred between and through the optical coupler layers 1608a-1608f and 1610a-1610f. The optical coupler layers 1608a-1608f and 1610a-1610f are spaced apart by the dielectric layer 1606 such that the optical coupler layers 1608a-1608f and 1610a-1610f are not in direct contact with each other. The optical coupler layers 1608a-1608f and 1610a-1610f may each include one or more arrangements, top view profiles, and/or material compositions of the optical coupler layers described herein.

FIGS. 16B-16F illustrate examples of optical signal paths to and/or from the PIC 1604 through the multiple-layer coupler structures 1602a and 1602b. As shown in an example in FIG. 16B, an optical signal path 1614 includes propagation of an optical signal through the optical coupler layer 1608c of the multiple-layer coupler structure 1602a to the optical coupler layer 1610a of the multiple-layer coupler structure 1602a, and from the optical coupler layer 1610a to the PIC 1604. Thus, the optical signal path 1614 includes a multiple layer optical signal path. As another example, an optical signal path 1616 includes propagation of an optical signal through the optical coupler layer 1608d of the multiple-layer coupler structure 1602b to the optical coupler layer 1610e of the multiple-layer coupler structure 1602b, and from the optical coupler layer 1610e to the PIC 1604. Thus, the optical signal path 1616 includes a multiple layer optical signal path.

As shown in examples in FIG. 16C-16F, the multiple-layer coupler structures 1602a and 1602b may enable bi-directional or two-way transmission of optical signals through the multiple-layer coupler structures 1602a and/or 1602b. As shown in the example in FIG. 16C, optical signals may propagate through the multiple-layer coupler structure 1602a along opposing optical signal paths 1618 and 1620 (e.g., along the optical coupler layers 1610c and 1610d). As shown in the example in FIG. 16D, optical signals may propagate through the multiple-layer coupler structure 1602b along opposing optical signal paths 1622 and 1624 (e.g., along the optical coupler layers 1608e and 1610e). As shown in the example in FIG. 16E, optical signals may propagate through the multiple-layer coupler structure 1602a along opposing optical signal paths 1626 and 1628 (e.g., along the optical coupler layers 1608b, 1610b, and 1610c). As shown in the example in FIG. 16F, optical signals may propagate through the multiple-layer coupler structure 1602b along opposing optical signal paths 1630 and 1632 (e.g., along the optical coupler layers 1608e and 1610f).

As indicated above, FIGS. 16A-16F are provided as examples. Other examples may differ from what is described with regard to FIGS. 16A-16F.

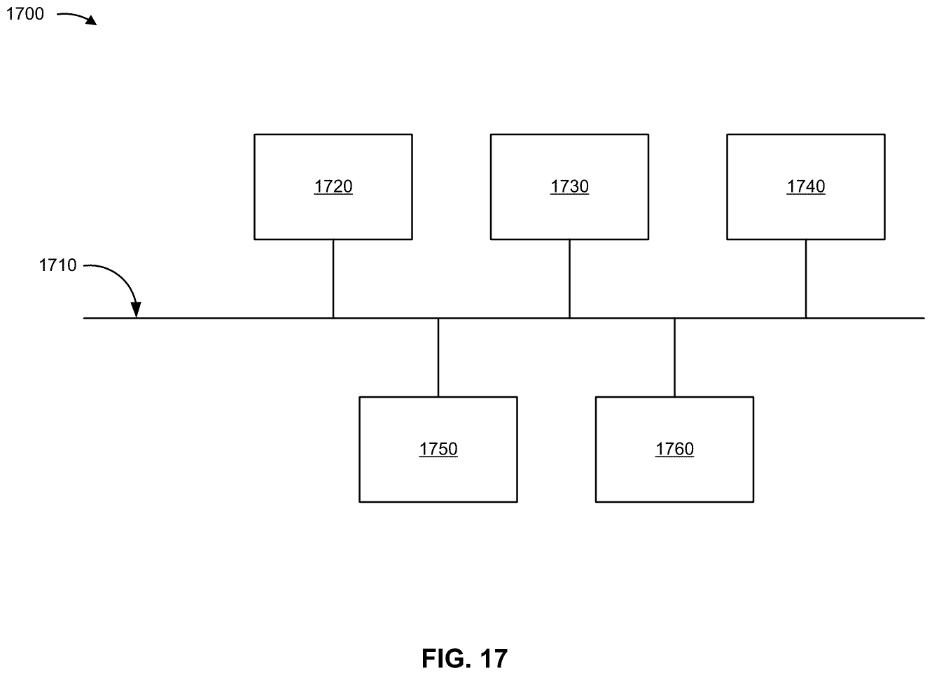

FIG. 17 is a diagram of example components of a device 1700 described herein. In some implementations, one or more of the semiconductor processing tools 102-114 and/or the wafer/die transport tool 116 may include one or more devices 1700 and/or one or more components of the device 1700. As shown in FIG. 17, the device 1700 may include a bus 1710, a processor 1720, a memory 1730, an input component 1740, an output component 1750, and/or a communication component 1760.

The bus 1710 may include one or more components that enable wired and/or wireless communication among the components of the device 1700. The bus 1710 may couple together two or more components of FIG. 17, such as via operative coupling, communicative coupling, electronic coupling, and/or electric coupling. For example, the bus 1710 may include an electrical connection (e.g., a wire, a trace, and/or a lead) and/or a wireless bus. The processor 1720 may include a central processing unit, a graphics processing unit, a microprocessor, a controller, a microcontroller, a digital signal processor, a field-programmable gate array, an application-specific integrated circuit, and/or another type of processing component. The processor 1720 may be implemented in hardware, firmware, or a combination of hardware and software. In some implementations, the processor 1720 may include one or more processors capable of being programmed to perform one or more operations or processes described elsewhere herein.

The memory 1730 may include volatile and/or nonvolatile memory. For example, the memory 1730 may include random access memory (RAM), read only memory (ROM), a hard disk drive, and/or another type of memory (e.g., a flash memory, a magnetic memory, and/or an optical memory). The memory 1730 may include internal memory (e.g., RAM, ROM, or a hard disk drive) and/or removable memory (e.g., removable via a universal serial bus connection). The memory 1730 may be a non-transitory computer-readable medium. The memory 1730 may store information, one or more instructions, and/or software (e.g., one or more software applications) related to the operation of the device 1700. In some implementations, the memory 1730 may include one or more memories that are coupled (e.g., communicatively coupled) to one or more processors (e.g., processor 1720), such as via the bus 1710. Communicative coupling between a processor 1720 and a memory 1730 may enable the processor 1720 to read and/or process information stored in the memory 1730 and/or to store information in the memory 1730.

The input component 1740 may enable the device 1700 to receive input, such as user input and/or sensed input. For example, the input component 1740 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 1750 may enable the device 1700 to provide output, such as via a display, a speaker, and/or a light-emitting diode. The communication component 1760 may enable the device 1700 to communicate with other devices via a wired connection and/or a wireless connection. For example, the communication component 1760 may include a receiver, a transmitter, a transceiver, a modem, a network interface card, and/or an antenna.

The device 1700 may perform one or more operations or processes described herein. For example, a non-transitory computer-readable medium (e.g., memory 1730) may store a set of instructions (e.g., one or more instructions or code) for execution by the processor 1720. The processor 1720 may execute the set of instructions to perform one or more operations or processes described herein. In some implementations, execution of the set of instructions, by one or more processors 1720, causes the one or more processors 1720 and/or the device 1700 to perform one or more operations or processes described herein. In some implementations, hardwired circuitry may be used instead of or in combination with the instructions to perform one or more operations or processes described herein. Additionally, or alternatively, the processor 1720 may be configured to perform one or more operations or processes described herein. Thus, implementations described herein are not limited to any specific combination of hardware circuitry and software.

The number and arrangement of components shown in FIG. 17 are provided as an example. The device 1700 may include additional components, fewer components, different components, or differently arranged components than those shown in FIG. 17. Additionally, or alternatively, a set of components (e.g., one or more components) of the device 1700 may perform one or more functions described as being performed by another set of components of the device 1700.

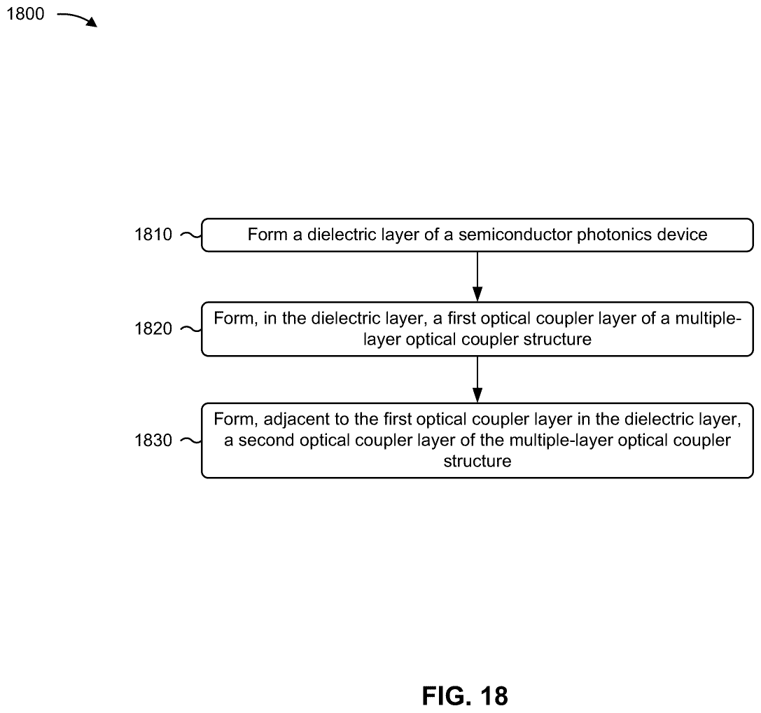

FIG. 18 is a flowchart of an example process 1800 associated with forming a semiconductor photonics device described herein. In some implementations, one or more process blocks of FIG. 18 are performed using one or more semiconductor processing tools (e.g., one or more of the semiconductor processing tools 102-114). Additionally, or alternatively, one or more process blocks of FIG. 18 may be performed using one or more components of device 1700, such as processor 1720, memory 1730, input component 1740, output component 1750, and/or communication component 1760.

As shown in FIG. 18, process 1800 may include forming a dielectric layer of a semiconductor photonics device (block 1810). For example, one or more of the semiconductor processing tools 102-114 may be used to form a dielectric layer (e.g., one or more of the dielectric layers 206, 506, 806, 906, 1006, 1106, 1206, 1306, 1406, 1506, and/or 1606) of a semiconductor photonics device (e.g., one or more of the semiconductor photonics device 200, 500, 800, 900, 1000, 1100, 1200, 1300, 1400, 1500, and/or 1600), as described herein.

As further shown in FIG. 18, process 1800 may include forming, in the dielectric layer, a first optical coupler layer of a multiple-layer coupler structure (block 1820). For example, one or more of the semiconductor processing tools 102-114 may be used to form, in the dielectric layer, a first optical coupler layer (e.g., one or more of the optical coupler layers 210, 508, 810, 910, 1010, 1110, 1210, 1310, 1410, 1510, 1512, and/or 1608a-1608f) of a multiple-layer coupler structure (e.g., one or more of the multiple-layer coupler structures 202, 502, 802, 902, 1002, 1102, 1202, 1302, 1402, 1502, and/or 1602), as described herein. In some implementations, the first optical coupler layer may have a first cross-sectional thickness.

As further shown in FIG. 18, process 1800 may include forming, adjacent to the first optical coupler layer in the dielectric layer, a second optical coupler layer of the multiple-layer coupler structure (block 1830). For example, one or more of the semiconductor processing tools 102-114 may be used to form, adjacent to the first optical coupler layer in the dielectric layer, a second optical coupler layer (e.g., one or more of the optical coupler layers 208, 510, 808, 908, 1008, 1108, 1208, 1308, 1408, 1508, and/or 1610a-1610f) of the multiple-layer coupler structure, as described herein. In some implementations, the second optical coupler layer has a second cross-sectional thickness that is greater than the first cross-sectional thickness.

Process 1800 may include additional implementations, such as any single implementation or any combination of implementations described below and/or in connection with one or more other processes described elsewhere herein.

In a first implementation, forming the second optical coupler layer includes forming a first segment (e.g., a segment 808a, a segment 908a) of the second optical coupler layer, and forming, adjacent to and spaced apart from the first segment in a top view of the second optical coupler layer, a plurality of second segments (e.g., segments 808c, segments 908c) on opposing sides of the first segment.

In a second implementation, alone or in combination with the first implementation, forming the second optical coupler layer includes forming a first segment (e.g., a segment 1008b, a segment 1108b) having a uniform top view width, forming a plurality of second segments (e.g., segments 1008c, segments 1108c), and forming a third segment (e.g., a segment 1008a, a segment 1108a) between and coupled with the first segment and the plurality of second segments.

In a third implementation, alone or in combination with one or more of the first and second implementations, a top view width of the third segment increases from the first segment to the plurality of second segments.

In a fourth implementation, alone or in combination with one or more of the first through third implementations, forming the second optical coupler layer includes forming the second optical coupler layer such that the second optical coupler layer partially overlaps the first optical coupler layer.

In a fifth implementation, alone or in combination with one or more of the first through fourth implementations, forming the second optical coupler layer includes forming the second optical coupler layer to a top view length that is greater than a top view length of the first optical coupler layer.

Although FIG. 18 shows example blocks of process 1800, in some implementations, process 1800 includes additional blocks, fewer blocks, different blocks, or differently arranged blocks than those depicted in FIG. 18. Additionally, or alternatively, two or more of the blocks of process 1800 may be performed in parallel.

In this way, a semiconductor photonics device includes a multiple-layer coupler structure. The multiple-layer coupler structure includes a plurality of optical coupler layers, which enables the properties of the optical coupler layers (e.g., materials, refractive indices, shapes, sizes, positioning) to be configured to achieve efficient optical coupling for a broad spectrum of optical wavelengths. This enables the multiple-layer coupler structure to handle wide bandwidth optical signals, which enables the semiconductor photonics device to support high-bandwidth optical communication applications. Moreover, the optical coupler layers of the multiple-layer coupler device enable the performance of the multiple-layer coupler structure to be increased using less complex and less costly semiconductor manufacturing processes and techniques. Additionally, the optical coupler layers of the multiple-layer coupler structure enable the multiple-layer coupler structure to handle bidirectional transmission of optical signals, thereby enabling transmission of optical signals between various layers of the semiconductor photonics device.

As described in greater detail above, some implementations described herein provide a semiconductor photonics device. The semiconductor photonics device includes a dielectric layer. The semiconductor photonics device includes a multiple-layer optical coupler, in the dielectric layer, that includes a first optical coupler layer having a first top view profile and a second optical coupler layer, adjacent to the first optical coupler layer, having a second top view profile that is different from the first top view profile.

As described in greater detail above, some implementations described herein provide a semiconductor photonics device. The semiconductor photonics device includes a dielectric layer. The semiconductor photonics device includes a multiple-layer optical coupler, in the dielectric layer, that includes a first optical coupler layer and a second optical coupler layer. The first optical coupler layer includes a first end adjacent to an optical signal input and a second end opposing the first end. A top view width of the first optical coupler layer increases from the first end to an intermediate point between the first end and the second end. The top view width of the first optical coupler layer decreases between the intermediate point and the second end. The second optical coupler layer is adjacent to the first optical coupler layer and includes a third end adjacent to the optical signal input a fourth end opposing the third end.

As described in greater detail above, some implementations described herein provide a method. The method includes forming a dielectric layer of a semiconductor photonics device. The method includes forming, in the dielectric layer, a first optical coupler layer having a first cross-sectional thickness. The method includes forming, adjacent to the first optical coupler layer in the dielectric layer, a second optical coupler layer having a second cross-sectional thickness that is greater than the first cross-sectional thickness.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

The terms “approximately” and “substantially” can indicate a value of a given quantity that varies within 5% of the value (e.g., ±1%, ±2%, ±3%, ±4%, ±5% of the value). These values are merely examples and are not intended to be limiting. It is to be understood that the terms “approximately” and “substantially” can refer to a percentage of the values of a given quantity in light of this disclosure.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor photonics device, comprising:
a dielectric layer; and
a multiple-layer optical coupler, in the dielectric layer, comprising:
a first optical coupler layer having a first top view profile; and
a second optical coupler layer, adjacent to the first optical coupler layer, having a second top view profile that is different from the first top view profile.

2. The semiconductor photonics device of claim 1, wherein the first optical coupler layer is optically coupled with an optical signal input/output; and
wherein the second optical coupler layer is optically coupled with the first optical coupler layer.

3. The semiconductor photonics device of claim 2, wherein the multiple-layer optical coupler further comprises:
a third optical coupler layer adjacent to the second optical coupler layer,
wherein the second optical coupler layer is located between the first optical coupler layer and the third optical coupler layer, and
wherein the third optical coupler layer is optically coupled with the second optical coupler layer.

4. The semiconductor photonics device of claim 2, wherein the multiple-layer optical coupler further comprises:
a third optical coupler layer adjacent to the second optical coupler layer,
wherein the second optical coupler layer is located under a first segment of the first optical coupler layer,
wherein the third optical coupler layer is located under a second segment of the first optical coupler layer, and
wherein the third optical coupler layer is optically coupled with the first optical coupler layer.

5. The semiconductor photonics device of claim 1, wherein the first optical coupler layer comprises a first material composition; and
wherein the second optical coupler layer comprises a second material composition that is different from the first material composition.

6. The semiconductor photonics device of claim 5, wherein the first material composition has a first refractive index;
wherein the second material composition has a second refractive index; and
wherein the first refractive index and the second refractive index are different refractive indexes.

7. The semiconductor photonics device of claim 5, wherein the first material composition comprises a semiconductor material; and
wherein the second material composition comprises a dielectric material.

8. The semiconductor photonics device of claim 1, wherein the first optical coupler layer and the second optical coupler layer are arranged in a direction that is approximately perpendicular to a substrate of the semiconductor photonics device.

9. The semiconductor photonics device of claim 1, wherein the multiple-layer optical coupler is a first multiple-layer optical coupler included in the semiconductor photonics device; and
wherein the semiconductor photonics device further comprises:
a photonic integrated circuit in the dielectric layer; and
a second multiple-layer optical coupler, comprising:
a third optical coupler layer having a third top view profile; and
a fourth optical coupler layer, adjacent to the third optical coupler layer, having a fourth top view profile that is different from the third top view profile.

10. A semiconductor photonics device, comprising:
a dielectric layer; and
a multiple-layer optical coupler, in the dielectric layer, comprising:
a first optical coupler layer comprising:
a first end adjacent to an optical signal input/output (I/O); and
a second end opposing the first end,
wherein a top view width of the first optical coupler layer increases from the first end to an intermediate point between the first end and the second end, and
wherein the top view width of the first optical coupler layer decreases between the intermediate point and the second end; and
a second optical coupler layer, adjacent to the first optical coupler layer, comprising:
a third end adjacent to the optical signal I/O; and
a fourth end opposing the third end.

11. The semiconductor photonics device of claim 10, wherein first sidewalls of the first optical coupler layer, between the first end and the intermediate point, are linear in a top view of the multiple-layer optical coupler; and
wherein second sidewalls of the first optical coupler layer, between the second end and the intermediate point, are linear in the top view of the multiple-layer optical coupler.

12. The semiconductor photonics device of claim 10, wherein first sidewalls of the first optical coupler layer, between the first end and the intermediate point, are linear in a top view of the multiple-layer optical coupler; and
wherein second sidewalls of the first optical coupler layer, between the second end and the intermediate point, are curved in the top view of the multiple-layer optical coupler.

13. The semiconductor photonics device of claim 10, wherein a top view width of the second optical coupler layer increases from the third end to an intermediate point of the second optical coupler layer between the third end and the fourth end, and
wherein the top view width of the second optical coupler layer increases between the intermediate point and the fourth end.

14. The semiconductor photonics device of claim 13, wherein the top view width of the second optical coupler layer, at the third end, is greater than the top view width of the second optical coupler layer at the fourth end.

15. A method, comprising:
forming a dielectric layer of a semiconductor photonics device;
forming, in the dielectric layer, a first optical coupler layer having a first cross-sectional thickness; and
forming, adjacent to the first optical coupler layer in the dielectric layer, a second optical coupler layer having a second cross-sectional thickness that is greater than the first cross-sectional thickness.

16. The method of claim 15, wherein forming the second optical coupler layer comprises:
forming a first segment of the second optical coupler layer; and
forming, adjacent to and spaced apart from the first segment in a top view of the second optical coupler layer, a plurality of second segments on opposing sides of the first segment.

17. The method of claim 15, wherein forming the second optical coupler layer comprises:
forming a first segment having a uniform top view width;
forming a plurality of second segments; and
forming a third segment between and coupled with the first segment and the plurality of second segments.

18. The method of claim 17, wherein a top view width of the third segment increases from the first segment to the plurality of second segments.

19. The method of claim 15, wherein forming the second optical coupler layer comprises:
forming the second optical coupler layer such that the second optical coupler layer partially overlaps the first optical coupler layer.

20. The method of claim 15, wherein forming the second optical coupler layer comprises:
forming the second optical coupler layer to a top view length that is greater than a top view length of the first optical coupler layer.
